(19) United States
(12) Patent Application Publication
(10) Pub. No.: US 2026/0214691 A1
(43) Pub. Date: Jul. 23, 2026

(54) METHODS AND APPARATUS FOR MANAGING RADIO NETWORK SPECTRUM USAGE USING BLOCKCHAIN AND/OR DISTRIBUTED LEDGER TECHNOLOGY

(71) Applicant: Charter Communications Operating, LLC, St. Louis, MO (US)

(72) Inventor: Pareshkumar Panchal, Highlands Ranch, CO (US)

(21) Appl. No.: 19/035,507

(22) Filed: Jan. 23, 2025

(51) Int. Cl. H04W 72/50; H04W 72/04

(52) U.S. Cl. CPC H04W 72/535; H04W 72/04

(57) ABSTRACT

The present invention relates to methods and apparatus for managing the allocation of radio resources in wireless systems utilizing smart contracts, tokens, blockchains, and/or distributed ledgers. An exemplary embodiment includes the steps of: generating a smart contract in response to receiving a request for radio resources from a wireless device, the smart contract including: (i) information identifying the wireless device, (ii) information identifying a base station radio system of the base station that is serving the wireless device, (iii) terms of the smart contract, and (iv) information on radio resources to be allocated for use by the wireless device; communicating, by the base station, a smart contract offer message to the wireless device; and upon acceptance of the smart contract offer issuing a token to the wireless device identifying radio resources allocated for its use; and tracking the allocation of radio resources using a distributed blockchain ledger.

### FIELD OF INVENTION

The present invention relates to methods and apparatus for implementing radio network spectrum management using blockchain and/or distributed ledger technology including for example radio network scheduling of spectrum resource allocations and/or usage among wireless devices using blockchain and/or distributed ledger technology.

### BACKGROUND

Current 4G and 5G wireless system architectures allow for a base station to schedule the spectrum resources needed as per the required data rate or service types. Each time a device needs to transfer data or request an active connection, time spectrum resources will be granted by a base station scheduler unit with start and end resource numbers for the device to use specifically. Allocation of these resources are being managed by a scheduler. Current resource allocation methods/schemes are described in the European Telecommunications Standards Institute (ETSI) Technical Specification TS 138 212 V 16.2.0 (2020-07) entitled “5G; NR; Multiplexing and channel coding (3GPP TS 38.212 version 16.2.0 Release 16)” which was published by ETSI in July 2020 and which is incorporated herein by reference in its entirety and ETSI TS 138 214 V 16.2.0 (2020-07) entitled “5G; NR; Physical layer procedures for data (3GPP TS 38.214 version 16.2.0 Release 16)” which was published by ETSI in July 2020 and which is incorporated by reference herein in its entirety. For example, section 5.1.2.2 of the 3GPP TS 38.214 version 16.2.0 Release 16 discusses downlink resource allocation schemes in the frequency domain and Section 6.1.2.2 discusses uplink resource allocation schemes in the frequency domain. 3GPP TS 38.212 version 16.2.0 Release 16 Section 7.3.1-1 and Table 7.3.1-1 describe Downlink Control Information formats and the scheduling for the Physical Uplink Shared Channel (PUSCH) used for the transmission of uplink data from wireless devices to a base station and scheduling of Physical Downlink Shared Channel (PDSCH) used for the transmission of data from a base station to a wireless device. The spectrum resources of the PUSCH and PDSCH being shared among the wireless devices being serviced by a base station.

Typically, the control channel signaling (e.g., the Physical Uplink Control Channel (PUCCH) signaling and Physical Downlink Control Channel (PDCCH) signaling) for the scheduling of resource utilization occupies 20% to 30% of the signaling overhead of the air interface (depending on the configuration types). Such overhead impacts the available resources for data transfer in uplink and downlink and hence reduces the network's offered capacity.

The current schemes for scheduling, allocating, and notifying wireless devices of the scheduled spectrum resource allocation is wasteful in that it occupies 20% to 30% of the signaling overhead of the air interface which could otherwise be used for providing services.

From the foregoing, it should be understood that there is a need for new and/or improved methods and apparatus for implementing radio network spectrum management to achieve greater network spectral efficiency. From the foregoing it should further be understood that there is a need for new and/or approved methods and apparatus to more effectively and efficiently schedule and utilize wireless resources (e.g., spectrum) so that additional capacity and services can be provided to wireless users. From the foregoing, it should further be understood that there is a need for new and/or approved methods and apparatus that solve the technological problem of how to more effectively and efficiently utilize wireless resources (e.g., spectrum) of networks through the use of blockchain and/or distributed ledger technology.

### SUMMARY OF THE INVENTION

The present invention provides new and/or improved methods and apparatus for implementing radio network spectrum management that achieve greater and/or improved network spectral efficiency by reducing control channel signaling for scheduling data transfer. Various embodiments of the present invention provide new and/or approved methods and apparatus to more effectively and efficiently schedule and utilize wireless resources (e.g., spectrum or radio resources) so that additional capacity and services can be provided to wireless users. Various embodiments of the present invention, provide need new and/or approved methods and apparatus that solve the technological problem of how to more effectively and efficiently utilize wireless resources (e.g., spectrum or radio resources) of networks through the use of blockchain and/or distributed ledger technology. Various embodiments of the present invention solve one or more of the problems discussed above.

The present invention utilizes blockchain and/or distributed ledger technology to manage radio spectrum resources in a wireless network system. In various embodiments of the invention, a blockchain resource allocation architecture is employed where devices do not need to wait for a base station to allocate resources. The allocation of resources (e.g., shared spectrum resources) is instead based on blockchain with public and private keys where each resource block (e.g., Physical Resource Block (PRB)) per instant has its own unique keys. The wireless devices (e.g., user equipment devices) in the coverage area of specific base stations (e.g., a group or cluster of base stations) will use resources from available resource blocks with allocated private keys as per the wireless'devices need for data transfer. Once the data transfer is completed, the resources (i.e., the resource blocks) will be released so that the spectrum resources can be used by other wireless devices. Each time a wireless device occupies or utilizes resources (e.g., resource blocks), the wireless device will be in an active session and other wireless devices will not be allocated the same resource blocks if it will cause a conflict. This is analogous or similar to the use of a token for digital currency in which only one user can have the token representing the digital currency at one time. In some embodiments, a scheduler in a network node which is part of a distributed radio base station will monitor the usage of resources (e.g., PRBs) as per a wireless device's needs. The base station based on the monitored usage can preempt a device's autonomous allocation of resources. Blockchain and a distributed ledger are used to maintain resource allocation integrity so that other wireless devices do not try to use the same resources (e.g., PRBs) which are already in use by different wireless devices from the same base station coverage area.

An exemplary method embodiment of the present invention includes the steps of: initiating generation of a first smart contract by a first blockchain enabled scheduler of a first base station in response to receiving a first request for radio resources from a first wireless device; generating a first smart contract, by a first smart contract function of the first base station, said first smart contract including: (i) information identifying the first wireless device as a first party to the first smart contract, (ii) information identifying a base station radio system of the first base station that is serving the first wireless device as a second party to the first smart contract, and (iii) terms of the first smart contract; and communicating, by the first smart contract function, a first smart contract offer message to the first wireless device, said first smart contract offer message including information on the parties to the first smart contract and information on the terms of the first smart contract.

In some embodiments, the information on the terms of the first smart contract includes: (i) information on the radio resources to be allocated to the first wireless device for use in communicating with the base station radio system serving the first wireless device, (ii) conditions on when the first smart contract is to be executed, and (iii) one or more actions to be initiated by the first smart contract when the conditions in the first smart contract have been met. In some embodiments, the first smart contract is an executable software routine that performs the following operations: (i) monitoring to detect when the conditions identified in the first smart contract are met; and (ii) in response to detecting that the conditions in the first smart contract are met initiating said one or more actions identified in the first smart contract.

In some method embodiments, the method further includes the steps of: after receiving by the first smart contract function an acceptance of the first smart contract offer by the first wireless device, generating a first token by the first smart contract function of the first base station, said first token authorizing a first wireless device to utilize radio resources identified in the first token for communicating with a first base station radio system of the first base station, said first base station radio system being the base station radio system serving the first wireless device; storing, by the first smart contract function, information on the radio resources authorized for use by the first token in a radio resource allocation ledger; distributing the ledger to the first blockchain enabled scheduler of the first base station; and communicating the first token to the first wireless device. In some embodiments, the information on the radio resources authorized for use by the first token is stored as a block of a radio resource allocation blockchain stored in the radio resource allocation ledger. In some embodiments, the first base station is a distributed base station including: (i) a central computing system, and (ii) a plurality of base station radio systems.

The present invention is also applicable to apparatus and system embodiments wherein one or more devices, nodes or systems implement the steps of the method embodiments. In some apparatus embodiments each of the base stations, entities, schedulers, wireless devices, user equipment devices, central computing systems, servers each of the other apparatus/devices/nodes/servers of the wireless system include one or more processors and/or hardware circuitry, input/output interfaces including receivers and transmitters, and a memory. The memory including instructions which when executed by one or more of the processors control the apparatus/device/node/server of the system to operate to perform the steps and/or functions of various method embodiments of the invention.

An exemplary base station configuration management system in accordance with one embodiment of the present invention includes: a base station comprising: memory; and a first processor, said first processor controlling the base station to perform the following operations: initiating generation of a first smart contract in response to receiving a first request for radio resources from a first wireless device; generating a first smart contract, said first smart contract including: (i) information identifying the first wireless device as a first party to the first smart contract, (ii) information identifying a base station radio system of the base station that is serving the first wireless device as a second party to the first smart contract, and (iii) terms of the first smart contract; and communicating, by the first base station, a first smart contract offer message to the first wireless device, said first smart contract offer message including information on the parties to the first smart contract and information on terms of the first smart contract.

While various embodiments have been discussed in the summary above, it should be appreciated that not necessarily all embodiments include the same features and some of the features described above are not necessary but can be desirable in some embodiments. Numerous additional features, embodiments and benefits of various embodiments are discussed in the detailed description which follows.

### BRIEF DESCRIPTION OF THE DRAWINGS

FIG. 1 illustrates an exemplary system in accordance with an embodiment of the present invention.

FIG. 2 illustrates details of an exemplary implementation of a distributed base station system in accordance with an embodiment of the present invention.

FIG. 3 illustrates another exemplary system in accordance with an embodiment of the present invention.

FIG. 4 illustrates an overview of exemplary Physical Resource Blocks and Resource elements in accordance with an embodiment of the present invention.

FIG. 5 illustrates a high level flowchart of an exemplary blockchain resource allocation functional process flow of an exemplary method in accordance with an embodiment of the present invention.

FIG. 6 illustrates an exemplary token (blockchain) based resource allocation for a group of base station radio systems of a distributed base station in accordance with an embodiment of the present invention.

FIG. 7 illustrates exemplary information contained in an exemplary token in accordance with an embodiment of the present invention.

FIG. 8 comprises FIG. 8A and FIG. 8B.

FIG. 8A illustrates three exemplary Physical Resource Block (PRB) index tables for three different PRB token allocations in accordance with an embodiment of the present invention.

FIG. 8B illustrates an additional three exemplary Physical Resource Block (PRB) index tables for three different PRB token allocations in accordance with an embodiment of the present invention.

FIG. 8 comprises FIG. 8A and FIG. 8B.

FIG. 8A illustrates three exemplary Physical Resource Block (PRB) index tables for three different PRB token allocations in accordance with an embodiment of the present invention.

FIG. 8B illustrates an additional three exemplary Physical Resource Block (PRB) index tables for three different PRB token allocations in accordance with an embodiment of the present invention.

FIG. 9 illustrates another exemplary token (blockchain) based resource allocation for a group of base station radio systems of a distributed base station in accordance with an embodiment of the present invention.

FIG. 10 illustrates exemplary information contained in smart contracts in accordance with an embodiment of the present invention.

FIG. 11 illustrates an exemplary set of blockchain radio resource allocation group ledgers for a first instance in accordance with an embodiment of the present invention.

FIG. 12 illustrates an exemplary set of blockchain radio resource allocation group ledgers for a second instance in accordance with an embodiment of the present invention.

FIG. 13 illustrates an exemplary smart contract ledger in accordance with an embodiment of the present invention.

FIG. 14 illustrates details of an exemplary base station radio system and central computing system which combined form a distributed base station in accordance with an embodiment of the present invention.

FIG. 15 illustrates details of an exemplary wireless device (e.g., a User Equipment (UE) device, a mobile device, cell phone, smartphone, wireless tablet, laptop, wireless notebook), in accordance with an embodiment of the present invention.

FIG. 16 illustrates details of an exemplary server/node/device/network equipment/system in accordance with an embodiment of the present invention.

FIG. 17 illustrates an exemplary assembly of components for a base station radio system in accordance with an embodiment of the present invention.

FIG. 18 illustrates an exemplary assembly of components for a wireless device (e.g. a user equipment device) in accordance with an embodiment of the present invention.

FIG. 19 illustrates an exemplary assembly of components for a server/node/device/network equipment/system in accordance with an embodiment of the present invention.

FIG. 20 comprises FIG. 20A, FIG. 20B, FIG. 20C and FIG. 20D.

FIG. 20A is the first part of an exemplary signaling diagram and method in accordance with an embodiment of the present invention.

FIG. 20B is the second part of an exemplary signaling diagram and method in accordance with an embodiment of the present invention.

FIG. 21 comprises FIG. 21A, FIG. 21B, FIG. 21C, and FIG. 21D.

FIG. 21A illustrates a first part of a flowchart of an exemplary method in accordance with an embodiment of the present invention.

FIG. 21B illustrates a second part of a flowchart of an exemplary method in accordance with an embodiment of the present invention.

FIG. 21C illustrates a third part of a flowchart of an exemplary method in accordance with an embodiment of the present invention.

FIG. 21D illustrates a fourth part of a flowchart of an exemplary method in accordance with an embodiment of the present invention.

### DETAILED DESCRIPTION

The present invention introduces the use of blockchain and distributed ledger technology to wireless systems. The use of these technologies reduces the amount of the over the air spectrum resources currently occupied by signaling overhead (e.g., signaling used to base stations to notify wireless devices of their granted uplink and downlink spectrum resources) which as previously discussed is approximately 20-30% of the available spectrum resources (depending on system configuration types). As also previously discussed above, the present invention utilizes blockchain and/or distributed ledger technology to manage radio spectrum resources (also referred to as resources herein) in a wireless network system. In various embodiments of the invention, a blockchain resource allocation architecture is employed where devices do not need to wait for a base station to allocate resources. The allocation of resources (e.g., shared spectrum resources) is instead based on blockchain with public and private keys where each resource block (e.g., Physical Resource Block (PRB)) per instant has its own unique keys. The wireless devices (e.g., user equipment devices) in the coverage area of specific base stations (e.g., a group or cluster of base stations) will use resources from available resource blocks with allocated private keys as per the wireless'devices need for data transfer. Once the data transfer is completed, the resources (i.e., the resource blocks) will be released so that the spectrum resources can be used by other wireless devices. Each time a wireless device occupies or utilizes resources (e.g., resource blocks), the wireless device will be in an active session and other wireless devices will not be allocated the same resource blocks if it will cause a conflict. This is analogous or similar to the use of a token for digital currency in which only one user can have the token representing the digital currency at one time. In some embodiments, a scheduler in a network node which is part of a distributed radio base station will monitor the usage of resources (e.g., PRBs) as per a wireless device's needs. The base station based on the monitored usage can preempt a device's autonomous allocation of resources. Blockchain and a distributed ledger will be used to maintain resource allocation integrity so that other wireless devices do not try to use the same resources (e.g., PRBs) which are already in use by different wireless devices from the same base station coverage area.

Unlike in the current 4G and 5G system, in an exemplary embodiment of the present invention, wireless devices connected to a base station are allocated tokens and can be begin transmitting uplink data bytes or receiving downlink bytes at a start time indicated in the allocated token using spectrum identified based on information contained in the token.

Considering the limitations on wireless devices (e.g., mobile devices, mobile phones, smartphones, laptops, tablets, wireless sensors, etc.) such as computation ability, power, size, cost, etc. the wireless system architecture keeps most of the components of the system on the base station or network side. In an exemplary embodiment, the base stations of the wireless system are distributed base station. Each base station of a group, cluster or set of base stations has elements/components/functions of the base station implemented in one or more network nodes located at a central site (e.g., a data center) while the transmitter(s), receiver(s) and antenna(s) are located at a different site or site(s). The wireless system architecture (e.g., wireless devices in conjunction with a smart contract function) borrows/obtains/purchases for a period of time currency in the form of spectrum resources from a blockchain scheduler of the base station, use the spectrum resources, and release them back for other wireless devices use upon completion of data transfer or timer expiry of the borrowed/obtained/purchased period of time. The number of resources borrowed/obtained/purchased may be, and in many embodiments is, dependent on availability, need (depends on data size to be transferred by the wireless device, quality of radio environment (e.g., amount of interference, signaling conditions which will impact the rate of data transfer for the UE), Quality of Service contract for the subscriber of the UE and other wireless devices (UEs) in use requiring resources.

In general in blockchain systems, a smart contract function generates a smart contract that conveys the digital actions or transactions, which are organized into blocks, and broadcast or shares these smart contracts with other elements of the system. The network nodes or servers that help maintain the consensus, often known as miners approve the digital actions or transactions identified in the smart contract by inspecting the digital signature and confirming its validity through, e.g., verifying that the payer has sufficient funds in his account for transactions. The miners organize a bundle of valid digital actions into a new block for attachment to the end of the blockchain via a puzzle solving procedure known as mining. In an exemplary embodiment of the present invention, the smart contract and miners functions are located at network servers of a centralized computing system where the functions or digital actions include performing transparent and reliable data exchange, token creation, validation and monitoring with timer expiry, reallocation as per input from a scheduler.

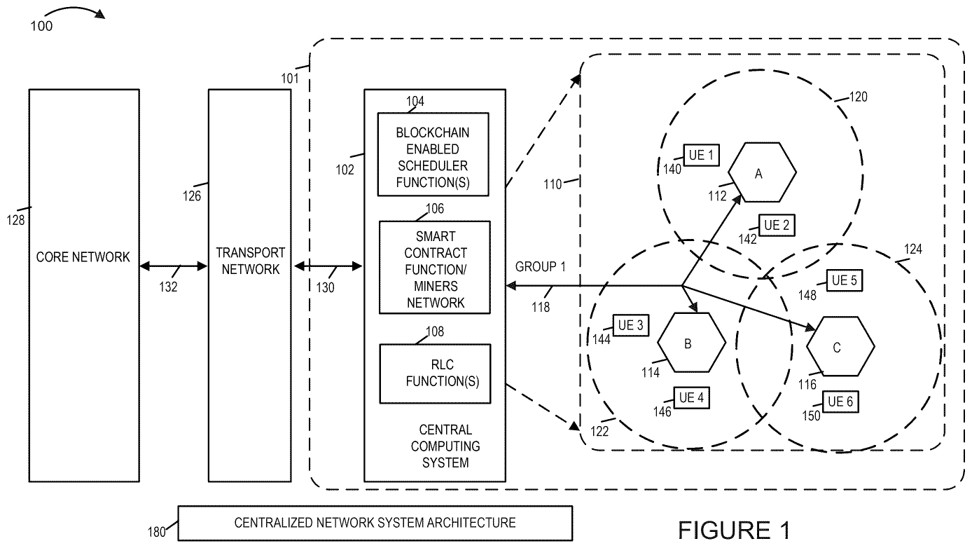

FIG. 1 illustrates elements of a wireless system 100 in accordance with an embodiment of the present invention. System 100 includes a distributed base station system 101, a transport network 126, a core network 128, a plurality of wireless devices (i.e. UE 1 140, UE 2 142, UE 3 144, UE 4 146, UE 5 148, and UE 6 150) and communications links 130 and 132. The communications link 130 couples and/or connects the distributed base station system 101 to the transport network 126. The communications link 132 couples and/or connects the transport network 126 to the wireless core network 128 (e.g., a 5G wireless core network). The communications links 130 and 132 are typically wired, cable or optical high speed and high capacity links. As noted by the legend 180 on FIG. 1, system 100 utilizes a centralized network system architecture. The centralized architecture system 100 will have central components of a scheduler, smart contract function and RLC functionalities as discussed below. In various embodiments, each of these centralized components/functions will have 1:1 redundancy in case of failures.

The distributed base station system 101 includes a set of base station functions implemented as components or applications executing on one or more nodes (e.g., compute nodes) or servers located in a central computing system (e.g., a cloud system) 102. The components may be implemented as hardware components, software components, or a combination of hardware and software components. The distributed base station system 101 function(s) include blockchain enabled scheduler function(s) 104, smart contract function(s)/miners network 106, and Radio Link Controller function(s) 108. The distributed base station system 101 also includes a group, set or cluster of base station radio systems 110 referred to herein as group 1 base station radio systems 110. The group 1 base station radio systems 110 include the base station radio system A 112, base station radio system B 114, and base station radio system C 116 which are coupled and/or connected to the central computing system 102 via communications link 118. The communications link 118 is a typically a high speed high capacity wired or optical communications link. The base station radio systems A 112, B 114, and C 116 include radio units including transmitter(s), receiver(s), and antenna(s) for transmitting and receiving radio communications also sometimes referred to as over the air communications to the wireless devices of the system 100 (i.e., UE 1 140, UE 2 142, UE 144, UE 4 146, UE 5 148, and UE 6 150 within their respective coverage areas using radio resources (i.e., spectrum resources such as Physical Block Resources (PRBs)). Base station radio system A 112 has a coverage area 120. Base station radio system B 114 has a coverage area 122. Base station radio system C 116 has a coverage area 124. As the UEs move between the radio base station coverage areas of the system different radio base stations provide wireless services to the UEs. For example, if UE 1 140 which is located in the coverage area 120 of base station radio system A 112 and is receiving wireless services from base station radio system A 112 moves to the position of UE 3 144 in the coverage area 122 of base station radio system B 114 then UE 1 140 will receive wireless services from base station radio system B 114.

The distributed base station system 101 is implemented with the base station radio system handling or performing the radio frequency transmission physical layer tasks or operations of communicating with the wireless devices being serviced (e.g., wireless signal generation, transmission, and reception of wireless signals) while the non-physical layer tasks (resource scheduling tasks or operations, radio link control task or operations, encryption and decryption, error checking and correction, smart contract tasks and operations, token allocation) are handled or performed by the base station functions located in the central computing system 102. The base station radio systems are sometimes referred to as radio units. In various embodiments, the central system 102 is located in or near the center of the geographical area coverage for the group of base station radio systems so that the communications between the central computing system 102 and base station radio systems is minimized so as to minimize the amount of delay in communications between the base station functions of the distributed base station 101 and the group 1 base station radio systems 110 (i.e., base station radio system A 112, base station radio system B 114, and base station radio system C 116). In various embodiments, the communications link paths to the different base station radio systems A, B, and C are implemented to provide the same or amount of delay within a threshold value between the central computing system 102 and each of the base station radio systems A, B, and C. While one communications link 118 is shown in system 100 in various embodiments of the invention different configuration of links may be implemented such as for example a separate communications link coupling and/or connecting the central computing system 102 to each of the base station radio systems A 112, B 114, and C 116.

It is to be understood that while the exemplary cell coverage areas for the base station radio system A 112, B 114, and C 116 are for a single circular coverage area for each of these base station radio systems, this is only for ease of explanation in order to explain the invention and that each base station radio system may, and in some embodiments do, implement multiple cells and/or cell sectors to provide coverage in various different configurations/areas. The base station radio system cells, cell sector, and antenna(s) configurations may vary depending on implementation and geography, e.g., the systems may be implemented with multiplexed signaling and/or beam forming antenna arrays with multiple cells/cell sectors.

It is also to be understood that while only six user equipment devices (i.e., UE 1 140, UE 2 142, UE 3, 144, UE 4 146, UE 5 148, and UE 6 150 and only three base station radio systems (i.e., A 112, B 114, and C 116) have been illustrated this is only exemplary and that many more UEs and base station radio systems may be and typically are included in base station group, set or cluster. The wireless devices UE 1, UE 2, UE 3, UE 4, UE 5, and UE 6 are coupled and/or connected to the distributed base station radio systems of system 100 via wireless communications links.

While UEs are shown for the wireless devices, it is to be understood that other wireless devices which are subscribed to receive wireless services from the system can also be used such as endpoint devices which are not necessarily user equipment devices or wireless devices which emulate user equipment devices. The UEs of the system 100 can be replaced with any wireless device which receives wireless services from the distributed wireless base station 101.

The central computing system 102 may be, and in some embodiments is, implemented in a cloud system or a data center system having a plurality of compute nodes and/or servers. Each of the compute nodes or servers includes a processor and memory or being attached to memory. In some embodiments, the base station functions (e.g., base station functions 104, 106 and 108) are implemented on the nodes or servers. In some embodiments, the central computing system 102 includes a plurality of servers and each of the servers having a plurality of virtual nodes, base station functions (e.g., base station functions 104, 106, and 108) being implemented as applications on virtual nodes of the system 102. In some embodiments, the blockchain enabled scheduler function(s) 104 is a single function/component that performs the blockchain scheduler tasks/operations for the entire group 1 110 base station radio systems A 112, B 114, and C 116. In some embodiments, smart contract function(s)/miners network 106 is a single function/component that performs the blockchain scheduler tasks/operations for the entire group 1 110 base station radio systems A 112, B 114, and C 116. In some embodiments, the smart contract function(s)/miners network 106 is a single function/component that performs the smart contract/miners network tasks/operations for the entire group 1 110 base station radio systems A 112, B 114, and C 116. In some embodiments, the RLC function(s) are implemented as a single function/component that performs the RLC tasks/operations for the entire group 1 110 base station radio systems A 112, B 114, and C 116. In most, but not all, embodiments, redundancy is implemented by implementing backup blockchain scheduler function(s), smart contract function(s)/miners network, and RLC function(s) on separate hardware within the central computing system (e.g., separate nodes and/or servers).

In the exemplary embodiment, the base station radio systems A 112, B 114, and C 116 utilize the same shared spectrum for communicating with the wireless devices (UE 1 140, UE 2 142, UE 3 144, UE 4 146, UE 5 148 and UE 6 150) for providing wireless services. This is a single channel system, e.g., a single 20 MHz cellular bandwidth channel. The distributed base station system 101 schedules allocation of tokens to wireless devices (i.e., the user equipment devices of the system) to avoid conflicts and interference with the usage of the shared spectrum. Tokens identifying which PRBs of the shared spectrum are to be available for use by a wireless device to which the token was issued as well as the start time and duration of usage.

The core network 128 is for example a 5G core network which provides the functionality of a typical core network including for example: connectivity and mobility management, authentication, authorization, subscriber data management, policy management, traffic handling, billing, and security.

The transport network 126 provides connectivity between the core network and the distributed base station system 101 of the radio network. The transport network 126 is typically an optic and/or wired network providing high speed high capacity which supports bandwidth requirements for example backhaul capacities.

The blockchain enabled scheduler function/component 104 (also sometimes referred to herein as the scheduler and blockchain scheduler) provides spectrum resource allocation management (e.g., management of allocation of PRBs and/or resource elements to wireless devices (e.g., UEs) on a per wireless device buffer status, radio conditions and Quality of Service requirement).

In some embodiments, the scheduler function 104 also maintains or utilizes a database or data structure (e.g., table, linked list, etc.) or blockchain ledger of information corresponding to UEs being serviced by each base station radio system/cell including a unique ID for the UE (e.g., Internation Mobile Equipment Identity (IMEI) and/or Cell Radio Network Temporary Identifier (C-RNTI)), the NR cell global identity (NRCGI) of the distributed base station cell to which the UE is connected, location information of the UE (e.g., GPS coordinates), radio condition information corresponding to the UE, and buffer status information for the UE), requests for resources from the UE and allocation of resources to the UE (e.g., which PRBs or resource elements are allocated for use by the UE and for what specific period of time).

The smart contract function (SCF)/miners network 106 provides transparent and reliable data exchange support, token creation, validation and monitoring with timer expiry, reallocation as per information/instructions/input(s) from the scheduler function 104.

The Radio Link Control (RLC) function 108 provides error correction, segmentation, sequencing, reordering and reassembly of data units functionality.

In various embodiments, additional centralized functions are included in the central computing system such as for example a metrics collection and analyzer function which collects metrics from the individual base station radio systems, the UEs, and the centralized functions such as for example UE location information, radio condition information (e.g., channel state information, signaling interference information (e.g., Signal to Noise Ratio (SINR) information), signal strength information (e.g., Reference Signal Received Power (RSRP) information), Channel Quality Index (CQI) information, Block Error Rate (BLER) information, Reference Signal Received Quality (RSRQ) information, etc.). The metrics collected can then be used by the scheduler in determining resource allocation requirements (e.g., by using the determined radio conditions from the radio condition information when determining the amount of resources to allocate to a UE).

The exemplary wireless devices of the system 100 are user equipment devices (e.g., mobile devices, laptops, tablets, smartphones computers with wireless interfaces, sensors, etc.) used by users which allow access to various wireless services through native and third party applications such as calling applications, texting applications, e-mail applications, applications with internet access, short/long range wireless communications applications, satellite connectivity access, etc.

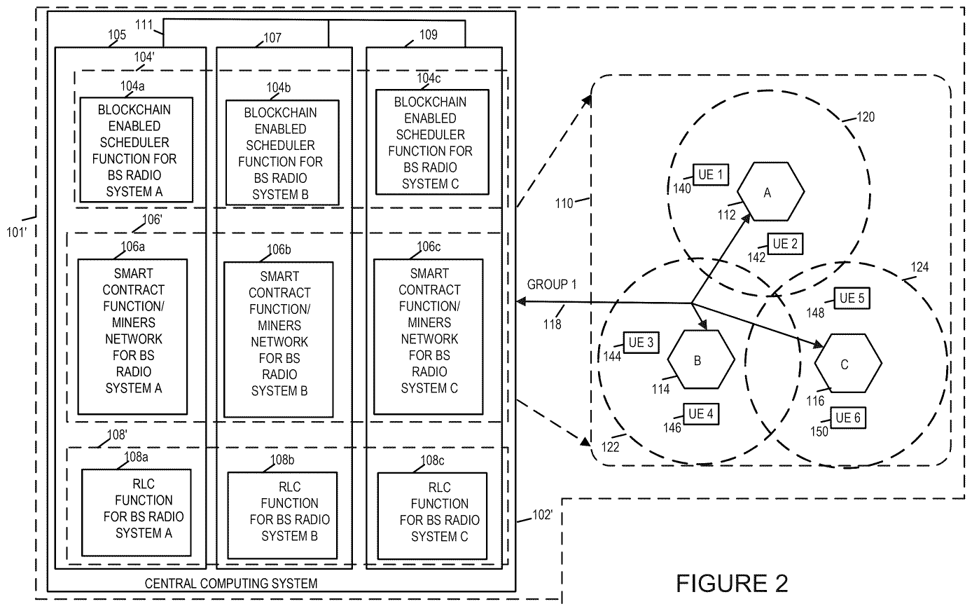

FIG. 2 illustrates an exemplary distributed base station system 101′ which is the same as distributed base station system 101 of system 100 shown in FIG. 1 but with additional details of an exemplary implementation of the central computing system 102 shown as central computing system 102′. Elements or steps with the same reference numbers used in different figures are the same or similar and those elements or steps will not be described in detail again. The central computing system 102 includes a plurality of servers (server 105, 107, 109). In some embodiments, the servers are nodes (e.g., compute node). Each server has base station functions/components corresponding to an individual base station radio system of the group 1 base station radio systems 110. Server 105 includes base station functions/components (blockchain enabled scheduler function 104a, smart contract function 106a, RLC function 108a) for base station radio system A 112. Server 107 includes base station functions (blockchain enabled scheduler function 104b, smart contract function 106b, RLC function 108b) for base station radio system B 114. Server 109 includes base station functions (blockchain enabled scheduler function 104c, smart contract function 106c, RLC function 108c) for base station radio system C 116. The blockchain enabled scheduler function 104 being distributed across servers 105, 107, and 109 as blockchain enabled scheduler function 104a, 104b, and 104c. The smart contract function/miners network 106 being distributed across servers 105, 107, and 109 as smart contract function/miners network 106a, 106b, and 106c. The RLC function 108 being distributed across servers 105, 107, and 109 as RLC function 108a, 108b, and 108c. The communications link 111 allows the exchange of data and information between the servers 105, 107, and 109 of the central computing system 102′. In the exemplary distributed base station system 101′, each of the base station radio systems A 112, B 114 and C 116 has its own set of set of base station functions/components which operate together and are located together on a server. Having separate servers providing the base station functions for each of the base station radio system A 112, B 114, and C 116 allows for the failure of one server to not affect the ability of the other base station radio systems to continue to operate and provide services. The use of a distributed ledger which includes the allocated resources among the different blockchain schedulers 104a, 104b, and 106c allows for backup and integrity of the system should one server be affected.

An exemplary embodiment of the distributed ledger and blockchain of the system 100 will now be discussed.

Each of the base station radio systems A 112, B 114, and C 116 of system 100 is assigned a unique identifier (e.g., New Radio cell global identity (NRCGI)) and each wireless device of the system 100 (UE 1 140, UE 2 142, UE 3 144, UE 4 146, UE 5 148, UE 6 150) is also assigned a unique identifier (e.g., International Mobile Equipment Identity or the Cell Radio Network Temporary Identifier (C-RNTI), the C-RNTI being a unique identifier used in cellular networks, including 5G wireless networks which is a temporary identifier assigned to a UE by the base station (in the case of 5G networks this is the gNodeB) when the UE first successfully establishes a connection to the cellular network). The unique base station radio system ID (e.g., NRCGI for the base station radio system) is a public key and the UE unique identifier is a private key. The unique base station radio system identifier and unique wireless device identifiers may be, and in some embodiments, are used for one or more of the following tasks: signing, identifying and verifying items, actions and/or information contained in smart contracts, tokens and/or the ledger. These unique identifiers are also used in gathering and analyzing metrics including for example to count and measure the average use of resources per distributed base station system per wireless device, use of resources per base station radio system per wireless device, etc. It should be noted that as the wireless communications between the UEs and the base station radio system are already encrypted in many embodiments no additional encryption is used for communications of the smart contracts or the tokens they contain.

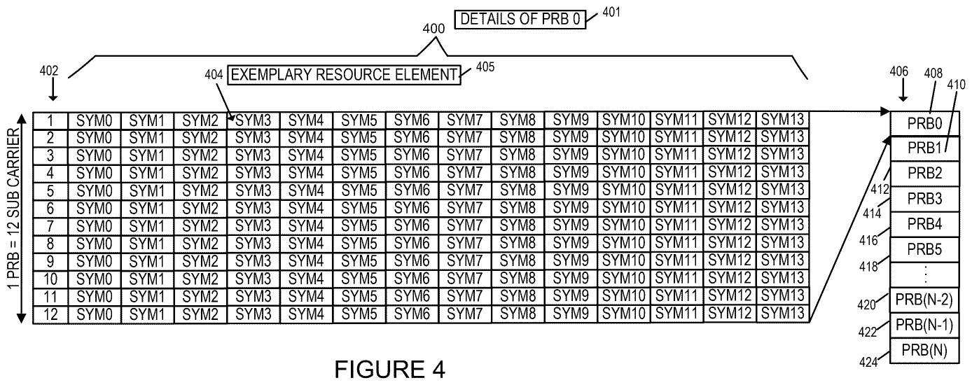

FIG. 4 illustrates an overview of a set of N physical resource blocks (PRBs) 406 (N being an integer greater than 7) illustrated as a single column array or table in accordance with an embodiment of the present invention. Each PRB The set of N physical resource blocks 406 includes the following physical resource blocks: PRB 0 408, PRB 1 410, PRB 2 412, PRB 3 414, PRB 4 416, PRB 5 418, . . . , PRB (N-2) 420, PRB (N-1) 422, PRB (N) 424. The details of an exemplary PRB which in this case is PRB 0 is illustrated in table 400 as noted by label 401. Each PRB of the set of PRBs 406 has 12 subcarriers each of the subcarriers as shown by the subcarrier index 402 for PRB 0 has 14 orthogonal frequency-division multiplexing (OFDM) symbols (symbol 0 (SYM0), symbol 1 (SYM1), symbol 2 (SYM2), symbol 3 (SYM3), symbol 4 (SYM4), symbol 5 (SYM5), symbol 6 (SYM6), symbol 7 (SYM7), symbol 8 (SYM8), symbol 9 (SYM9), symbol 10 (SYM10), symbol 11 (SYM11), symbol 12 (SYM12), and symbol 13 (SYM13)). Each of these symbols is a resource element. Subcarrier 1 symbol 3 404 is an exemplary resource element as indicated by label 405.

In some embodiment of system 100, each PRB will have its own unique block code ID and if needed each resource element (RE) of each PRB can have a unique ID.

For example, within a 24 hour time period with a 5 MHz channel bandwidth (25 PRBs) with 15 KHz subcarrier spacing (SCS):

$$Total number of subframes ( 1 ms subframe duration ) = {( number of hours per period )}^{*} {( number of minutes per hour )}^{*} {( number of seconds per minute )}^{*} ( number of subframes per second ) = {24}^{*} {60}^{*} {60}^{*} 1000 = 86 , 400 , 000 subframes .$$

$$Total PRB index = {( total number of subframes )}^{*} ( number of PRBs per subframe ) = 86 , 400 , {000}^{*} 25 = {2.16}^{*} {10}^{9} PRBs . In the example of Figure 4 , N would be {2.16}^{*} {10}^{9} - 1.$$

$$Total Resource Elements = {( total number of PRBs )}^{*} {( number of subcarriers per PRB )}^{*} ( number of symbols per subcarrier ) = {2.16}^{*} {{10}^{9}}^{*} {12}^{*} 14 = {362}^{*} {10}^{9} resource elements .$$

In an exemplary embodiment, each day at 00 interval (e.g., midnight 12:00:00 a.m., the PRB index (e.g., N from PRB N from FIG. 4) is reset to zero.

In some embodiments, each wireless device (UE of system 100) at any specific event, are allowed to self allocate available resources using tokenization and release the resources for use by other wireless devices (other UEs of system 100) when the wireless device's need for the resources is completed (e.g., completion of data transfer). Tokenization is a method of using the resources identified in a token issued by a smart contract function of a distributed base station of a network rather than the back and forth resource request process between wireless device and the network currently in use. Token contents include information from which the PRBs available for use by a wireless device can be identified. In one embodiment, a token issued to a UE includes the index of PRBs for a period of time and the PRBs of the index marked as available for use (e.g., a “1” marking) or not available for use (e.g., “0” marking) by the UE until the token expires.

In one embodiment, the PRB index for an entire 24 period is used. In some such embodiments, only portions of the entire PRB index relevant to the wireless devices allocation of resources identified in the token are provided in the token. For example, the token identifies the PRBs from the PRB index corresponding to time period from a first time (e.g., time T1 01:00:00:00:00) to a second time (e.g., time T2 which is 10 milliseconds later 01:00:00:01:00) which are available for use by the wireless device.

In some embodiments, instead of the PRBs being indexed the resource elements are indexed and are identified in the tokens for use by the UE requesting resources.

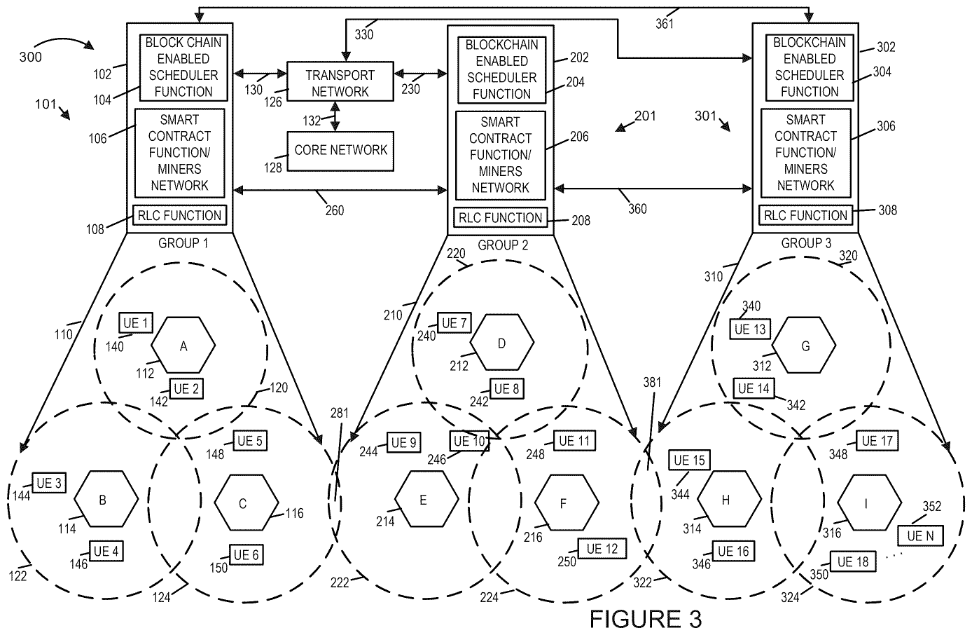

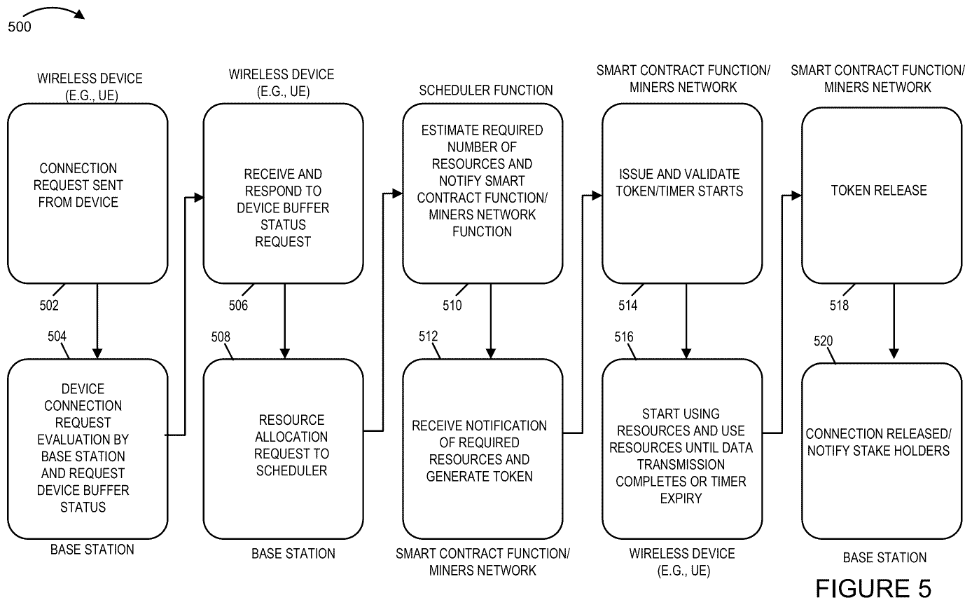

FIG. 5 illustrates a high level flowchart of an exemplary blockchain resource allocation functional process flow of a method 500 in accordance with an embodiment of the present invention. While it will be readily understood that additional steps/functions are performed in connection with communicating information and messages between devices, the method 500 focuses on and discusses the steps for understanding the invention. The method 500 will be discussed in connection with the exemplary system 100 but is not limited to being implemented on system 100 and can be implemented on other systems such as for example system 300 shown in FIG. 3.

Method 500 begins in step 502 shown on FIG. 5 wherein a wireless device (e.g., UE 1 140 of system 100) generates and sends a connection request to a base station (e.g., distributed base station system 101) of a wireless system (e.g., system 100) to which the user of the wireless device is a subscriber. Operation proceeds from step 502 to step 504.

In step 504, the base station (e.g., base station radio system A 112 of distributed base station system 101) receives and evaluates the connection request. In addition, the base station also generates and sends a buffer status request to the wireless device from which the connection request was received. In some embodiments, the radio system of the base station receives and evaluates the connection request as well as communicates the buffer status request to the requesting wireless device. In some other embodiments, the base station radio system (e.g., base station radio system A 112 receives the connection request from the wireless device and communicates it to a function in a central computing system of a distributed base station system (e.g., RLC function 108) which performs the evaluation of the connection request and sends the buffer status request to the base station radio system which transmits it the wireless device from which the connection request was received. Operation proceeds from step 504 to step 506.

In step 506, the wireless device receives and responds to the device buffer status request indicating a buffer size and/or an amount of data to be transferred for which wireless resources (e.g., PRBs) are required. In some embodiments, the buffer size will indicate the amount of data to be transferred and/or a data rate which needs to be supported to ensure that there isn't a buffer overflow at the device. In some embodiments, the wireless device in response to the buffer status request generates and communicates a buffer status report to the base station. The buffer status report including information on the amount of data available for transmission in the wireless device's uplink buffers. Operation proceeds from step 506 to step 508.

In step 508, the base station receives the response to the device buffer status request from the wireless device and using the information contained in the response generates and communicates a resource allocation request to a scheduler function (e.g., radio system A 112 of distributed base station system 101 receives the response to the device buffer status request and communicates it to RLC function 108 which generates and communicates a resource allocation request to the blockchain enabled scheduler function 104 of the central computing system 102 of the distributed base station system 101). Operation proceeds from step 508 to step 510.

In step 510, the scheduler function based on the information included in the buffer status response determines and/or estimates a required number of resources (e.g., PRBs or resource elements (i.e., OFDM symbols) needed for and/or to be provided to the wireless device and notifies the smart contract function/miners network (e.g., smart contract function/miners network 106).

In some embodiments, the determination and/or estimate is further based on resources currently available for use by the base station radio system (e.g., base station radio system A 112), the radio conditions at the wireless device (e.g., signaling conditions) and/or the base station radio system, and the QoS requirements for the wireless device (e.g., subscriber QoS per contract with wireless network system service provider). The radio conditions will take into account radio packets that will be lost due to signaling interference and/or poor signal strength in the location of the wireless device. In some embodiments, the required number of resources is also based on the type of application for which the resources will be used (e.g., phone application in which dropped packets are not retransmitted as opposed to data transmission application in which the lost packets are re-transmitted and where data loss is not permitted).

In some embodiments, the scheduler makes the determination or estimate of the amount of radio resources (e.g., PRBs or resource elements of PRBs) to be allocated for use by the wireless device to communicate with the base station radio system serving the wireless device based on: (i) information contained in the buffer status report received by the first blockchain enabled scheduler from the wireless device and (ii) information contained in a blockchain ledger, each block of the blockchain ledger including: (i) information on radio resources of the distributed base station that have been allocated for use by a wireless device being served by the distributed base station, (ii) information on the identity of the wireless device to which the radio resources have been allocated, and (iii) information on the identity of the base station radio system serving the wireless device to which the radio resources have been allocated.

In some embodiments, the scheduler makes the determination and/or estimate of the required number of radio resources (e.g., PRBs or resource elements (i.e., OFDM symbols) to be allocated to the first user equipment device also based on one or more of the following: (i) coverage area of the base station radio system serving the wireless device, (ii) number of wireless devices actively being served by the base station radio system serving the wireless device, (iii) radio conditions at the wireless device (e.g., channel conditions and/or signal interference conditions (SINR) determined based on reports from the wireless device and/or determined based on reference signals received from the wireless device at the distributed base station), (iv) modulation scheme to be utilized for data transmission (e.g., Quadrature Amplitude Modulation (QAM) scheme—16-QAM, 64-QAM, 256-QAM, etc. or modulation index from 5G standard set of modulation indices), (v) Quality of Service (QoS) to be provided to the wireless device (e.g., via contract between subscriber of the wireless devices and operator of the distributed base station), and (vi) type of application on the wireless device requesting the radio resources (e.g., voice call application, text messaging application, e-mail communications application, data transfer application, multi-media application, internet service application, emergency services application (e.g., 911 service application)). Operation proceeds from step 510 to step 512.

In step 512, the smart contract function/miners network receives the notification from the scheduler function of the determined and/or estimated required number of resources (e.g., PRBs or resource elements) required and/or to be provided for the wireless device and generates a token which includes information for identifying the resources to be utilized by the wireless device from the resources available for use. This includes analyzing the blockchain of resources designated in currently issued tokens for usage by other UEs connected to the base station radio system to which the UE is connected (e.g., what resources are available for use at base station radio system A 112 and it is to be noted that the resources available for use at base station radio system A 112 is different than base station radio system B 114 and base station radio system C 116 as each have different coverage areas with the exception of the portions of the coverage area which overlap). Generation of the token includes determining and locating which of the available resources (e.g., PRBs and/or resource elements) to allocate or make available to the wireless device and the amount of time that the wireless device can use the resources identified in the token. The token may, and in some embodiments does, include a start time and a stop or token expiration time which defines the duration of use. In some embodiments, a start time is provided and the PRBs identified for use will dictate a stop time or token expiration time. In some embodiments, the start time is determined by the wireless device from the current date with a new PRB index being used at the start of each day that is for each day or 24 hour period the PRBs for use are identified based on PRB index for the 24 hour period. If the wireless device is in a coverage area overlapping with the coverage area of another base station radio system coverage area (e.g., UE connected to base station radio system A 112 but in area also covered by base station system B 114 then the determination of available resources includes excluding PRBs that are currently in use by base station radio system B 114 which would cause interference or collisions with transmissions from the UE to the radio base station system A 112, i.e., excluding use of the same PRBs in overlapping coverage area by two different base stations) In some embodiments, this is achieved through analysis of the identified resources allocated in active tokens by the overlapping base station radio systems as well as reports from the UE and/or the base station radio systems of the strength of the received signals from the UEs in determining if a problem such as collisions will or have occurred. In various embodiments, the base station radio systems will have coverage areas with minimum overlap and then coordination will occur at the base station scheduler function and smart contract function to minimize the same PRBs being used in an overlapping coverage area (e.g., by base station radio systems and/or RLC function identifying UEs in overlapping areas and informing the scheduling function and/or smart contract function which is performing the identification of available resources (i.e., PRBs) to made available to the UEs in the overlapping area).

In some embodiments, the scheduler function not only determines or estimates the number of resources required (e.g., PRBs) but also locates the specific PRBs to make available instead of the smart contract function identifying the specific PRBs. The scheduler function uses the same process described above in connection with the smart contract function for locating/identifying the PRBs to make available for use by the wireless device. In such embodiments, the smart contract then generates the token based on the scheduler function identified PRBs.

Operation proceeds from step 512 to step 514. In step 514, the smart contract function/miners network issues the generated token to the wireless device by communicating it to the RLC function and then to the base station radio system to the wireless device. The smart contract function also performs validation of the token's usage, starts the expiry timer and monitors for token expiration. Operation proceeds step 514 to step 516.

In step 516, the wireless device starts using the resources identified by the information in the token (e.g., by using the PRBs identified in the token). The wireless device continues to use the identified resources until the data transmission completes or token expiry timer expires. Operation proceeds from step 516 to step 518.

In step 518, the smart contract function/miners network releases the token. Operation proceeds from step 518 to step 520.

In step 520, the base station (e.g., base station radio system A 112) releases the connection and notifies the stake holders of the release. The stake holders being for example the RLC function, scheduler, smart contract function/miners network function.

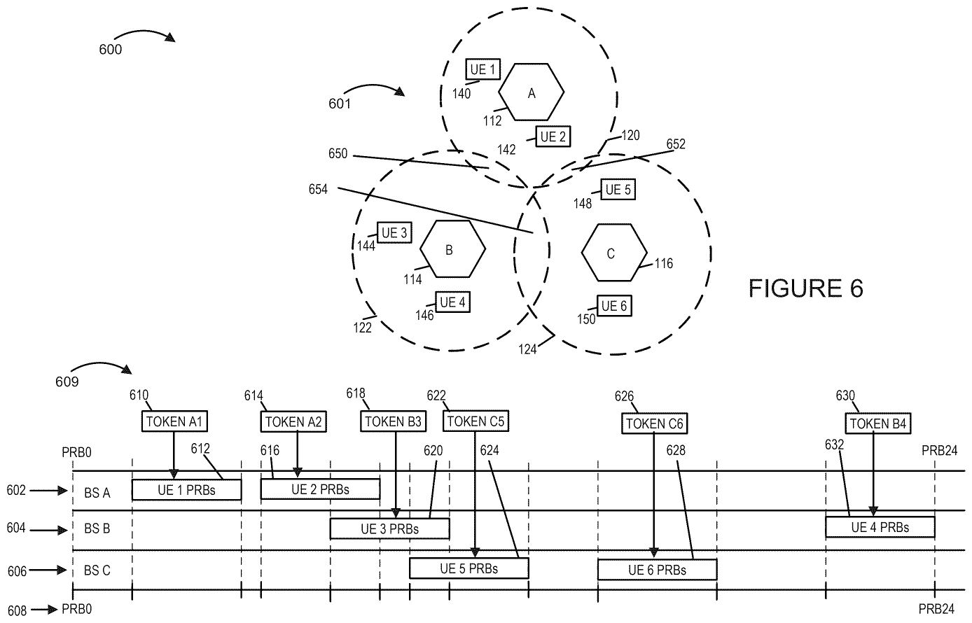

Diagram 600 of FIG. 6 illustrates exemplary token (blockchain) based resource allocation for the group 1 base station radio systems 110 of distributed base station 101 of system 100 in accordance with an embodiment of the present invention. Diagram 601 illustrates the base station radio systems A 112, B 114, and C 116 of group 1 110 of the distributed base station 101 of system 100 along with the user equipment devices UE 1 140, UE 2 142, UE 3 144, UE 4 146, UE 5 148 and UE 6 150. UE 1 140 and UE 2 142 are within the coverage area 120 of radio base station system A 112 and are connected to and receiving wireless services from base station radio system A 112. UE 3 144 and UE 4 146 are within the coverage area 122 of radio base station system B 114 and are connected to and receiving wireless services from base station radio system B 114. UE 5 148 and UE 6 150 are within the coverage area 124 of radio base station system C 116 and are connected to and receiving wireless services from base station radio system C 116.

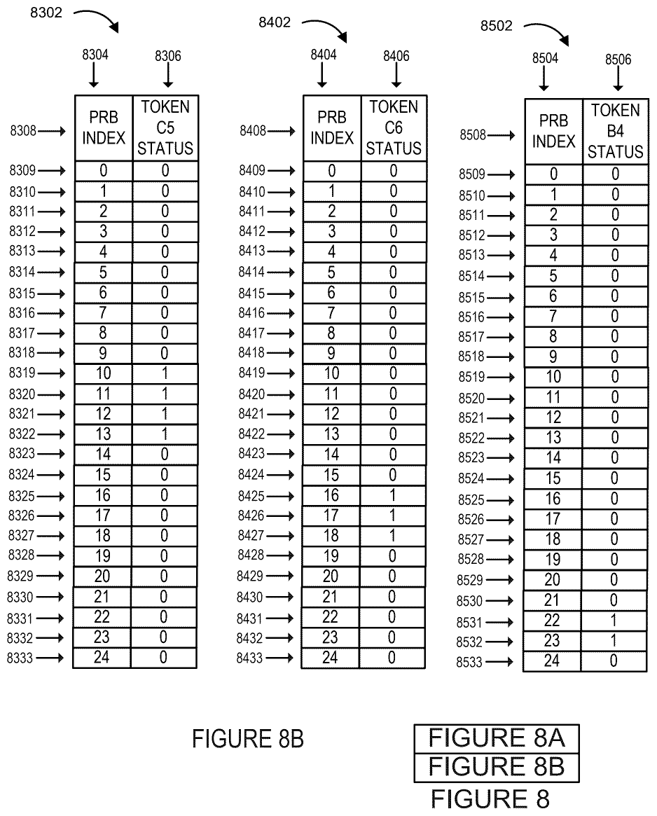

Each of the group 1 110 base station radio systems or radio units has a separate coverage area. The coverage areas partially overlap as shown in diagram 101. None of the UEs which are being serviced in the example shown in diagram 601 are within the overlapping coverage areas. The distributed base station 101 has a 5 MHz channel bandwidth with 15 KHz subcarrier spacing (SCS) resulting in 25 PRBs per subframe with each subframe has a 1 ms duration as discussed in connection with FIG. 4. Each of the group 1 110 base station radio systems A 112, B 114, and C 116 utilize the same 5 MHz channel. Diagram 609 illustrates the allocation of radio resources in the form of PRBs via tokens (token A1 610, token A2 614, token B3 618, token C5 622, token C6 626, and token B4 630) issued to the user equipment devices (UE 1 140, UE 2 142, UE 3 144, UE 4 146, UE 5 148, and UE 6 150) of system 100 by the distributed base station system 101 for a 1 ms duration starting at the beginning of a day e.g., 2024-01-20 00:00:00:00:00:00. This results in the allocation of 25 PRBs which are indexed from PRB 0 to PRB 24 608 and are shown as progressing from left to right as time proceeds. The distribution of PRBs which progress from PRB 0 to PRB 24 is not to scale but is intended to shown the overlap of the same resources (i.e., PRBs) being allocated in different coverage areas corresponding to the different group 1 110 base station radio systems of the distributed base station 101. The actual PRBs allocated in the tokens is described in detail in FIG. 8.

Radio resource allocation 602 for base station radio system A 112 illustrates that token A1 610 issued to UE 1 140 by the distributed base station system 101 has reserved PRBs 612 for use by UE 1 140 to communicate with base station radio system A 112 and token A2 614 issued to UE 2 142 by the distributed base station system 101 has reserved PRBs 616 for use by UE 2 142 to communicate with base station radio system A 112.

Radio resource allocation 604 for base station radio system B 114 illustrates that token B3 618 issued to UE 3 144 by the distributed base station system 101 has reserved PRBs 620 for use by UE 3 144 to communicate with base station radio system B 114 and token B4 630 issued to UE 4 146 by the distributed base station system 101 has reserved PRBs 632 for use by UE 4 146 to communicate with base station radio system B 114.

Radio resource allocation 606 for base station radio system C 116 illustrates that token C5 622 issued to UE 5 148 by the distributed base station system 101 has reserved PRBs 628 for use by UE 5 148 to communicate with base station radio system C 116 and token C6 626 issued to UE 6 150 by the distributed base station system 101 has reserved PRBs 628 for use by UE 6 150 to communicate with base station radio system C 116.

The distribution of PRBs in diagram 609 which progresses from PRB 0 to PRB 24 is not to scale but is intended to show the overlap of the same resources (i.e., PRBs) being allocated in different coverage areas corresponding to the different group 1 110 base station radio systems A 112, B 114, and C 116 of the distributed base station 101. The actual PRBs allocated in the tokens is described in detail in FIG. 8.

In the example of radio resource allocation via tokens shown in FIG. 6, the diagram 609 illustrates how tokens A2 614, B3 618 and C5 622 have reserved or allocated overlapping PRB resources for different user equipment devices. Token B3 618 has PRBs 620 reserved/allocated for UE 3 144 which is being served by base station radio system B 114. The PRBs 620 are shown as having some PRBs overlapping with the PRBs 616 identified in token A2614 which are reserved for use by UE 2 144. Additionally, the PRBs 620 are shown as having some PRBs overlapping with the PRBs 624 identified in token C5 622 which are served for use by UE 5 148. This is allowable because each of the base station radio systems A 112, B 114, and C 116 have different coverage areas with only some overlap. The amount of overlap by the base station radio systems A, B, and C can be controlled and minimized during design and during usage by changing one or more of the base station radio systems A, B, and/or C configuration including changing antenna directions, using beam forming techniques, and changing radio unit signal strength. Furthermore, the distributed base station system 101 will coordinate the usage of the PRBs by the base station radio systems A, B, and C of the distributed base station system 101 to minimize interference and potential collisions of radio transmission to/from different UEs.

In the example of diagram 601 the wireless devices UE 1 140, UE 2 142, UE 3 144, UE 4 146, UE 5 148 and UE 6 150 are not operating within any of the overlapping coverage areas 650, 652 or 654 of the base station radio systems A 112, B 114, and C 116. As UE 2 142, UE 3 144 and UE 5 148 are being served by different base station radio systems A 112, B 114, and C 116 and are not in an overlapping coverage area UE 2 142, UE 3 144 and UE 5 148 can each utilize the same radio resources (e.g., PRBs). In the example of radio resource allocation diagram 609 UE 2 142, UE 3 144, and UE 5 148 have been issued tokens granting the use of some overlapping PRBs. FIG. 8 PRB index token A1 status table 8102 shows that token A2 has identified PRBs 6, 7 and 8 as being reserved for use by UE 2 142 when communicating with base station radio system A 112. FIG. 8 PRB index token B3 status table 8202 shows that token B3 has identified PRBs 8, 9, 10 as being reserved for use by UE 3 144 when communicating with base station radio system B 114. FIG. 8 PRB index token C5 status table 8304 shows that token C5 has identified PRBs 10, 11, and 12 as being reserved for use by UE 4148 when communicating with base station radio system C 116. The use of PRB 8 by UE 2 142 to communicate with base station radio system A 112 and UE 3 144 to communicate with base station radio system B 114 does not cause a problem as UE 2 and UE 3 are not in an overlapping coverage area between base station radio system A 112 and base station radio system B 114. Similarly, the use of PRB 10 by UE 3 144 to communicate with base station radio system B 114 and UE 5 148 to communicate with base station radio system C 116 does not cause a problem as UE 3 and UE 5 are not in an overlapping coverage area between base station radio system B 114 and base station radio system C 116. The use of a centralized computing system 102 with a centralized scheduler function and centralized smart contract/miners function which has more computing power than a standalone non-distributed base station allows for the efficient and effective use of radio resources through blockchain token and distributed ledger tracking of the issued token, the UEs to which they were issued, the duration for which they were issued, and the radio resources identified for use (e.g., PRBs). The use of blockchain distributed ledgers ensures the integrity of the radio resource allocation so the same radio resources will not be allocated to the UEs being served by the same base station radio system.

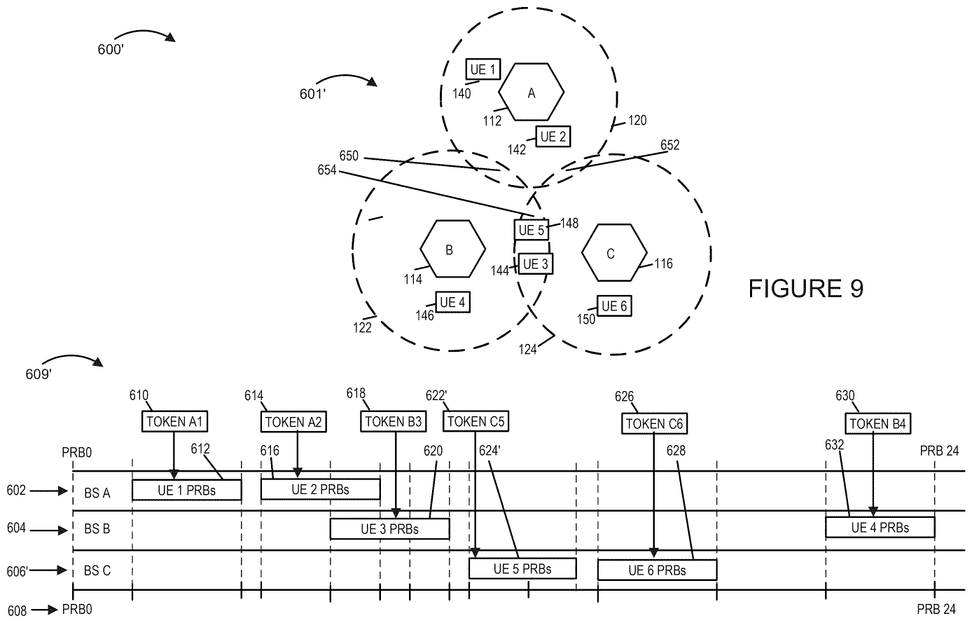

Diagram 600′ of FIG. 9 illustrates another exemplary token (blockchain) based resource allocation for the group 1 base station radio systems 110 of distributed base station system 101 of system 100 in accordance with an embodiment of the present invention. Diagram 601′ illustrates the base station radio systems A 112, B 114, and C 116 of group 1 110 of the distributed base station 101 of system 100 along with the user equipment devices UE 1 140, UE 2 142, UE 3 144, UE 4 146, UE 5 148 and UE 6 150. UE 1 140 and UE 2 142 are being served by radio base station system A 112 and are connected to and receiving wireless services from base station radio system A 112. UE 3 144 is within the overlapping coverage area 654 where base station radio system B 114 coverage area 122 overlaps with base station radio system C 116 coverage area 124. UE 3 144 is connected to and being served by radio base station system B 114. UE 4 146 is within the coverage area 122 of base station radio system B 114 and is connected to and being served by radio base station system B 114. UE 5 148 is within the overlapping coverage area 654 where base station radio system B 114 coverage area 122 overlaps with base station radio system C 116 coverage area 124. UE 5 148 is connected to and being served by radio base station system C 116. UE 6 150 is within the coverage area 124 of base station radio system C 116 and is connected to and being served by radio base station system C 116. As UE 2 142 and UE 3 144 are not in an overlapping coverage area 650 where the coverage area 120 of base station radio system A 112 overlaps with the coverage area 122 of base station radio system B 114, UE 2 142 and UE 3 144 can use overlapping resources as shown by resource allocation diagram 609′ showing Token A 614 has reserved for UE 2 144 use PRBs 616 some of which overlap with the Token B3 618 PRBs 620 reserved for UE 3 144 as previously discussed in connection with FIG. 6. UE 3 144 and UE 5 148 are operating in overlapping coverage are 654 and are being served by different base station radio systems of the group 1 base station radio systems 110 of distributed base station system 101.

The distributed base station system 101 will be able to determine whether UEs are within the overlapping coverage areas (e.g., overlapping coverage areas 650, 652, and 654) and which overlapping coverage area from information reported by the UEs of the system including for example: (i) location information (e.g., GPS information), (ii) information identifying which base station radio system A, B, or C is each UE's active serving base station radio system (e.g., which base station radio system A, B, or C is connected to), (iii) strength of the different base station radio system signals being received by each of the UEs (e.g., Reference Signal Received Strength from the different base station radio system A, B, C), (iv) signal strength of radio transmission from each UE being received by the different base station radio systems. The distributed base station system 101 will also be able to determine whether more than one UE from different base station radio systems are within the same overlapping coverage area and potentially pose a problem (e.g., interference problem). Whether the use of the same PRBs by the different UEs will potentially be a problem can be determined through location of the UEs (e.g., in an overlapping coverage area) and/or the use of signal strength of signals received by the UEs from the different base station radio systems (e.g., RSRP) and/or by signal strength of signals received by the different base station radio system from the UEs. When a potential problem is determined, the distributed base station system 101 will refrain from scheduling the use of the same PRBs for the two UEs being served by different base station radio systems in the overlapping coverage area. In the example of 601′, the distributed base station system 101 determines that the UE 3 144 and UE 5 148 are in overlapping coverage area 654 and are being served by different base station radio systems B 114 and C 116 respectively. This determination in some embodiments is made based information reported from the base station radio systems and/or UE 3 144 and/or UE 5 148. In some embodiments, the base station radio system B 114 receives signals from UE 5 148 and base station radio system C 116 receives signals from UE 3 144 and based on these received signals a determination is made that UE 3 144 and UE 5 148 are within coverage area 654. In some embodiments, the UE 3 143 receives signals (e.g., Base Station Radio System C Reference Signal) from base station radio system C 116 and UE 5 148 receives signals (e.g., Base Station Radio System Reference Signal) from base station radio system B 114 and based on these received signals a determination is made that UE 3 144 and UE 5 148 are within coverage area 654. In some embodiments, once the determination is made that UE 3 144 and UE 5 148 are in overlapping coverage area 654 and are being served by different base stations, the distributed base station system 101 (e.g., scheduling function 104 or smart contract function/miners network 106) determine to refrain from scheduling, allocating, or reserving the same radio resources (e.g., the same PRBs to UE 3 144 and UE 5 148). In some embodiments, the distributed base station system 101 after determining that UE 3 144 and UE 5148 are within overlapping coverage area 654 and are being serviced by different base station radio systems determines based on reported signal strength measurements (e.g., RSRP measurements) whether the UE 3 144 and UE 5 148 can utilize the same radio resources. For example, when the signal strength measurements exceed a signal strength threshold level then the determination is made that the same radio resources (e.g., PRBs) can not be used because of the level of interference. Whereas when the signal strength measurements do not exceed the signal strength threshold level then the same radio resources can be used for UE 3 and UE 5 as the level of interference is low enough to be tolerated by the devices.

For example, the scheduler function 104 and/or the smart contract function/miner network 106 of distributed base station system 101 when notified that UE 3 144 being served by base station radio system B 114 and UE 5 148 being served by base station radio system C 148 are in overlapping coverage area 654 will refrain from reserving the same resources (e.g., PRBs) for use by UE 3 144 and U5 148. In some embodiments, the decision of whether or not to refrain from allocating the same resources (e.g., PRBs) to the UE 3 144 and UE 5 148 is further determined based on signaling strength measurements. If the signaling strength measurements indicate that the base station radio system B 114 and base station radio system C 116 for uplink traffic will not result in interference to the point of inability to decode the PRBs from UE 3 144 and UE 5 146 then the same PRBs can be used by UE 3 and UE 5 otherwise the same PRBs will not be allocated for use by UE 3 144 and UE 5 148.

In the example of FIG. 9 it has been determined that the distributed base station system 101 is to refrain from reserving or allocating for use the same radio resources (e.g., PRBs) by UE 3 144 and UE 5 148. The smart contract function/miners network when searching for and determining available radio resources will refrain from identifying the same radio resources for use by UE 3 144 and UE 5 148. The resource allocation 606′ for base station radio system C 116 has been modified from that shown in resource allocation 606 of FIG. 6. It has been changed so that token C5 622′ issued to UE 5 148 identifies PRBs 624′ for use in communicating with base station radio system C 116. The identified PRBs 624′ do not overlap with the PRBs 620 identified in token B3 618 issued to UE 3 144 for use in communicating with base station radio system B 114.

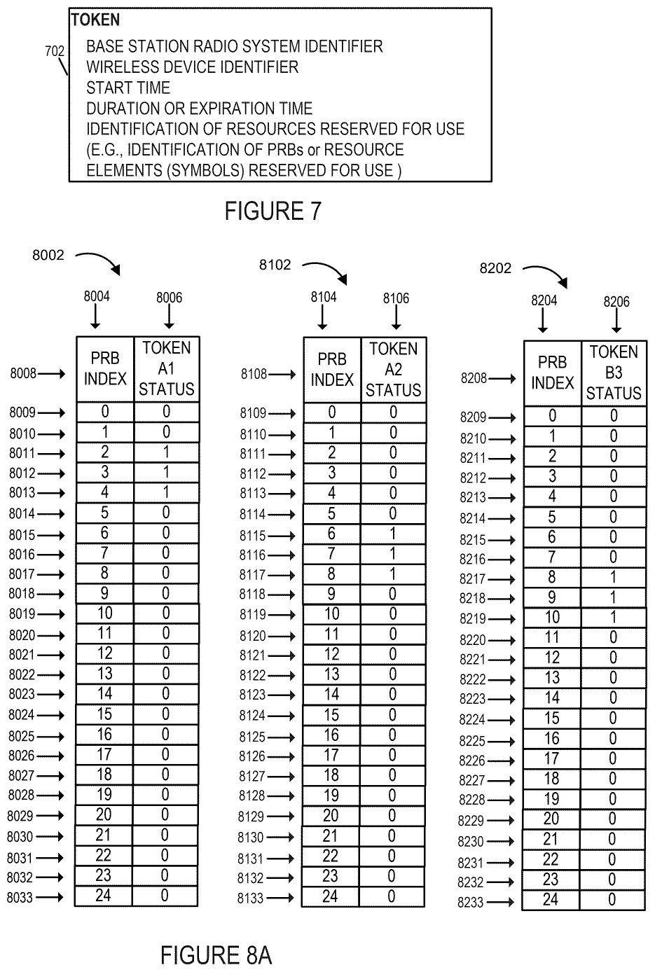

FIG. 7 illustrates an exemplary token 702. The exemplary token 702 includes the following information: (i) base station radio system identifier information (e.g., NRCGI), (ii) wireless device identifier (e.g., IMEI or C-RNTI), (iii) start time (e.g., time stamp 2024-01-20 00:00:00:00:00), (iv) identification of resources reserved for use by the wireless device (e.g., identification of PRBs and/or resource elements (symbols of PRBs) reserved for use by the wireless device. In some embodiments, the token 702 also includes a token expiration time and/or a duration of use time which indicates when the token expires (e.g., 10 milliseconds from start time or a time stamp in which 10 ms is indicated from the start time—2024-01-20 00:00:00:10:00) and the radio resources identified in the token are no longer available for the UE's use. In some embodiments, the start time and duration time are indicated by the resources identified such as when a resource index for a time period (e.g., an entire day or 24 hour time period) is utilized the start of which is known (e.g., PRBs are identified so that the wireless device can determine based on time of day which PRBs it is allowed to use—for example PRBs 0, 1, 5, 7, 8, 25, 28, 29, 30, 40 are identified for use which covers the time period of 2 ms from 2024-01-20 00:00:00:00:00 the start of day when PRB index is reset. 25 PRBs per sub-frame which is 1 ms in duration as discussed in connection with the example of FIG. 4. The UE being aware when the PRB index is reset and when the PRBs will occur based on the PRB index being for a 24 hour period starting at timestamp 00:00:00:00:00. In some embodiments, the token index is for a sub-frame starting at the start time and the PRB index designates which PRBs in the sub-frame are reserved for the UEs use while the token is valid that is not expired. The token will be encrypted using the same encryption procedures used for other messages and data communicated via the radio link between the wireless device and the base station radio system serving it so that only the wireless device identified in the token to which it has been issued can decrypt and read the contents of the token and know which radio resources (e.g., PRBs have been reserved for the wireless device's use in communicating with the base station radio system serving it).

FIG. 8 comprises FIG. 8A and FIG. 8B. Tables 8002, 8102, 8202 shown on FIG. 8A and tables 8302, 8402, and 8502 shown on FIG. 8B are exemplary PRB index tables for the PRB token allocations shown in diagram 609 of FIG. 6. Table 8002 is included in token A1 610 and identifies the UE 1 PRBs 612 reserved and/or allocated for use by UE 1 140. Table 8102 is included in token A2 614 and identifies the UE 2 PRBs 616 reserved and/or allocated for use by UE 2 142. Table 8202 is included in token B3 618 and identifies the UE 3 PRBs 620 reserved and/or allocated for use by UE 3 144. Table 8302 is included in token C5 622 and identifies the UE 5 PRBs 624 reserved and/or allocated for use by UE 5 148. Table 8402 is included in token C6 626 and identifies the UE 6 PRBs 628 reserved and/or allocated for use by UE 6 150. Table 8502 is included in token B4 630 and identifies the UE 4 PRBs 632 reserved and/or allocated for use by UE 4 146.

Table 8002 includes columns 8004 and 8006 and rows 8008, 8009, 8010, 8011, 8012, 8013, 8014, 8015, 8016, 8017, 8018, 8019, 8020, 8021, 8022, 8023, 8024, 8025, 8026, 8027, 8028, 8030, 8131, 8032, and 8033. The entries in row 8008 are labels indicating the information contained in each column. Entries in column 8004 identify the PRB index number (row 8008, column 8004 entry). The entries in column 8006 are the Token A1 status (“1” indicated reserved for the UE's use or “0” not reserved for the UE's use) (row 8008, column 8006). Each row provides the status for a different PRB of the PRB index. The table 8002 is read as follows the PRB 0 (row 8009, column 8004 entry) is not reserved or allocated for use by UE 1 as the token A1 status for PRB 0 is “0” (row 8009, column 8006 entry). PRB 1 (row 8010, column 8004 entry) is not reserved or allocated for use by UE 1 as the token A1 status for PRB 1 is “0” (row 8010, column 8006 entry). PRB 2 (row 8011, column 8004 entry) is reserved or allocated for use by UE 1 as the token A1 status for PRB 2 is “1” (row 8011, column 8006 entry). PRB 3 (row 8012, column 8004 entry) is reserved or allocated for use by UE 1 as the token A1status for PRB 3 is “1” (row 8012, column 8006 entry). PRB 4 (row 8013, column 8004 entry) is reserved or allocated for use by UE 1 as the token A1 status for PRB 4 is “1” (row 8013, column 8006 entry). The remainder of the rows of the table are read in the same manner as described for rows 8009, 8010, 8011, 8012, and 8013 and indicate that the PRBs 5, 6, 7, 8, 9, 10, 11, 12, 13, 14, 15, 16, 17, 18, 19, 20, 21, 22, 23 and 24 each have a status of “0” indicating that they are not reserved or allocated for use by UE 1.

Table 8102 includes columns 8104 and 8106 and rows 8108, 8109, 8110, 8111, 8112, 8113, 8114, 8115, 8116, 8117, 8118, 8119, 8120, 8121, 8122, 8123, 8124, 8125, 8126, 8127, 8128, 8130, 8131, 8132, and 8133. The entries in row 8108 are labels indicating the information contained in each column. Entries in column 8104 identify the PRB index number (row 8108, column 8104 entry). The entries in column 8106 are the Token A2status (“1” indicated reserved for the UE's use or “0” not reserved for the UE's use) (row 8108, column 8106). Each row provides the status for a different PRB of the PRB index. The table is read the same as described above in connection with table 8002. The table indicates that PRBs 6, 7, and 8 have a status of “1” indicating that they are reserved or allocated for use by UE 2 and that PRBs 0, 1, 2, 3, 4, 5, 9, 10, 11, 12, 13, 14, 15, 16, 17, 18, 19, 20, 21, 22, 23, and 24 have a status of “0” indicating that these PRBs are not reserved or allocated for use by UE 2.

Table 8202 includes columns 8204 and 8206 and rows 8208, 8209, 8210, 8211, 8212, 8213, 8214, 8215, 8216, 8217, 8218, 8219, 8220, 8221, 8222, 8223, 8224, 8225, 8226, 8227, 8228, 8230, 8232, 8232, and 8233. The entries in row 8208 are labels indicating the information contained in each column. Entries in column 8204 identify the PRB index number (row 8208, column 8204 entry). The entries in column 8206 are the Token B3 status (“1” indicated reserved for the UE's use or “0” not reserved for the UE's use) (row 8208, column 8206). Each row provides the status for a different PRB of the PRB index. The table is read the same as described above in connection with table 8002. The table indicates that PRBs 8, 9, 10 have a status of “1” indicating that they are reserved or allocated for use by UE 3 and that PRBs 0, 1, 2, 3, 4, 5, 6, 7, 11, 12, 13, 14, 15, 16, 17, 18, 19, 20, 21, 22, 23, and 24 have a status of “0” indicating that these PRBs are not reserved or allocated for use by UE 3.

Table 8302 includes columns 8304 and 8306 and rows 8308, 8309, 8310, 8311, 8312, 8313, 8314, 8315, 8316, 8317, 8318, 8319, 8320, 8321, 8322, 8323, 8324, 8325, 8326, 8327, 8328, 8330, 8331, 8332, and 8333. The entries in row 8308 are labels indicating the information contained in each column. Entries in column 8304 identify the PRB index number (row 8308, column 8304 entry). The entries in column 8306 are the Token C5 status (“1” indicated reserved for the UE's use or “0” not reserved for the UE's use) (row 8308, column 8306). Each row provides the status for a different PRB of the PRB index. The table is read the same as described above in connection with table 8002. The table indicates that PRBs 10, 11, 12 and 13 have a status of “1” indicating that they are reserved or allocated for use by UE 5 and that PRBs 0, 1, 2, 3, 4, 5, 6, 7, 8, 9, 14, 15, 16, 17, 18, 19, 20, 21, 22, 23, and 24 have a status of “0” indicating that these PRBs are not reserved or allocated for use by UE 5.

Table 8402 includes columns 8404 and 8406 and rows 8408, 8409, 8410, 8411, 8412, 8413, 8414, 8415, 8416, 8417, 8418, 8419, 8420, 8421, 8422, 8423, 8424, 8425, 8426, 8427, 8428, 8430, 8431, 8432, and 8433. The entries in row 8408 are labels indicating the information contained in each column. Entries in column 8404 identify the PRB index number (row 8408, column 8404 entry). The entries in column 8406 are the Token C6 status (“1” indicated reserved for the UE's use or “0” not reserved for the UE's use) (row 8408, column 8406). Each row provides the status for a different PRB of the PRB index. The table is read the same as described above in connection with table 8002. The table indicates that PRBs 16, 17, and 18 have a status of “1” indicating that they are reserved or allocated for use by UE 6 and that PRBs 0, 1, 2, 3, 4, 5, 6, 7, 8, 9, 10, 11, 12, 13, 14, 15, 19, 20, 21, 22, 23, and 24 have a status of “0” indicating that these PRBs are not reserved or allocated for use by UE 6.

Table 8502 includes columns 8504 and 8506 and rows 8508, 8509, 8510, 8511, 8512, 8513, 8514, 8515, 8516, 8517, 8518, 8519, 8520, 8521, 8522, 8523, 8524, 8525, 8526, 8527, 8528, 8530, 8531, 8532, and 8533. The entries in row 8508 are labels indicating the information contained in each column. Entries in column 8504 identify the PRB index number (row 8508, column 8504 entry). The entries in column 8506 are the Token B4 status (“1” indicated reserved for the UE's use or “0” not reserved for the UE's use) (row 8508, column 8506). Each row provides the status for a different PRB of the PRB index. The table is read the same as described above in connection with table 8002. The table indicates that PRBs 22 and 23 have a status of “1” indicating that they are reserved or allocated for use by UE 4 and that PRBs 0, 1, 2, 3, 4, 5, 6, 7, 8, 9, 10, 11, 12, 13, 14, 15, 16, 17, 18, 19, 20, 21, and 24 have a status of “0” indicating that these PRBs are not reserved or allocated for use by UE 4.

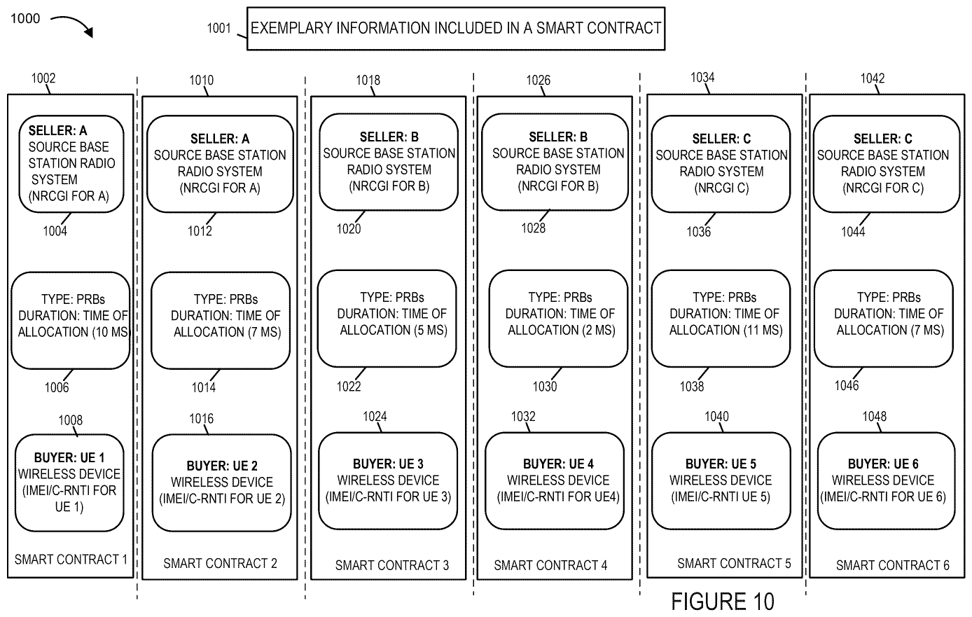

FIG. 10 diagram 1000 illustrates exemplary information or contents included in smart contracts as the title 1001 of FIG. 10 indicates. The exemplary smart contracts will be discussed in connection with the system 100 shown in FIG. 1 but it should be understood that the duration of the allocations of radio resources are only exemplary and are not for the allocations of radio resources shown in diagram 600 of FIG. 6.

Information included in smart contract 1 1002 includes the identification of the parties to the smart contract which are radio base station system A 112 of the distributed base station system 101 of system 100 (party 1 seller identification information 1004) and the wireless device UE 1 140 of system 100 (party 2 buyer identification information 1008). The base station radio system A 112 is identified as the seller and the UE 1 140 is identified as the buyer. The radio base station system A 112 is identified in the example by the New Radio Cell Global Identifier (NRCGI) for the base station radio system A 112. The wireless device UE 1 in the example is identified by its IMEI and/or C-RNTI. The smart contract 1 1002 also includes information on the radio resources to be allocated, reserved and/or granted (1006) for the use of wireless device 1 (UE 1 140) to communicate with the radio base station system A 112 of the distributed base station system 101. In this example, the smart contract 1002 information on the radio resources identifies the type of radio resources to be allocated/reserved/granted to the wireless device UE 1 as PRBs and the duration of the allocation which is 10 ms.

Information included in smart contract 2 1010 includes the identification of the parties to the smart contract which are radio base station system A 112 of the distributed base station system 101 of system 100 (party 1 seller identification information 1012) and the wireless device UE 2 142 of system 100 (party 2 buyer identification information 1016). The base station radio system A 112 is identified as the seller and the UE 2 142 is identified as the buyer. The radio base station system A 112 is identified in the example by the New Radio Cell Global Identifier (NRCGI) for the base station radio system A 112. The wireless device UE 2 in the example is identified by its IMEI and/or C-RNTI. The smart contract 2 1010 also includes information on the radio resources to be allocated, reserved and/or granted (1014) for the use of wireless device 2 (UE 2 142) to communicate with the radio base station system A 112 of the distributed base station system 101. In this example, the smart contract 1010 information on the radio resources identifies the type of radio resources to be allocated/reserved/granted to the wireless device UE 2 as PRBs and the duration of the allocation which is 7 ms.

Information included in smart contract 3 1018 includes the identification of the parties to the smart contract which are radio base station system B 114 of the distributed base station system 101 of system 100 (party 1 seller identification information 1020) and the wireless device UE 3 144 of system 100 (party 2 buyer identification information 1024). The base station radio system B 114 is identified as the seller and the UE 3 144 is identified as the buyer. The radio base station system B 114 is identified in the example by the New Radio Cell Global Identifier (NRCGI) for the base station radio system B 114. The wireless device UE 3 in the example is identified by its IMEI and/or C-RNTI. The smart contract 3 1018 also includes information on the radio resources to be allocated, reserved and/or granted (1022) for the use of wireless device 3 (UE 3 144) to communicate with the radio base station system B 114 of the distributed base station system 101. In this example, the smart contract 1018 information on the radio resources identifies the type of radio resources to be allocated/reserved/granted to the wireless device UE 3 as PRBs and the duration of the allocation which is 5 ms.

Information included in smart contract 4 1026 includes the identification of the parties to the smart contract which are radio base station system B 114 of the distributed base station system 101 of system 100 (party 1 seller identification information 1028) and the wireless device UE 4 146 of system 100 (party 2 buyer identification information 1032). The base station radio system B 114 is identified as the seller and the UE 4 146 is identified as the buyer. The radio base station system B 114 is identified in the example by the New Radio Cell Global Identifier (NRCGI) for the base station radio system B 114. The wireless device UE 4 in the example is identified by its IMEI and/or C-RNTI. The smart contract 4 1026 also includes information on the radio resources to be allocated, reserved and/or granted (1030) for the use of wireless device 4 (UE 4 146) to communicate with the radio base station system B 114 of the distributed base station system 101. In this example, the smart contract 1026 information on the radio resources identifies the type of radio resources to be allocated/reserved/granted to the wireless device UE 4 as PRBs and the duration of the allocation which is 2 ms.

Information included in smart contract 5 1034 includes the identification of the parties to the smart contract which are radio base station system C 116 of the distributed base station system 101 of system 100 (party 1 seller identification information 1036) and the wireless device UE 3 144 of system 100 (party 2 buyer identification information 1040). The base station radio system C 116 is identified as the seller and the UE 5 148 is identified as the buyer. The radio base station system C 116 is identified in the example by the New Radio Cell Global Identifier (NRCGI) for the base station radio system C 116. The wireless device UE 5 in the example is identified by its IMEI and/or C-RNTI. The smart contract 5 1034 also includes information on the radio resources to be allocated, reserved and/or granted (1038) for the use of wireless device 5 (UE 5 148) to communicate with the radio base station system C 116 of the distributed base station system 101. In this example, the smart contract 1034 information on the radio resources identifies the type of radio resources to be allocated/reserved/granted to the wireless device UE 5 as PRBs and the duration of the allocation which is 11 ms.

Information included in smart contract 6 1042 includes the identification of the parties to the smart contract which are radio base station system C 116 of the distributed base station system 101 of system 100 (party 1 seller identification information 1046) and the wireless device UE 6 150 of system 100 (party 2 buyer identification information 1048). The base station radio system C 116 is identified as the seller and the UE 6 150 is identified as the buyer. The radio base station system C 116 is identified in the example by the New Radio Cell Global Identifier (NRCGI) for the base station radio system C 116. The wireless device UE 6 in the example is identified by its IMEI and/or C-RNTI. The smart contract 6 1042 also includes information on the radio resources to be allocated, reserved and/or granted (1046) for the use of wireless device 6 (UE 6 150) to communicate with the radio base station system C 116 of the distributed base station system 101. In this example, the smart contract 1042 information on the radio resources identifies the type of radio resources to be allocated/reserved/granted to the wireless device UE 6 as PRBs and the duration of the allocation which is 7 ms.

In some embodiments, the type of radio resources is resource elements (OFDM symbols) of PRBs. In some embodiments, the smart contract information also includes a quantity or amount of radio resources that are being allocated/reserved/granted for the use of the wireless device identified in the smart contract. In some embodiments, the information on the radio resources included in the smart contract include information identifying the specific PRBs to be allocated for a period of time which will be included in a token to be issued to the wireless device on execution of the smart contract. In such embodiments, the smart contract typically with the help of a plurality of miner functions identifies the specific radio resources (PRBs) for the period of time from the available radio resources for the distributed base station and in particular for the base station radio system serving the wireless device which will be a party to the smart contract.

In some embodiments, the smart contract also includes the conditions or terms of the smart contract which when met will trigger the self execution of the smart contract. In some embodiments, the smart contract also includes the action(s) to be taken when the conditions or terms of the smart contract are met. For example, the conditions or terms to be met by the smart contract may be, and in some embodiments are, that the smart contract function which sends a smart contract offer message to the wireless device identified as the buyer receive a confirmation of acceptance of the smart contract offer from the wireless device to which it was sent. In some embodiments, in addition to sending the smart contract offer to the wireless device identified in the contract it is also sent to the base station radio system identified in the smart contract and an additional condition that needs to be met of the smart contract is that an acceptance of the smart contract offer must also be received from the base station radio system identified in the smart contract. Examples of when the conditions of the smart contract may not be met are for example when the wireless device moves positions and is handed off from one base station radio system to another or from one distributed base station to another and the smart contract identifies the original base station radio system which is no longer valid. In another example, the base station radio system may not accept the smart contract offer when it is experiencing problems and is scheduled to be taken off line or go through an update or reset for maintenance during at least a portion of the duration indicated in the smart contract.

The action(s) to be taken by the smart contract function when the conditions are met (i.e., receipt of an acceptance of the smart contract offer from the wireless device and/or the base statin radio system identified in the smart contract) for example include one or more of the following: (i) determining or initiating the determination (e.g., via instructions to miners or miner functions) of the specific radio resources (e.g., PRBs if the type is PRB or resource elements if the type is resource elements) to be utilized by the wireless device for the duration of time specified in the smart contract, (ii) generating a token, (iii) updating the blockchain ledger tracking the use of radio resources of the distributed radio base station 101 (e.g., by including the smart contract and the generated token or information included therein in a new block of the blockchain ledger), (iii) distributing the updated blockchain ledger to other elements of the system (e.g., the blockchain enabled scheduler function, other smart contract functions, and/or other distributed base stations such as those with overlapping coverage area(s)), (iv) issuing the token or communicating the token to the wireless device and the base station radio system identified in the smart contract, (v) monitoring the status of the data transmission between the wireless device and radio base station system serving the wireless device for completion or time out of the token expiry timer and taking action(s) in response what the monitors detects; (vi) updating the blockchain ledger to indicate completion of the smart contract and that the radio resources identified in the issued token for the smart contract are no longer being reserved or used and are available for use by other wireless devices (such as for example other wireless devices being served by the base station radio system identified in the smart contract or wireless devices in the proximity of the wireless device identified in the smart contract which is being served by another base station radio system which is in overlapping coverage area), (vii) distributing the updated blockchain ledger to other elements of the system (e.g., the blockchain enabled scheduler function (e.g., for use in determining future amounts of radio resources to be allocated to wireless devices based on future requests for radio resources from those wireless devices), other smart contract functions (e.g., when each base station radio system has its own smart contract function as in the example of system 101′ other smart contract functions of other distributed base stations such as with overlapping coverage areas), and/or other distributed base stations such as those with overlapping coverage area.

The actions to be taken by the smart contract may be, and typically are, instructions (e.g., software instructions or other code instructions which when executed cause the hardware (e.g., server, compute node, or device) on which the smart contract function is executing to perform the actions (e.g., which may be operations or tasks) identified in the smart contract.

The token will include information identifying the determined specific radio resources which are reserved/allocated/granted for the use of the wireless device (e.g., table 8002), a start time (e.g., a timestamp indicating when the wireless device identified in the smart token can being using the allocated/reserved radio resources identified in the token. The start time is the time the radio resource allocation in the token commences. The token may, and in some embodiments does, also include the time of duration of the token or an expiration of the token after which the radio resource grant in the token is no longer valid. In some embodiments, this expiration time can be determined from the radio resources identified. In some embodiments, the wireless device uses the duration time included in the smart contract information which would be conveyed with the smart contract offer. Token 702 of FIG. 7 discussed herein includes exemplary information which may be and sometimes is included in a token.

While system 100 illustrates an exemplary system in accordance with the present invention for a single distributed base station system with a plurality of group base station radio systems, the invention is not limited to a single distributed base station system and can be applied to a plurality of distributed base station system. FIG. 3 illustrates an exemplary wireless system 300 in accordance with an embodiment of the present invention. The wireless system 300 illustrates one example of how system 100 may be expanded to include additional distributed base station systems. Elements or steps with the same reference numbers used in different figures are the same or similar and those elements or steps will not be described in detail again. The wireless system 300 includes three distributed base stations 101, 201, and 301, a transport network 126 and a core network 128. Distributed base stations 201 and 301 are implemented the same as or similar to the distributed base station 101 discussed above.

The distributed base station 201 includes a central computing system 202 and the group 2 set of base station radio systems D 212, E 214, and F 216 to which the central computing system 202 is coupled and/or connected. In some embodiments, the group 2 base station radio systems are implemented as a cluster of base station radio systems which appear as a single base station radio system.

The central computing system 202 includes a set of base station functions implemented as components or applications executing on one or more nodes (e.g., compute nodes) or servers located in a central computing system (e.g., a cloud system) 202. The components may be implemented as hardware components, software components, or a combination of hardware and software components. The distributed base station system 201 function(s) include blockchain enabled scheduler function(s) 204, smart contract function(s)/miners network 206, and Radio Link Controller function(s) 208. The distributed base station system 101 as discussed also includes a group, set or cluster of base station radio systems 210 referred to herein as group 2 base station radio systems 210. The group 2 base station radio systems 210 include the base station radio system D 212, base station radio system E 214, and base station radio system F 216 which are coupled and/or connected to the central computing system 202 via a communications link similar to communications link 118 but which is not shown. The communications link is a typically a high speed high capacity wired or optical communications link. The base station radio systems D 212, D 214, and C 216 include radio units including transmitter(s), receiver(s), and antenna(s) for transmitting and receiving radio communications also sometimes referred to as over the air communications to the wireless devices of the system 300 (i.e., UE 1 140, UE 2 142, UE 144, UE 4 146, UE 5 148, UE 6 150, UE 7 240, UE 8 242, UE 9 244, UE 10 246, UE 11 248, UE 12 250, UE 13 340, UE 14, 342, UE 15344, UE 16 346, UE 17 348, UE 18 350, . . . , UE N 352 (where N is an integer greater than 15) within their respective coverage areas using radio resources (i.e., spectrum resources such as Physical Block Resources (PRBs)). Base station radio system D 212 has a coverage area 220. Base station radio system E 214 has a coverage area 222. Base station radio system F 216 has a coverage area 224. As the UEs move between the radio base station coverage areas of the system different radio base stations provide wireless services to the UEs. For example, if UE 5 148 which is located in the coverage area 124 of base station radio system C 116 and is receiving wireless services from base station radio system C 116 moves to the position of UE 9 244 in the coverage area 222 of base station radio system E 214 then UE 5 148 will receive wireless services from base station radio system E 214.

The distributed base station system 201 is implemented with the base station radio system handling or performing the radio frequency transmission physical layer tasks or operations of communicating with the wireless devices being serviced (e.g., wireless signal generation, transmission, and reception of wireless signals) while the non-physical layer tasks (resource scheduling tasks or operations, radio link control task or operations, encryption and decryption, error checking and correction, smart contract tasks and operations, token allocation) are handled or performed by the base station functions located in the central computing system 202. The base station radio systems are sometimes referred to as radio units. In various embodiments, the central computing system 202 is located in or near the center of the geographical area coverage for the group of base station radio systems so that the communications between the central computing system 202 and base station radio systems D 212, E 214 and F 216 is minimized so as to minimize the amount of delay in communications between the base station functions of the distributed base station 201 and the group 2 base station radio systems 210 (i.e., base station radio system D 212, base station radio system E 214, and base station radio system F 216). In various embodiments, the communications link paths to the different base station radio systems D, E, and F are implemented to provide the same or amount of delay within a threshold value between the central computing system 202 and each of the base station radio systems D, E, and F.

The distributed base station 301 includes a central computing system 302 and the group 3 set of base station radio systems G 312, H 314, and I 316 to which the central computing system 302 is coupled and/or connected. In some embodiments, the group 3 base station radio systems are implemented as a cluster of base station radio systems which appear as a single base station radio system.

The central computing system 302 includes a set of base station functions implemented as components or applications executing on one or more nodes (e.g., compute nodes) or servers located in a central computing system (e.g., a cloud system) 302. The components may be implemented as hardware components, software components, or a combination of hardware and software components. The distributed base station system 301 function(s) include blockchain enabled scheduler function(s) 304, smart contract function(s)/miners network 306, and Radio Link Controller function(s) 308. The distributed base station system 301 as discussed also includes a group, set or cluster of base station radio systems 210 referred to herein as group 3 base station radio systems 310. The group 3 base station radio systems 310 include the base station radio system G 312, base station radio system H 314, and base station radio system I 316 which are coupled and/or connected to the central computing system 302 via a communications link similar to communications link 118 but which is not shown. The communications link is a typically a high speed high capacity wired or optical communications link. The base station radio systems G 312, H 314, and I 316 include radio units including transmitter(s), receiver(s), and antenna(s) for transmitting and receiving radio communications also sometimes referred to as over the air communications to the wireless devices of the system 300 (i.e., UE 1 140, UE 2 142, UE 144, UE 4 146, UE 5 148, UE 6 150, UE 7 240, UE 8 242, UE 9 244, UE 10 246, UE 11 248, UE 12 250, UE 13 340, UE 14, 342, UE 15 344, UE 16 346, UE 17 348, UE 18 350, . . . , UE N 352 (where N is an integer greater than 15) within their respective coverage areas using radio resources (i.e., spectrum resources such as Physical Block Resources (PRBs)). Base station radio system G 312 has a coverage area 320. Base station radio system H 314 has a coverage area 322. Base station radio system I 316 has a coverage area 324. As the UEs move between the radio base station coverage areas of the system different radio base stations provide wireless services to the UEs. For example, if UE 12 150 which is located in the coverage area 224 of base station radio system F 216 and is receiving wireless services from base station radio system F 216 moves to the position of UE 16 346 in the coverage area 322 of base station radio system H 314 then UE 12 250 will receive wireless services from base station radio system H 314.

The distributed base station system 301 is implemented with the base station radio system handling or performing the radio frequency transmission physical layer tasks or operations of communicating with the wireless devices being serviced (e.g., wireless signal generation, transmission, and reception of wireless signals) while the non-physical layer tasks (resource scheduling tasks or operations, radio link control task or operations, encryption and decryption, error checking and correction, smart contract tasks and operations, token allocation) are handled or performed by the base station functions located in the central computing system 302. The base station radio systems are sometimes referred to as radio units. In various embodiments, the central computing system 302 is located in or near the center of the geographical area coverage for the group of base station radio systems so that the communications between the central computing system 302 and base station radio systems G 312, H 314 and I 316 is minimized so as to minimize the amount of delay in communications between the base station functions of the distributed base station 201 and the group 3 base station radio systems 310 (i.e., base station radio system G 312, base station radio system H 314, and base station radio system I 316). In various embodiments, the communications link paths to the different base station radio systems G, H, and I are implemented to provide the same or amount of delay within a threshold value between the central computing system 302 and each of the base station radio systems G, H, I.

The central computing system 202 of the distributed base station system 201 is coupled and/or connected to the transport network 126 via communications link 230. The central computing system 302 of distributed base station system 301 is coupled and/or connected to the transport network 126 via communications link 330. The central computing system 302 of the distributed base station 301 is coupled and/or connected to the central computing system 202 distributed base station system 201 via communications link 260. The central computing system 202 of distributed base station system 201 is coupled and/or connected to the central computing system 302 of distributed base station 301 via communications link 360. The central computing system 102 of the distributed base station system 101 is coupled and/or connected to the central computing system 302 of distributed base station system 301 via communications link 361. The communications links 230, 260, 330, 360 and 361 are typically optical or cable links that are high speed high capacity and allow the distributed base station central computing systems to communicate with one another (e.g., with respect to smart contract information, radio resource allocations, ledgers, information on UEs and base stations used for deconfliction of radio resource allocations in overlapping coverage areas, etc.). Each of the radio base stations A 112, B 114, C 116, D 212, E 214, F 216, G 312, H 314, and I 316 in various embodiments utilize the same spectrum resources also referred to as radio resources for example a 5 MHz channel of bandwidth.

Each of the distributed base stations 101, 201, and 301 distribute their radio resource allocation ledgers (e.g., blockchain radio resource allocation ledgers) to the other distributed base stations of the system 300. For example, the smart contract functions 106, 206 and 306 each distribute the radio resource allocation ledger to the other smart contract functions of the system 300 ensuring integrity of the ledger and that it is available if a problem should occur. Furthermore, the distribution of the group 1, group 2, and group 3 radio resource allocation ledgers is used in the management and coordination of allocation of radio resources for the overall system 300.

The central computing systems 102, 202, and 302 coordinate the handling of the allocation of radio resources in the overlapping coverage areas 281 and 381 to avoid interference between the different base station radio systems as previously discussed in connection with overlapping coverage areas 650, 652, and 654 shown in FIG. 9. The distributed radio resource allocation ledgers for groups 1, 2, and 3 among the smart contract functions 106, 206, and 306 of the distributed base stations along with additional information on signal strength measurements of UEs and base station radio systems'reference signals allows for efficient and effective allocation of radio resources (e.g., PRBs and resource elements) to UEs being served by different radio base station systems of different groups in an overlapping coverage area without causing interference by allocating different PRBs to the UEs in the overlapping coverage area (e.g., when signal strength measurements indicate it is necessary (e.g., signal strength threshold has been exceeded) to avoid interference).

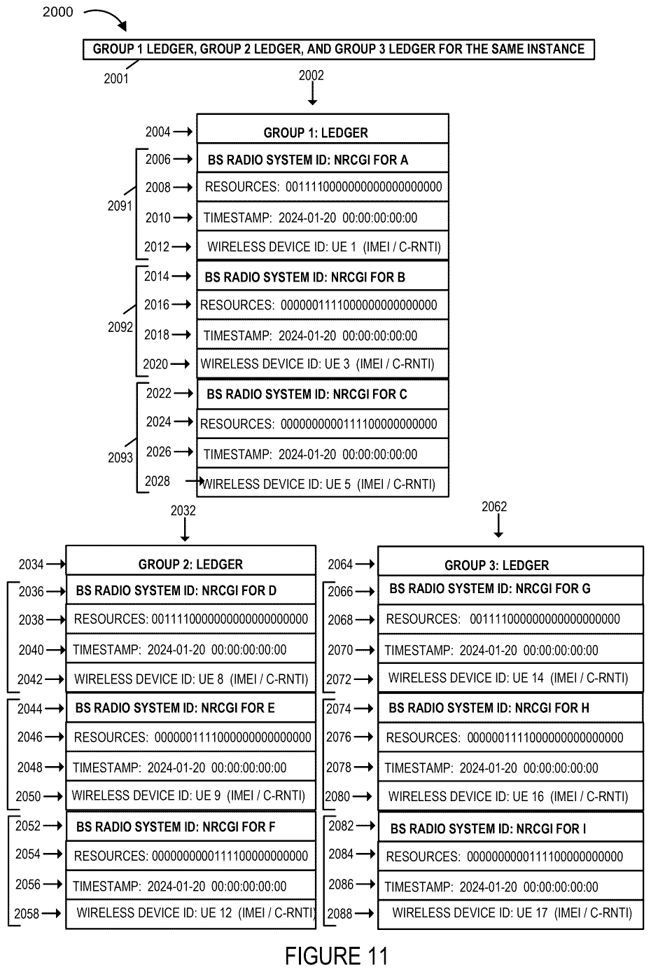

Diagram 2000 of FIG. 11 illustrates exemplary group 1 radio resource allocation ledger 2002 for group 1 radio base station systems 110, exemplary group 2 radio resource allocation ledger 2032 for group 2 radio base station systems 210 and exemplary group 3 radio resource allocation ledger 2062 for group 3 radio base station systems 310 for the same instance of time (e.g., a first instance). FIG. 11 title 2001 states that Group 1 Ledger, Group 2 Ledger, and Group 3 Ledger are for the same instance.

The radio resource allocation group 1 ledger 2002 is illustrated as a single column table including rows 2004, 2006, 2008, 2010, 2012, 2014, 2016, 2018, 2020, 2022, 2024, 2026, and 2028. The information in row 2004 indicates that the table is a ledger for radio resource allocation of the group 1 110 base station radio systems. The ledger is made up of three blocks 2091, 2092, and 2093 of information identifying three different radio resource allocations that have been made by the distributed base station system 101. Each of the three blocks of information include the following four pieces of information which are included on separate rows of the table in the following order: (i) base station radio system identity, (ii) identification of the radio resources which have been granted which in this case has been illustrated using a PRB index, (iii) a timestamp the value of which indicates the start of when the radio resources (e.g., identified PRBs of the PRB index) can be used, and (iv) identity of the wireless device to which the resources have been allocated to be used for communicating with the identified base station radio system identified in the block.

The first block 2091 includes rows 2006, 2008, 2010 and 2012. The second block 2092 includes rows 2014, 2016, 2018, and 2020. The third block 2093 includes rows 2022, 2024, 2026 and 2028.

The first block 2091 row 2006 includes the NRCGI for the base station radio system A 112; row 2008 identifies the PRB resources which have been allocated using a PRB index having the value 0011110000000000000000000 which indicates that PRB 2, PRB 3, PRB 4, PRB 5 from PRB 0 to PRB 24 have been allocated or reserved for use; row 2010 includes the timestamp having the value 2024-01-20 00:00:00:00:00 which indicates the start time from when the radio resources identified can be used; and row 2012 includes the wireless device identity for UE 1 (e.g., IMEI or C-RNTI for UE 1).

The second block 2092 includes rows 2014, 2016, 2018, and 2020. The second block 2092 row 2014 includes the NRCGI for the base station radio system B 114; row 2016 identifies the PRB resources which have been allocated using a PRB index having the value 0000001111000000000000000 which indicates that PRB 6, PRB 7, PRB 8, PRB 9 from PRB 0 to PRB 24 have been allocated or reserved for use; row 2018 includes the timestamp having the value 2024-01-20 00:00:00:00:00 which indicates the start time from when the radio resources identified can be used; and row 2020 includes the wireless device identity for UE 3 (e.g., IMEI or C-RNTI for UE 3).

The third block 2093 includes rows 2022, 2024, 2026 and 2028. The third block 2093 row 2022 includes the NRCGI for the base station radio system C 116; row 2024 identifies the PRB resources which have been allocated using a PRB index having the value 0000000000111100000000000 which indicates that PRB 10, PRB 11, PRB 12, PRB 13 from PRB 0 to PRB 24 have been allocated or reserved for use; row 2026 includes the timestamp having the value 2024-01-20 00:00:00:00:00 which indicates the start time from when the radio resources identified can be used; and row 2028 includes the wireless device identity for UE 5 (e.g., IMEI or C-RNTI for UE 5).

The radio resource allocation group 2 ledger 2032 is illustrated as a single column table including rows 2034, 2036, 2038, 2040, 2042, 2044, 2046, 2048, 2050, 2052, 2054, 2056, and 2058. The information in row 2034 indicates that the table is a ledger for radio resource allocation of the group 2 210 base station radio systems. The ledger 2032 is made up of three blocks of information identifying three different radio resource allocations that have been made by the distributed base station system 201. The first block of ledger 2032 is made up of rows 2036, 2038, 2040, and 2042 and describes the allocation of radio resources in the form of PRBs for use by wireless device UE 8 for communicating with base station radio system D 212. The second block of ledger 2032 is made up of rows 2044, 2046, 2048, and 2050 and describes the allocation of radio resources in the form of PRBs for use by wireless device UE 9 for communicating with base station radio system E 214. The third block of ledger 2032 is made up of rows 2052, 2054, 2056, and 2058 and describes the allocation of radio resources in the form of PRBs for use by wireless device UE 12 for communicating with base station radio system F 216. The blocks of the table of ledger 2032 are read in the same manner as described above in connection with the group 1 ledger 2002.

The radio resource allocation group 3 ledger 2062 is illustrated as a single column table including rows 2064, 2066, 2068, 2070, 2072, 2074, 2076, 2078, 2080, 2082, 2084, 2086, and 2088. The information in row 2064 indicates that the table is a ledger for radio resource allocation of the group 3 310 base station radio systems. The ledger 2062 is made up of three blocks of information identifying three different radio resource allocations that have been made by the distributed base station system 301. The first block of ledger 2062 is made up of rows 2066, 2068, 2070, and 2072 and describes the allocation of radio resources in the form of PRBs for use by wireless device UE 14 for communicating with base station radio system G 312. The second block of ledger 2062 is made up of rows 2074, 2076, 2078, and 2080 and describes the allocation of radio resources in the form of PRBs for use by wireless device UE 16 for communicating with base station radio system H 314. The third block of ledger 2062 is made up of rows 2082, 2084, 2086, and 2088 and describes the allocation of radio resources in the form of PRBs for use by wireless device UE 17 for communicating with base station radio system I 316. The blocks of the table of ledger 2062 are read in the same manner as described above in connection with the group 1 ledger 2002.

A review of the ledgers 2002, 2032, and 2062 illustrates that the same PRBs are being allocated for use by different UEs in different base station radio systems of the same group and in different base station radio systems of the different groups this is because the UEs are not in an overlapping coverage areas that would cause problems and so the PRB can be reused.

In various embodiments, the blocks 2091, 2092 and 2093 of the ledger 2002 are blocks of a blockchain, the blocks being chained together as the resources are allocated via the issuance of tokens by smart contracts. Similarly, the first second and third blocks of the Group 2 ledger 2032 in various embodiments form a blockchain as well as the first second and third blocks of the Group 3 ledger 2062 form a blockchain. The blocks of the blockchain may be, and in some embodiments are encrypted.

The ledger 2002 is generated by the central computing system 102 (e.g., smart contract function 106 and/or scheduler function 104) of the distributed base station system 101 and shared with the central computing system 202 (e.g., with the scheduler 204 and/or smart contract function 206) of the distributed base station system 201 and the central computing system 302 (e.g., with the scheduler 304 and/or smart contract function 306) of the distributed base station system 301.

The ledger 2032 is generated by the central computing system 202 (e.g., smart contract function 206 and/or scheduler function 204) of the distributed base station system 201 and shared with the central computing system 102 (e.g., with the scheduler 104 and/or smart contract function 106) of the distributed base station system 101 and the central computing system 302 (e.g., with the scheduler 304 and/or smart contract function 306) of the distributed base station system 301.

The ledger 2062 is generated by the central computing system 302 (e.g., smart contract function 306 and/or scheduler function 304) of the distributed base station system 301 and shared with the central computing system 102 (e.g., with the scheduler 104 and/or smart contract function 106) of the distributed base station system 101 and the central computing system 202 (e.g., with the scheduler 204 and/or smart contract function 206) of the distributed base station system 201.

In one embodiment such as shown in FIG. 2, the smart contract function 106a generates the radio resource tracking blocks to track the radio resource allocations made for the base station radio system A 112; the smart contract function 106b generates the radio resource tracking blocks to track the radio resource allocations made for the base station radio system B 114; and the smart contract function 106c generates the radio resource tracking blocks to track the radio resource allocations made for the base station radio system C 116. In that system embodiment, the block 2091 of the ledger 2002 is first generated by the smart contract function 106a which distributes it to the other elements of the system including the smart contract functions 106b and 106c. Next, the block 2092 of ledger 2002 is generated by the smart contract function 106b. The smart contract function 106b chains block 2092 to block 2091 and distributed the updated blockchain containing the blocks 2091 and 2092 to the other elements of the system including the smart contract functions 106a and 106c. Next, the block 2093 of ledger 2002 is generated by the smart contract function 106c. The smart contract function 106c updates the blockchain by chaining block 2093 to blocks 2091 and 2092. The updated blockchain is then distributed by the smart contract function 106c to the other elements of the system including smart contract function 106a and smart contract function 106b. The process keeps repeating as new radio resources are being allocated for the different radio base station systems A, B, C with the blockchain of radio resource allocations being added to for each new radio resource allocation.

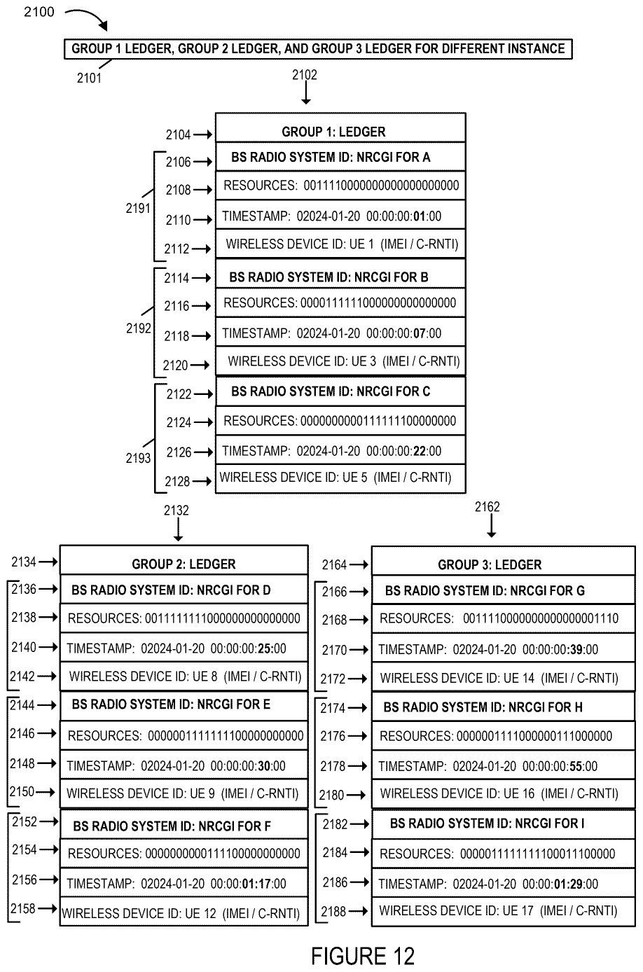

Diagram 2100 of FIG. 12 illustrates exemplary group 1 radio resource allocation ledger 2102 for group 1 radio base station systems 110, exemplary group 2 radio resource allocation ledger 2132 for group 2 radio base station systems 210 and exemplary group 3 radio resource allocation ledger 2162 for group 3 radio base station systems 310 for different instance showing that resource allocations can start at different timestamps. In this example, the PRB index corresponds to the 25 PRBs of a subframe starting at the designated time stamp as discussed in connection with FIG. 4.

The radio resource allocation group 1 ledger 2102 is illustrated as a single column table including rows 2104, 2106, 2108, 2110, 2112, 2114, 2116, 2118, 2120, 2122, 2124, 2126, and 2128. The information in row 2104 indicates that the table is a ledger for radio resource allocation of the group 1 110 base station radio systems. The ledger is made up of three blocks 2191, 2192, and 2193 of information identifying three different radio resource allocations that have been made by the distributed base station system 101. Each of the three blocks of information include the following four pieces of information which are included on separate rows of the table in the following order: (i) base station radio system identity, (ii) identification of the radio resources which have been granted which in this case has been illustrated using a PRB index, (iii) a timestamp the value of which indicates the start of when the radio resources (e.g., identified PRBs of the PRB index) can be used, and (iv) identity of the wireless device to which the resources have been allocated to be used for communicating with the identified base station radio system identified in the block.

The first block 2191 includes rows 2106, 2108, 2110 and 2112. The second block 2192 includes rows 2114, 2116, 2118, and 2120. The third block 2193 includes rows 2122, 2124, 2126 and 2128.

The first block 2191 row 2106 includes the NRCGI for the base station radio system A 112; row 2108 identifies the PRB resources which have been allocated using a PRB index having the value 0011110000000000000000000 have been allocated or reserved for use (“0” indicates not allocated, “1” indicates allocated); row 2110 includes the timestamp having the value 02024-01-20 00:00:00:01:00 which indicates the start time from when the radio resources identified can be used; and row 2112 includes the wireless device identity for UE 1 (e.g., IMEI or C-RNTI for UE 1).

The second block 2192 includes rows 2114, 2116, 2118, and 2120. The second block 2192 row 2114 includes the NRCGI for the base station radio system B 114; row 2116 identifies the PRB resources which have been allocated using a PRB index having the value 0000111111000000000000000 which have been allocated or reserved for use (“0” indicates not allocated, “1” indicates allocated); row 2118 includes the timestamp having the value 02024-01-20 00:00:00:07:00 which indicates the start time from when the radio resources identified can be used; and row 2120 includes the wireless device identity for UE 3 (e.g., IMEI or C-RNTI for UE 3).

The third block 2193 includes rows 2122, 2124, 2126 and 2128. The third block 2193 row 2122 includes the NRCGI for the base station radio system C 116; row 2124 identifies the PRB resources which have been allocated using a PRB index having the value 0000000000111111100000000 which have been allocated or reserved for use (“0” indicates not allocated, “1” indicates allocated); row 2126 includes the timestamp having the value 02024-01-20 00:00:00:22:00 which indicates the start time from when the radio resources identified can be used; and row 2128 includes the wireless device identity for UE 5 (e.g., IMEI or C-RNTI for UE 5).

In this example, the different start times reflect that the resource allocations for blocks 2191, 2192 and 2193 occurred at different times as requests from UE 1, UE 2 and UE 3 arrived at the distributed base station system 101 at different times. The example also shows that PRBs of a subframe made up of 25 PRBs being released from allocation to UE 1 140 in block 2191 and some of those PRBs being re-allocated to UE 2 142 in block 2192 to be used starting at timestamp 02024-01-20 00:00:00:07:00.

The radio resource allocation group 2 ledger 2132 is illustrated as a single column table including rows 2134, 2136, 2138, 2140, 2142, 2144, 2146, 2148, 2150, 2152, 2154, 2156, and 2158. The information in row 2134 indicates that the table is a ledger for radio resource allocation of the group 2 210 base station radio systems. The ledger 2132 is made up of three blocks of information identifying three different radio resource allocations that have been made by the distributed base station system 201. The first block of ledger 2132 is made up of rows 2136, 2138, 2140, and 2142 and describes the allocation of radio resources in the form of PRBs for use by wireless device UE 8 for communicating with base station radio system D 212. The second block of ledger 2132 is made up of rows 2144, 2146, 2148, and 2150 and describes the allocation of radio resources in the form of PRBs for use by wireless device UE 9 for communicating with base station radio system E 214. The third block of ledger 2132 is made up of rows 2152, 2154, 2156, and 2158 and describes the allocation of radio resources in the form of PRBs for use by wireless device UE 12 for communicating with base station radio system F 216. The blocks of the table of ledger 2132 are read in the same manner as described above in connection with the group 1 ledger 2102.

The radio resource allocation group 3 ledger 2162 is illustrated as a single column table including rows 2164, 2166, 2168, 2170, 2172, 2174, 2176, 2178, 2180, 2182, 2184, 2186, and 2188. The information in row 2164 indicates that the table is a ledger for radio resource allocation of the group 3 310 base station radio systems. The ledger 2162 is made up of three blocks of information identifying three different radio resource allocations that have been made by the distributed base station system 301. The first block of ledger 2162 is made up of rows 2166, 2168, 2170, and 2172 and describes the allocation of radio resources in the form of PRBs for use by wireless device UE 14 for communicating with base station radio system G 312. The second block of ledger 2162 is made up of rows 2174, 2176, 2178, and 2180 and describes the allocation of radio resources in the form of PRBs for use by wireless device UE 16 for communicating with base station radio system H 314. The third block of ledger 2162 is made up of rows 2182, 2184, 2186, and 2188 and describes the allocation of radio resources in the form of PRBs for use by wireless device UE 17 for communicating with base station radio system I 316. The blocks of the table of ledger 2162 are read in the same manner as described above in connection with the group 1 ledger 2102.

In various embodiments, the blocks 2191, 2192 and 2193 of the ledger 2102 are blocks of a blockchain, the blocks being chained together as the resources are allocated via the issuance of tokens by smart contracts. Similarly, the first second and third blocks of the Group 2 ledger 2132 in various embodiments form a blockchain as well as the first second and third blocks of the Group 3 ledger 2162 form a blockchain. The blocks of the blockchain may be, and in some embodiments are encrypted.

The ledger 2102 is generated by the central computing system 102 (e.g., smart contract function 106 and/or scheduler function 104) of the distributed base station system 101 and shared with the central computing system 202 (e.g., with the scheduler 204 and/or smart contract function 206) of the distributed base station system 201 and the central computing system 302 (e.g., with the scheduler 304 and/or smart contract function 306) of the distributed base station system 301.

The ledger 2132 is generated by the central computing system 202 (e.g., smart contract function 206 and/or scheduler function 204) of the distributed base station system 201 and shared with the central computing system 102 (e.g., with the scheduler 104 and/or smart contract function 106) of the distributed base station system 101 and the central computing system 302 (e.g., with the scheduler 304 and/or smart contract function 306) of the distributed base station system 301.

The ledger 2162 is generated by the central computing system 302 (e.g., smart contract function 306 and/or scheduler function 304) of the distributed base station system 301 and shared with the central computing system 102 (e.g., with the scheduler 104 and/or smart contract function 106) of the distributed base station system 101 and the central computing system 202 (e.g., with the scheduler 204 and/or smart contract function 206) of the distributed base station system 201.

In one embodiment such as shown in FIG. 2, the smart contract function 106a generates the radio resource tracking blocks to track the radio resource allocations made for the base station radio system A 112; the smart contract function 106b generates the radio resource tracking blocks to track the radio resource allocations made for the base station radio system B 114; and the smart contract function 106c generates the radio resource tracking blocks to track the radio resource allocations made for the base station radio system C 116. In that system embodiment, the block 2191 of the ledger 2102 is first generated by the smart contract function 106a which distributes it to the other elements of the system including the smart contract functions 106b and 106c. Next, the block 2192 of ledger 2102 is generated by the smart contract function 106b. The smart contract function 106b chains block 2192 to block 2191 and distributed the updated blockchain containing the blocks 2191 and 2192 to the other elements of the system including the smart contract functions 106a and 106c. Next, the block 2193 of ledger 2102 is generated by the smart contract function 106c. The smart contract function 106c updates the blockchain by chaining block 2193 to blocks 2191 and 2192. The updated blockchain is then distributed by the smart contract function 106c to the other elements of the system including smart contract function 106a and smart contract function 106b. The process keeps repeating as new radio resources are being allocated for the different radio base station systems A, B, C with the blockchain of radio resource allocations being added to for each new radio resource allocation.

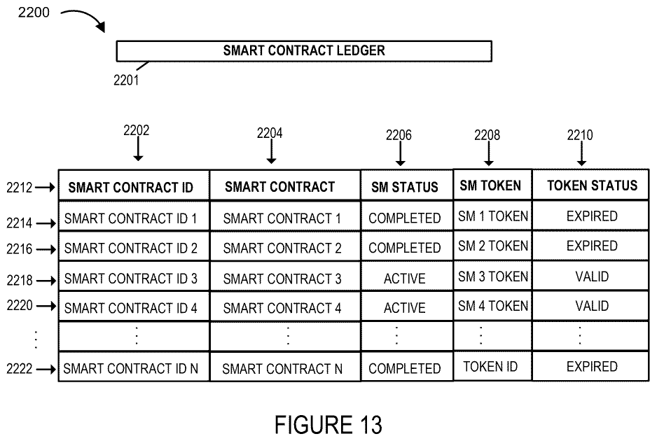

FIG. 13 illustrates an exemplary smart contract ledger 2200 in accordance with an embodiment of the present invention as indicated by the Figure's title 2201. The smart contract legend 2200 includes columns 2202, 2204, 2206, 2208, and 2210 and rows 2212, 2214, 2216, 2218, 2220,. 2222. The entries in row 2212 are labels indicating the information contained in each column. Entries in column 2202 are a smart contract identifier (row 2212, column 2202 entry) which identify the smart contract to which the information in the row pertains. The entries in column 2204 are the smart contracts for the actual smart contracts or terms of the smart contract identified in the same row (row 2212, column 2204 entry). The entries in column 2204 are smart contract status information for the smart contract identified in the same row (row 2212, column 2206 entry). In this example, the smart contract status may be either active or completed. In some embodiments, the smart contract status can be open, active, or completed wherein open indicates that a smart contract offer is outstanding but the smart contract has not been accepted. Typically, however, the smart contract is not added to the smart contract ledger until it has been accepted at which time it becomes active. In such systems, smart contract offers are tracked separately. The entries in column 2208 include a copy of the token issued for the smart contract identified in the same row (row 2012, column 2208 entry). The entries in column 2210 include the status of the token issued for the smart contract identified in the same row (row 2012, column 2210 entry). The token status is either valid or expired. When the token corresponding to the smart contract is valid the radio resources identified in the token are allocated/reserved/granted to a wireless device indicated in the smart contract and token for the identified wireless device's use. When the token is expired the radio resources identified in the token are no longer reserved/allocated/granted to the wireless device identified in the token and the identified wireless device is no longer authorized to use the radio resources identified in the token.

Each of the rows 2214, 2216, 2218, 2220, . . . , 2222 provide information for a particular smart contract. Row 2214 provides information for smart contract ID 1 (row 2214, column 2202 entry). Row 2216 provides information for smart contract ID 2 (row 2216, column 2202 entry). Row 2218 provides information for smart contract ID 3 (row 2218, column 2202 entry). Row 2220 provides information for smart contract ID 4 (row 2220, column 2202 entry). Row 2222 provides information for smart contract ID N, N being an integer greater than 4 (row 2222, column 2202 entry). The row 2214 includes the following: smart contract ID 1 (row 2014, column 2202 entry), the smart contract 1 (row 2214, column 2204 entry), the smart contract ID 1 has a status of completed (row 2214, column 2206), the token for the smart contract with the ID 1 is included in row 2214, column 2208 entry, the status of the smart contract ID 1 token is expired (row 2214, column 2210 entry). The entries in the table are fields and/or data structures in which the information identified can be stored (e.g., smart contract, tokens, etc.) In some embodiments, the data structure used for the smart contract ledger is a linked list or records with each row of the table being a record, the record including the different field identified in each column.

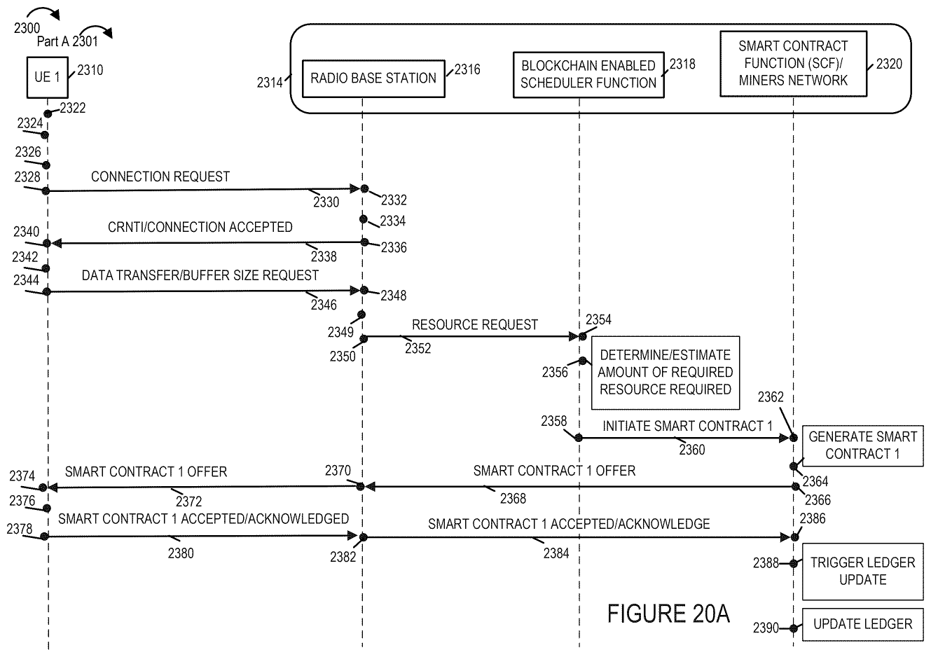

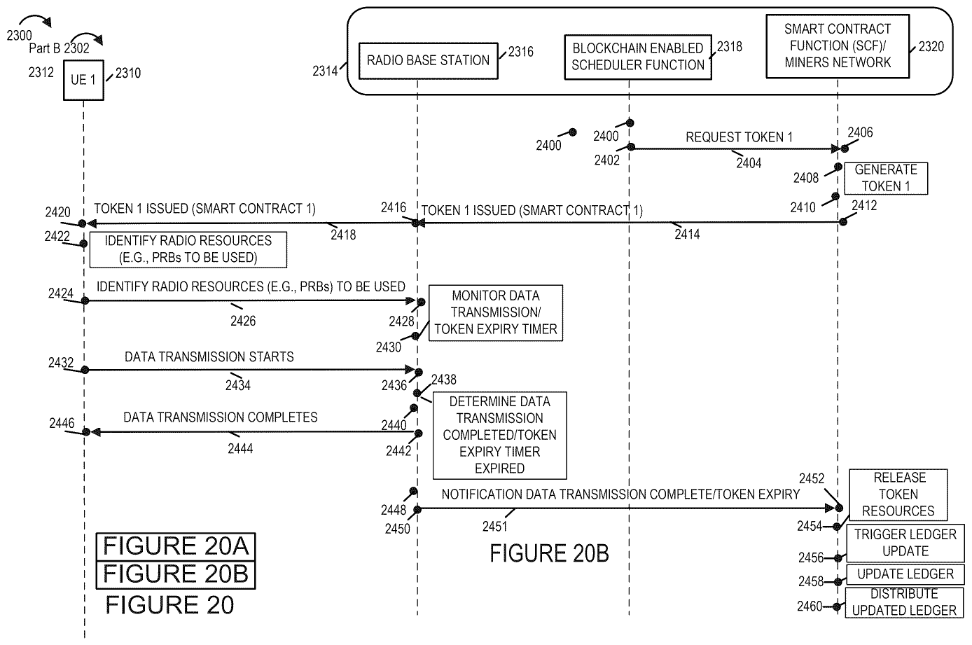

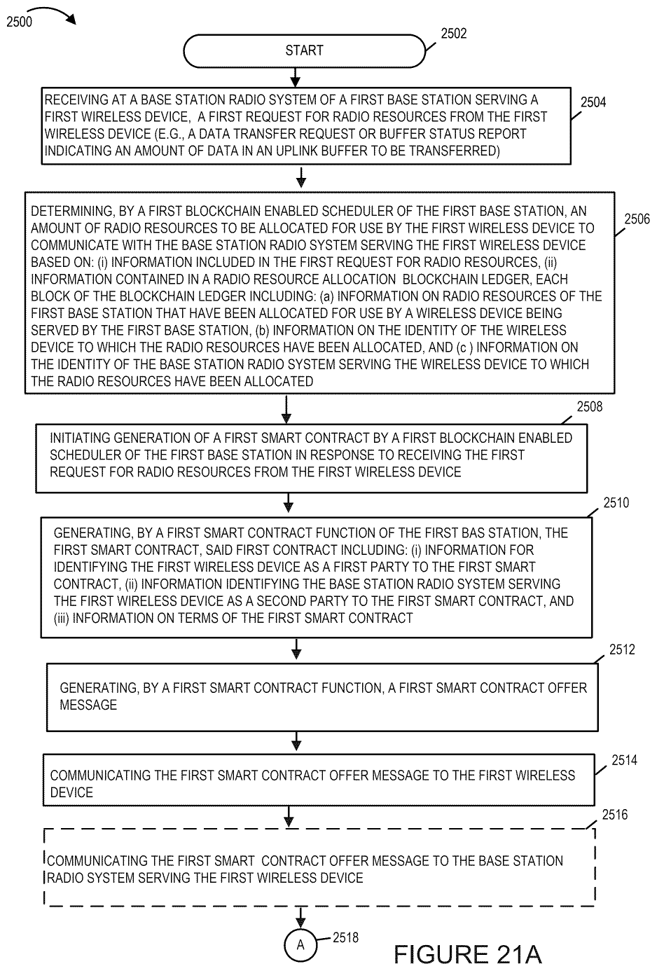

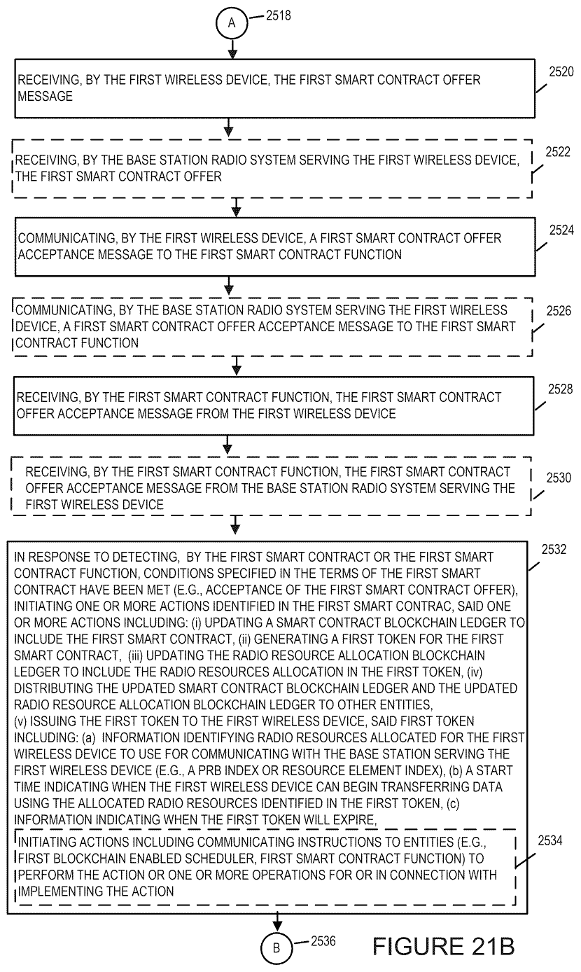

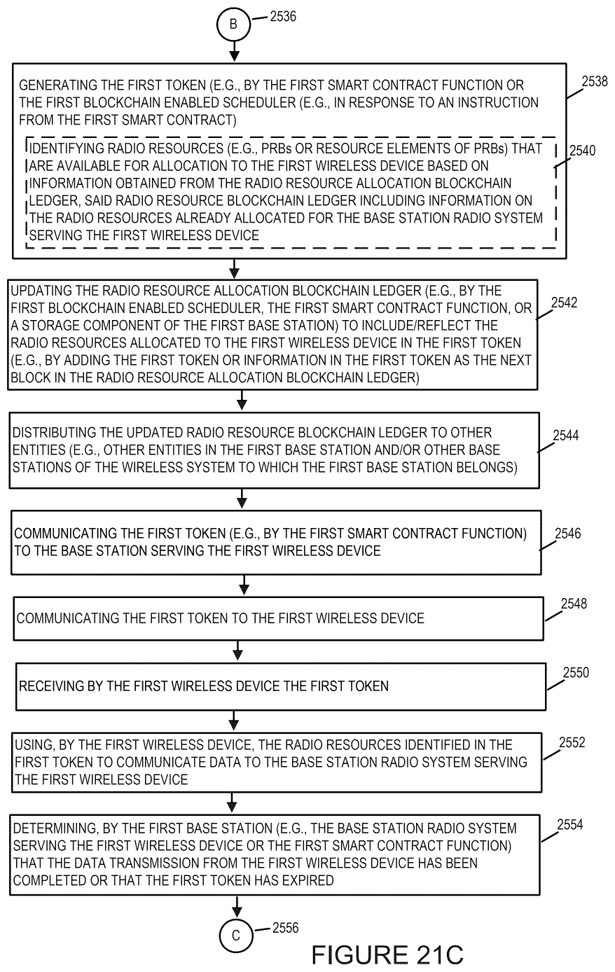

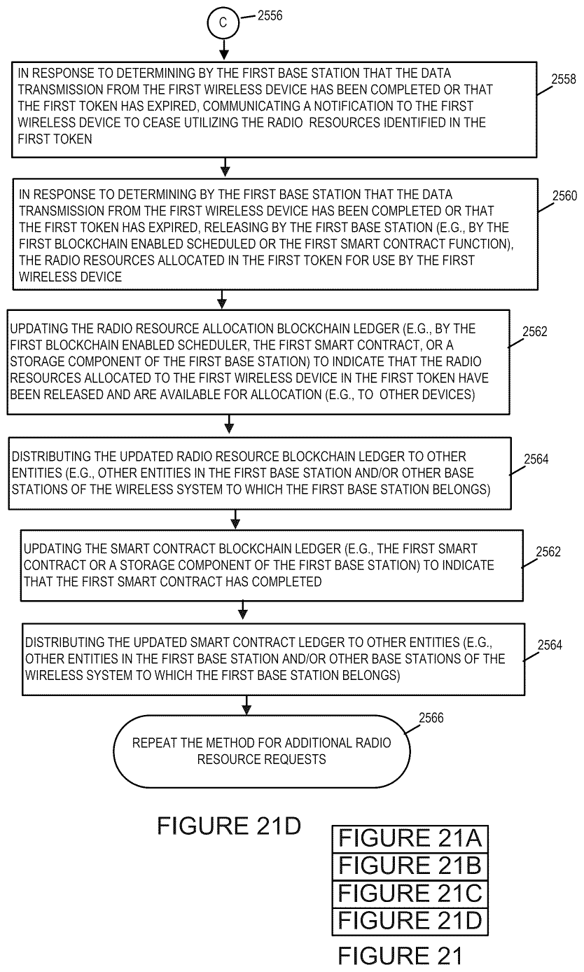

In some embodiments, the smart contracts are maintained as blocks of a blockchain indexed by their unique smart contract ID with the additional fields of the ledger being linked or indexed to the smart contract ID. An operation support system of the system 300 can be used to access the smart contract ledger and/or resource allocation ledgers being maintained (e.g., group 1, group 2, group 3 ledgers of FIGS. 20 and 21 to obtain metrics to measure radio resource utilization and efficiency and adjust coverage areas, base station radio system configuration such as handover parameters, etc.

FIG. 20 comprises FIG. 20A and FIG. 20B. FIG. 20A is the first part (Part A 2301) of a signaling diagram which illustrates the steps and signaling of an exemplary method 2300 in accordance with an embodiment of the present invention. FIG. 20B is the second part (Part B 2302) of a signaling diagram which illustrates the steps and signaling of an exemplary method 2300 in accordance with an embodiment of the present invention.

While it will be readily understood that additional steps and signaling are performed in connection with communicating information, messages, and packets between devices, the method 2300 focuses on and discusses the steps and signaling for understanding the invention. Elements or steps with the same reference numbers used in different figures are the same or similar and those elements or steps will not be described in detail again.

The signaling diagram/method 2300 may be, and in some embodiments is, implemented using exemplary systems 100 or 300. In some such exemplary embodiments, UE 1 2310 of FIG. 20 is UE 1 140 of system 100 or 300; base station 2314 is the distributed base station 101 of system 100 or 300; radio base station 2316 is base station radio system A 114 of system 100 or 300; blockchain enabled scheduler function 2318 is blockchain enabled scheduler function 104 of the central computing system 102 of the distributed base station system 101; smart contract function (SCF)/miners network 2320 is smart contract function/miners network 106 of he central computing system 102 of the distributed base station system 101. In some embodiments, the radio base station 2316 includes both the physical layer function and the RLC functionality. While only a single UE and a base station with a single radio base station is illustrated, the method 2300 is applicable to systems such as system 300 with multiple UEs and multiple base stations have multiple base station radio systems.

It should be understood that the method 2300 is not limited to the exemplary systems 100 or 300 and may be, and is used, on other systems and system configurations. The signaling diagram/method 2300 illustrates the exemplary signaling and steps for efficiently and effectively managing the usage of spectrum resources or radio resources of a wireless system such as for example PRBs or resource elements of a spectrum channel using blockchain and distributed ledger technology. The method does not use a spectrum channel signaling schedule that is broadcast to all UEs but instead uses a token system in which each wireless devices (e.g., UE 1 and UE 2) are provided individual token which identify which spectrum or radio resources the wireless device is authorized to use and for how long either by identification of the specific PRBs over the time period of by identifying PRBs of a sub-frame that will be used during a time period. The smart contracts of the method 2300 may be, and in some embodiments, are kept as a smart contract blockchain and kept in a ledger. Smart contract ledger 2200 shown in FIG. 13 is an exemplary smart contract ledger that may be implemented in accordance with an embodiment of the present invention. Radio Resource Allocation Group 1 ledger 2002 shown in FIG. 11 and Radio Resource Allocation Group 1 ledger 2102 shown in FIG. 12 are exemplary blockchain ledgers that show radio resource allocations being used for radio resource allocation and tracking which may be, and in some embodiments are, used in connection with the method 2300.

The method 2300 starts in start step 2322 shown on FIG. 20A. Operation proceeds from start step 2322 to step 2324. In step 2324, UE 1 2310 determines that it has uplink data to be transmitted. Operation proceeds from step 2324 to step 2326. In step 2326, the UE 1 2310 generates connection request message 2330. Operation proceeds from step 2326 to step 2328. In step 2328, the UE 1 2310 transmits the connection request message 2330 to the radio base station 2316 of base station 2314. Operation proceeds from step 2328 to step 2332. In step 2332, the radio base station 2316 of base station 2314 receives the connection request message 2330. Operation proceeds from step 2332 to step 2334. In step 2334, the radio base station 2316 assigns a C-RNTI to the UE 1 2310 and generates connection accepted message 2338 including the C-RNTI assigned. Operation proceed from step 2334 to step 2336. In step 2336, the radio base station 2316 transmits the connection accepted message 2338 to the UE 1 2310. Operation proceeds from step 2336 to step 2340. In step 2340, UE 12310 receives the connection accepted message with the C-RNTI. Operation proceeds from step 2340 to step 2342.

In step 2342, the UE 1 2310 generates data transfer/buffer size request 2346. The data transfer/buffer size request 2346 indicates an amount of data in its uplink buffer which is to be transferred. In some embodiments, the data transfer/buffer size request message 2346 is a buffer status report message sent in response to a buffer status request message sent from the radio base station 2316. Operation proceeds from step 2342 to step 2344. In step 2344, the data transfer/buffer size request message 2346 is transmitted from the UE 1 2310 to radio base station 2316 of the base station 2314. Operation proceeds from step 2344 to step 2348. In step 2348, the radio base station 2316 receives the data transfer/buffer size request message 2346. Operation proceeds from step 2348 to step 2349. In step 2349, the radio base station 2316 processes the data transfer/buffer size request message 2346 and generates resource request message 2352. The resource request message 2352 is a spectrum resource or radio resource request message including information on the amount or size of the data to be transferred, the identity of the UE (e.g., UE 1 IMEI/C-RNTI), identity of the radio base station 2316 (e.g., NRCGI for the radio base station 2316), the amount of data to be transfer and that it is uplink data. Operation proceeds from step 2349 to step 2350. In step 2350, the resource request message 2352 is communicated to the blockchain enabled scheduler function 2318 of the base station 2314. Operation proceeds from step 2350 to step 2354. In step 2354, the blockchain enabled scheduler function 2318 receives the resource request 2352 from the radio base station 2316. Operation proceeds from step 2354 to step 2356.

In step 2356, the blockchain enabled scheduler function 2318 using the information in the resource request determines and/or estimates the amount of required radio resources required for the data transmission (e.g., number of PRBs or resource elements of PRBs). Operation proceeds from step 2356 to step 2358.

In step 2358, generates initiate smart contract 1 request message 2360 and communicates it to the smart contract function/miners network 2320. In some embodiments the generation and communication of the request are performed as separate operations or steps. The smart contract 1 request message 2360 includes the identity of the radio base station 2316, the identity of the wireless device UE 1 2310, and the amount and direction (e.g., uplink) radio resources required (e.g., number of PRBs or resource elements of PRBs required for the data transfer). Operation proceeds from step 2358 to step 2362.

In step 2362, the smart contract function/miners network 2320 receives the initiate smart contract 1 message 2360. Operation proceeds from step 2362 to step 2364. In step 2364, the smart contract function/miners network generates smart contract 1. Operation proceeds from step 2364 to step 2366.

In step 2366, the smart contract function/miners network 2320 generates and communicates the smart contract 1 offer message 2368 to the radio base station 2316 for transmission to the UE 1 2310. The smart contract 1 offer message includes an identifier for the smart contract 1, the identity of the parties to the smart contract 1 (IMEI/C-RNTI, for UE 1 2310 NRCGI for radio base station 2316 and terms of the contract (e.g., type of radio resources—PRBs, amount of radio resources—number of PRBs, conditions to be met for execution of smart contract (e.g., acceptance of contract by UE)). In some embodiments, the smart contract 1 itself is included in the smart contract 1 offer message 2368. In some embodiments, an index of PRBs of the PRBs to be reserved for use by the UE 1 2310 to communicate with the radio base station 2316 are included in the smart contract 1 if they have already been determined by the smart contract function/miners network 2320. Operation proceeds from step 2366 to step 2370.

In step 2370, the radio base station 2316 receives smart contract 1 offer message 2368, generates smart contract 1 offer message 2372 based on the smart contract 1 offer message 2368 and transmits it over the air to the UE 1 2310. In some embodiments, the contents of the smart contract 1 offer message 2368 and 2372 are the same but the format is different as the messages are being communicated over different types of media. In some embodiments, the radio base station 2316 forwards the message 2368 as message 2372. Operation proceeds from step 2370 to step 2374. In step 2374, the UE 1 2310 receives the smart contract 1 offer message 2372. Operation proceeds from step 2374 to step 2376.

In step 2376, UE 1 2310 processes the smart contract 1 offer message 2372 and determines whether to accept or reject the smart contract 1 offer included in smart contract 1 offer message. In this example, UE 1 accepts the smart contract 1 offer and generates smart contract 1 accepted/acknowledged message 2380. The UE 1 2310 may make the decision to accept or reject the offer message based on the conditions at the UE 1 2310. The UE 1 2310 may reject the offer for example its uplink buffer no longer has data to be transferred for example because the application executing on the UE 1 2310 which was attempting to transfer the data has been terminated and the uplink buffer emptied. In most instances, UE 1 2310 will accept the smart contract 1 offer. In some embodiments, the smart contract 1 offer need not be accepted but merely acknowledged as the UE 1 2310 just needs to acknowledge that it has received the smart contract 1 offer and acknowledge of receipt indicates acceptance. The smart contract 1 acceptance message 2380 includes an identification of the smart contract 1 being accepted and the parties to the smart contract 1 included in the offer message. Operation proceeds from step 2376 to step 2378.

In step 2378, UE 1 2310 transmits the smart contract 1 acceptance message 2380 to the radio base station 2316. Operation proceeds from step 2378 to step 2382. In step 2382, the radio base station 2316 receives the smart contract 1 acceptance message 2380, generates smart contract 1 acceptance message 2384 based on the received smart contract 1 acceptance message 2380 and communicates the smart contract 1 acceptance message 2384 to the smart contract function/miners network 2320. In some embodiments, the contents of the smart contract 1 acceptance message 2380 and 2384 are the same but the format is different as the messages are being communicated over different types of media. In some embodiments, the radio base station 2316 forwards the message 2380 as message 2384. Operation proceeds from step 2382 to step 2386. In step 2386, the smart contract function/miners network 2320 receives the smart contract 1 acceptance message 2384. Operation proceeds from step 2386 to step 2388.

In step 2388, the smart contract function/miners network 2320 processes the smart contract 1 acceptance message 2384. Processing the smart contract 1 acceptance message 2384 includes updating the smart contract 1 to indicate that the conditions and/or terms of the smart contract 1 have been met (e.g., acceptance of the smart contract 1 by UE 1 2310) and upon determining that the conditions of smart contract 1 have been met initiating implementation of the smart contract 1 which includes triggering an update to one or more ledgers (e.g., an update to a smart contract ledger for the radio base station 2316 and/or base station 2314 to include the smart contract 1 as the next block in the smart contract blockchain and/or a radio resource allocation ledger). In some embodiments, the smart contract 1 self initiates execution of the smart contract 1 upon the updating of the smart contract 1 to include the acceptance of the smart contract 1 by UE 1 2310 and a determination that the conditions/terms of smart contract 1 have been met (e.g., UE 1 2310 have accepted the smart contract 1 offer). In some embodiments, triggering a ledger update includes notifying the blockchain scheduler function 2318 of the acceptance of the smart contract 1 by UE 1 2310. Operation proceeds from step 2388 to step 2390.

In step 2390, the smart contract function/miners network 2320 updates one or more ledgers (e.g., a smart contract ledger for the radio base station 2316 and/or base station 2314. Updating a ledger including adding information on smart contract 1 to the ledger and/or adding the smart contract 1 as the next block in a blockchain of the ledger. In some embodiments, the operation of updating one or more ledgers is performed by the blockchain enabled scheduler function 2318 in response to a notification that the smart contract 1 has been accepted by UE 1 2310. Operation proceeds from step 2390 to step 2400 shown on FIG. 20B.

In step 2400, the blockchain enabled scheduler function 2318 generates a request token 1 for the smart contract 1 message 2404 after determining that the smart contract 1 has accepted (e.g., via reviewing an updated entry in a smart contract ledger and/or receiving a notification that the smart contract 1 has been accepted by UE 1 2310. Operation proceeds from step 2400 to step 2402. In step 2402, the blockchain enabled scheduler function 2318 communicates the request token 1 for smart contract 1 message 2404 to the smart contract function/miners network 2320. Operation proceeds from step 2402 to step 2406. In step 2406, the smart contract function/miners network 2320 receives the request for token 1 for smart contract 1 and processes the message 2404. Operation proceeds from step 2406 to step 2408.

In some embodiments, steps 2400 to step 2406 are skipped and the smart contract function/miners network 2320 and/or the smart contract 1 upon executing automatically initiates the smart contract function/miners network 2320 to generate token 1 for the smart contract 1.

In step 2408, the smart contract function/miners network 2320 generates token 1 for smart contract 1. Generating the token 1 for smart contract 1 includes identifying the radio resources (e.g., PRBs or resource elements of PRBs) to be allocated/reserved/granted to the UE 1 2310 for use in communicating with the radio base statin 2316 and determining a start time and a duration for the use of the radio resources and/or a token expiration time. Operation proceeds from step 2408 to step 2410.

In step 2410, the smart contract function/miners network 2320 generates token 1 smart contract 1 issuance message 2414. The token 1 smart contract 1 issuance message 2414 includes the generated token 1 for smart contract 1. Operation proceeds from step 2410 to step 2412. In step 2412, the smart contract function/miners network 2320 issues token 1 for smart contract 1 to UE 1 by communicating the token 1 issuance message 2414 to radio base station 2316. Operation proceeds from step 2412 to step 2416. In step 2416, the radio base station 2316 receives the token 1 issuance message and processes the token 1 issuance message 241. Processing the token 1 issuance message 2414 includes generating token 1 for smart contract 1 issuance message 2418 based on the received token 1 issued message 2414. In some embodiments, the contents of the token 1 issuance message 2418 and 2414 are the same but the format is different as the messages are being communicated over different types of media. In some embodiments, the radio base station 2316 forwards the message 2414 as message 2416. In some embodiments, processing the token 1 issuance message 2414 also includes updating the radio base station 2316 to process the token 1 to determine the radio resources to be utilized for transferring data from the UE 1 2310 to the radio base station 2316 (e.g., the PRBs to be reserved/allocated for this purposed and the start time and token expiry time). Operation proceeds from step 2416 to step 2420.

In step 2420, UE 1 2310 receives the token 1 for smart contract 1issuance message 2418. Operation proceeds from step 2420 to step 2422. In step 2422, the UE 1 2310 processes the token 1 issued for smart contract 1 and identifies the radio resources (e.g., PRBs) to be used from the radio resources (PRBs) allocated/reserved for UE 1 2310 included in the token 1. In some embodiments, the UE 1 2310, identifies all of the radio resources allocated/reserved in the token 1 for the UE 1 2310 to be used by UE 1 2310. If the radio resources are identified in token 1 using a PRB index with “1” indicating the PRB identified is available/reserved/allocated and “0” indicating the PRB identified is not available/reserved/allocated for UE 1 2310 then the UE 1 2310 using a bit mask to change the “1” to “0” for the PRBs which have “1” in the PRB index but which will not be used for by the UE 1 2310. The updated PRB index will then indicate which PRBs the UE 1 2310 will be utilizing and which PRBs which had been available/reserved for use by UE 1 2310 it will not be using. In some embodiments, token 1 for smart contract 1 is encrypted by smart contract function/miners network so that only the UE 1 2310 can access the contents of token 1. In such cases, the identity of the PRBs allocated/reserved identified in token 1 are made know to the radio base station 2316 via message 2426. Operation proceeds from step 2422 to step 2424.

In step 2424, UE 1 generates and communicates message 2426 to radio base station 2316. The message 2426 identifies the radio resources (e.g., PRBs to be used for communicating with radio base station 2316 per token 1 allocation/reservation/grant. Operation proceeds from step 2424 to step 2428. In step 2428, the radio base station receives message 2426 and processes message 2426 which identifies the PRBs to be utilized for communicating with radio base station 2316 for transferring uplink data to the radio base station 2316 and the start time. In some embodiments, step 2422 and 2424 are skipped as the radio base station 2316 has the information included in token 1 regarding the allocated resources (e.g., PRBs) to be used in transferring data and the start time. Operation proceeds from step 2428 to step 2430.

In step 2430, the radio base station initiates monitors the transmission of data from the UE 1 2310 to the radio base station 2316 also activates a token 1 expiry timer which is set to notify the radio base station 2316 upon the token 1 expires. Operation proceeds from step 2430 to step 2432.

In step 2332, UE 1 2310 starts uplink data transmission of data 2434 to the radio base station 2316 using the identified radio resources (e.g., PRBs or resource elements in PRBs). Operation proceeds from step 2432 to step 2436. In step 2436, the radio base station 2316 receives the data 2434 included in the identified radio resources (e.g., PRBs or resource elements of PRBs) from the UE 1 2310. Operation proceeds 2436 to step 2438.

In step 2438, the radio base station 2316 determines whether the data transmission has completed or whether the token 1 expiry timer has expired. If either of these events has occurred then operation proceeds step 2438 to step 2440. The radio base station 2316 can determine if the data transmission is complete because it is receiving the data transmission and needs to determine if it was all received, partially received, and/or whether there errors detected in what was received require retransmission. In this example, in step 2438, the radio base station 2316 determines that the data transmission was successful and has completed before the token 1 timer expiry. In step 2440, the radio base station 2316 generates data transmission successful completion message 2444 which includes information that the data transmission has successfully completed. Operation proceeds from step 2440 to step 2442.

In step 2442, the radio base station 2316 transmits the data transmission successful completion message 2444 to UE 1 2310. Operation proceeds from step 2442 to step 2446 and step 2448.

In step 2446, the UE 1 2310 receives the successful data transmission completion message 2444 and ceases to use the radio resources identified in the token 1.

If in step 2438, the radio base station 2316 determined that the data transmission had not been completed but that the token 1 timer had expired and the token 1 was no longer valid as well as the radio resource allocations/reservations for UE 1 2310 no longer being valid, the radio base station 2316 would generate a message indicating that the data transmission had not completed but token 1 timer had expired and would transmit that message to the UE 1 2310 in place of the data transmission completion message 2444.

In step 2448, the radio base station 2316 generates the notification message 2451. The message 2451 will include information indicating that the data transmission for token 1 has completed successfully when the radio base station 2316 has determined in step 2438 that the data transmission 2434 has been successfully completed. The message 2451 will include information indicating that the data transmission for token 1 has not completed by the token 1 expiry timer has timed out if the token 1 expiry timer expires before the data transmission of data 2434 has successfully completed. This can occur when the radio conditions are worse than estimated (e.g., lost data due to transmission errors) and the determined amount of radio resources required were insufficient to transfer the amount of data in the radio resource request. Operation proceeds from step 2448 to step 2450. In step 2450, the notification message 2451 is communicated from radio base station 2316 to smart contract function/miner network 2320. Operation proceeds from step 2450 to step 2452. In step 2452, the smart contract function/miners network 2320 receives the message 2451. In some embodiments, the message 2451 includes information on the amount of data that was successfully transmitted and/or the amount of data was remaining to be transferred when the token 1 timer expired. Operation proceeds from step 2452 to step 2454.

In step 2454, the smart contract function/miners network 2320 which has been monitoring for the completion of the data transfer for smart contract 1 or the expiration of token 1 determines that the radio resources identified in token 1 for UE 1 2310's use can be released for use by other wireless devices (e.g., UE 2 2312) and initiates release of the radio resources. Operation proceeds from step 2454 to step 2456.

In step 2456, the determination of the expiration of token 1 or the completion of the data transfer for smart contract 1 triggers the smart contract function/miners network to update one or more ledgers or initiate the updating of one or more ledgers (e.g., smart contract ledger and/or the radio resource allocation ledger for radio base station 2316) to indicate that the smart contract 1 has completed, the token 1 has expired, the radio resources allocated/reserved/granted in token 1 have been released for use by other wireless devices. Operation proceeds from step 2456 to step 2458.

In step 2458, the smart contract function/miners network 2320 updates one or more ledgers (e.g., the smart contract ledger and/or the radio resource allocation ledger for radio base station 2316). In some embodiments, updating one or more ledgers includes updating the smart contract ledger and/or the radio resource allocation ledger for radio base station 2316 to indicate that the smart contract 1 has completed, the token 1 has expired, the radio resources allocated/reserved/granted in token 1 have been released for use by other wireless devices. In some embodiments, in step 2456, the blockchain enabled scheduler function 2318 is initiated to update one or more ledgers by the smart contract function/miners network 2320. In such embodiments, blockchain enabled scheduler function 2318 updates the smart contract ledger and/or the radio resource allocation ledger for radio base station 2316 based on information provided by the smart contract function/miners network 2320. Operation proceeds from step 2458 to step 2460. Once the one or more ledgers have been updated, the updated ledgers are distributed to other elements of the base station 2314 (e.g., the blockchain enabled scheduler function 2318) and to other base stations of the wireless system. Once the radio resources have been released, the radio resources are available to be allocated/reserved in other tokens for use by either UE 1 2312 or other UEs which are requesting resources for communicating with radio base station 2316. The steps of the method 2300 being repeated in response to the new data transfer/radio resource request which results in a smart contract 2 and a token 2 for the smart contract 2 and updates to the ledgers. The method 2300 being repeated for each new data transfer/radio resource request from a UE device. The method 2300 is applicable to multiple UEs making concurrent data transfer/radio resource requests (e.g., UE 1 and a UE 2 both making data transfer/radio resource requests in parallel or at the same time). The base station 2314 handles the requests concurrently and utilizes separate smart contracts and tokens (e.g., smart contract 1 and token 1 for smart contract 1, smart contract 2 and token 2) for each data transfer/radio resource request. The smart contract function/miners network 2320 using the smart contract ledgers and/or radio resource allocation ledgers to identify different PRBs to include in the token 1 as being reserved/allocated for use by UE 1 then the PRBs to include in token 2 as being reserved/allocated for use by UE 2. While the signaling diagram/method 2300 is shown from the perspective of data transfer from a UE to the radio base station 2316, the same process can be used for downlink transmission from the radio base station 2316 to the UE. The radio base station 2316 in such a situation makes the resource request in step 2352 indicating that it is for downlink data transfer.

In some embodiments, when token 1 expires and the data transmission has not completed, the smart contract function/miners network 2320 sends a radio resource request to the blockchain enabled scheduler function 2318 with the additional amount of data to be transferred to complete the data transfer from UE 1 2310 instead of requiring the UE 1 2310 to make an addition data transfer request. Operation proceeds back to step 2356 and the steps of the method repeat.

In some other embodiments of the invention a wireless device (e.g., UE 1 140) will make a request for a token to a smart contract function (e.g., smart contract function 106) when it has data that needs to be transferred via a base station (e.g., base station radio system A 112 of base station system 101. The smart contract function/miners network will issue the token to the wireless device. The wireless device will receive the token which will identify radio resources available/reserved for the wireless device for transferring the data to its serving base station radio system/cell. The wireless device will use a PRB index, a public key (e.g., identify of serving base station cell (e.g., NRCGI of the base station radio system or cell from which it is receiving wireless services)), a private key (e.g., identity of the wireless device such as IMEI or C-RNTI identifying the wireless device), and a token (including a network identity) to activate PRBs. The content of the token will also include a PRB index identifying the PRBs which are allocated/reserved/granted for use by the wireless device for the time period the token is valid. Activation of the PRBs can include identifying which PRBs from a set of available PRBs identified in a token the wireless device intends to use for transmitting the data from the wireless device to the serving base station radio system/cell. In some embodiments, the wireless device indicates in a message to the base station that it is going to use a set of PRBs indicated as being available in a token and signs the message with its private key.

The number of PRBs needed for the data transfer is determined by a blockchain enabled scheduler function (e.g., blockchain enabled scheduler function 104) which makes the determination from information on the amount of data being requested to be transferred (e.g., indicated in a buffer status report which identifies the amount of data in an buffer (e.g., an uplink buffer of the wireless device awaiting transfer). The determination of the number of PRBs needed for the transfer is based at least on one or more of the following: coverage area in which the wireless device is located, interference and supported modulation index and efficiency. For example, 100 Megabytes (MB) of data transfer will have 168 (symbols per PRB)*6 bits/symbol (64 QAM)=1008 bits/1 ms=1008000 bits/second=1 Mbps. With a 5 PRBs allocation, it will have 20 seconds to complete the 100 MB at the rate of 5 Mbps. The determined 5 PRBs allocation of each subframe needed for the data transfer will be provided to the smart contract function/miners network which generates and issues the token with identified PRB index identifying at least 5 PRBs in the index per subframe to be made available/reserved/allocated for the wireless device to use for the data transfer.

Once the data transfer is completed, the base station will send a notification to the wireless device indicating that the data transfer has completed and that the token is being released. The base station smart contract function/miners network and/or the blockchain enabled scheduler function will be notified that the token and its radio resources (i.e., the identified PRBs reserved for the wireless device) are to be released and made available for use by other devices. The release of the token resulting in the identified PRBs no longer being available/reserved for the wireless device to use but can now be included in other tokens issued to other wireless devices for their use in transferring data. In some embodiments, the radio base station system makes the determination that the data transmission has complete and requests release of the token while in some other embodiments, the smart contract/miner function makes that determination and releases the token and updates blockchain ledgers (e.g., radio resource allocation ledgers and/or smart contract ledgers to reflect the release of the token and the identified as being reserved for the wireless device in the token). Multiple devices can do simultaneous data transfers while using tokens received from the smart contract function/miners network and/or the scheduler function.

The radio resources integrity can be maintained while using only available radio resources. The radio resource allocations and utilizations can be tracked by blockchain scheduler function and/or the smart contract function/miners network. A blockchain ledger for radio resource allocations in some embodiments is maintained across different groups of base stations by smart contract function/miner networks and/or blockchain enabled scheduler functions. The base stations being connected via backhaul network connectivity.

FIG. 21 comprises FIG. 21A, FIG. 21B, FIG. 21C, and FIG. 21D. FIG. 21A illustrates a first part of a flowchart of an exemplary method 2500 in accordance with an embodiment of the present invention. FIG. 21B illustrates a second part of a flowchart of an exemplary method 2500 in accordance with an embodiment of the present invention. FIG. 21C illustrates a third part of a flowchart of an exemplary method 2500 in accordance with an embodiment of the present invention. FIG. 21D illustrates a fourth part of a flowchart of an exemplary method 2500 in accordance with an embodiment of the present invention.

While it will be readily understood that additional steps and signaling are performed in connection with communicating information, messages, and packets between devices, the method 2500 focuses on and discusses the steps and signaling for understanding the invention. Elements or steps with the same reference numbers used in different figures are the same or similar and those elements or steps will not be described in detail again.

The method 2500 may be, and in some embodiments is, implemented using exemplary systems 100 or 300. It should be understood that the method 2500 is not limited to the exemplary systems 100 or 300 and may be, and is used, on other systems and system configurations. The signaling diagram/method 2300 illustrates the exemplary signaling and steps for efficiently and effectively managing the usage of spectrum resources or radio resources of a wireless system such as for example PRBs or resource elements of a spectrum channel using blockchain and distributed ledger technology. The method does not use a spectrum channel signaling schedule that is broadcast to all UEs but instead uses a token system in which each wireless devices (e.g., UE 1 and UE 2) are provided individual tokens which identify which spectrum or radio resources the wireless device is authorized to use and for how long either by identification of the specific PRBs over the time period of by identifying PRBs of a sub-frame that will be used during a time period. The smart contracts of the method 2500 may be, and in some embodiments, are kept as a smart contract blockchain and kept in a ledger. Smart contract ledger 2200 shown in FIG. 13 is an exemplary smart contract ledger that may be implemented in accordance with an embodiment of the present invention. Radio Resource Allocation Group 1 ledger 2002 shown in FIG. 11 and Radio Resource Allocation Group 1 ledger 2102 shown in FIG. 12 are exemplary blockchain ledgers that show radio resource allocations being used for radio resource allocation and tracking which may be, and in some embodiments are, used in connection with the method 2500.

The method 2500 starts in start step 2502 shown on FIG. 21A. Operation proceeds from start step 2502 to step 2504. In step 2504, the base station radio system (e.g., base station radio system A 112) of a first base station (e.g., distributed base station 101 of system 100 or 300) serving a first wireless device (e.g., UE 1 140) receives a first request for radio resources from the first wireless device (e.g., a data transfer request or buffer status report indicating an amount of data in an uplink buffer to be transferred). Operation proceeds from step 2504 to step 2506.

In step 2506, a first blockchain enabled scheduler of the first base station (e.g., blockchain enabled scheduler function 104) determines an amount of radio resources to be allocated for use by the first wireless device to communicate with the base station radio system serving the first wireless device based on one or more of the following: (i) information included in the first request for radio resources, (ii) information contained in a radio resource allocation blockchain ledger, each block the radio resource allocation blockchain ledger including (a) information on radio resources of the first base station that have been allocated for use by a wireless device being served by the first base station, (b) information on the identity of the wireless device to which the radio resources have been allocated, and (c) information on the identity of the base station radio system serving the wireless device to which the radio resources have been allocated. In some embodiments, determining the amount of radio resources to be allocated for use by the first wireless device to communicate with the base station radio system serving the first wireless device is further based on one or more of the following: (i) coverage area of the base station radio system serving the first wireless device, (ii) number of wireless devices actively being served by the base station radio system serving the first wireless device, (iii) radio conditions at the first wireless device (e.g., channel conditions and/or signal interference conditions (SINR) determined based on reports from the first wireless device and/or determined based on reference signals received from the first wireless device at the first base station), (iv) modulation scheme to be utilized for data transmission (e.g., Quadrature Amplitude Modulation (QAM) scheme—16-QAM, 64-QAM, 256-QAM, etc. or modulation index from 5G standard set of modulation indices), (v) Quality of Service (QoS) to be provided to the first wireless device (e.g., via contract between subscriber of the first wireless devices and operator of the first base station), and (vi) type of application on the first wireless device requesting the radio resources (e.g., voice call application, text messaging application, e-mail communications application, data transfer application, multi-media application, internet service application, emergency services application (e.g., 911 service application)). Operation proceeds from step 2506 to step 2508.

In step 2508, in response to receiving the first request for the radio resources from the first wireless device, the first blockchain enabled scheduler of the first base station initiates generation of a first smart contract (e.g., by sending a message or request to a first smart function (e.g., smart contract function/miners network 106 of system 100 and 300) of the first base station to generate a first smart contract). Operation proceeds from step 2508 to step 2510.

In step 2510, the first smart contract function of the first base station generates the first smart contract. The first smart contract including: (i) information for identifying the first wireless device as a first party to the first smart contract (e.g., IMEI/C-RNTI) for UE 1 140), (ii) information identifying the base station radio system serving the first wireless device as a second party to the first smart contract (e.g., NRGCI for base station radio system A 112), and (iii) information on terms of the first smart contract. In some embodiments, the information on the terms of the first smart contract include: (i) information on the radio resources to be allocated to the first wireless device for use in communicating with the base station radio system serving the first wireless device, (ii) conditions on when the smart contract is be executed, and (iii) one or more actions to be initiated by the first smart contract when the conditions in the first smart contract have been met. In some embodiments, the first smart contract is an executable software routine that performs the following operations: (i) monitoring to detection when the conditions identified in the first smart contract are met; and (ii) in response to detecting that the conditions in the first smart contract are met initiating said one or more actions identified in the first smart contract. In some embodiments, the conditions in the first smart contract are receipt of information indicating the acceptance of the first smart contract offer by the first wireless device. Operation proceeds from step 2510 to step 2512.

In step 2512, the first smart contract generates a first smart contract offer message. The first smart contract offer message including the identification of the parties to the first smart, information on the terms of the first contract, and information the radio resources to be allocated/reserved for the first wireless device to utilize in communicating or transferring data to the base station radio system serving the first wireless device which is identified as a party to the first smart contract. Operation proceeds from step 2512 to step 2514. In step 2514, the first smart contract offer message is communicated to the first wireless device (e.g., by the first smart contract function via the base station radio system serving the first wireless device). In some embodiments, the first smart contract offer include the conditions which when met will result in the execution of the first smart contract and action(s) which will be performed pursuant to the terms of the first smart contract. In some embodiments, the conditions which will result in the execution of the first smart contract and the action(s) being performed is the receipt by the first smart contract function of information indicating an acceptance of the first smart contract offer by the first wireless device and in some embodiments by both first wireless device and the base station serving the first wireless device which are the two parties identified in the first smart contract. Operation proceeds from step 2514 to optional step 2516.

In optional step 2516, the first smart contract is communicated to the base station radio system serving the first wireless device for acceptance of the terms of the first smart contract. In various embodiments, this step is not performed as the base station radio system gives tacit acceptance or the acceptance is not required (e.g., as the smart contract function is acting on behalf of the base station radio system serving the first wireless device in sending the first smart contract offer to the first wireless device both the first smart contract function and the base station radio system being part of the first base station to which the radio resource request was made). Operation proceeds from step 2516 via communications node 2518 to step 2520 shown on FIG. 21B. In step 2520, the first wireless device receives the first smart contract offer message. Operation proceeds from step 2520 to optional step 2522. In step 2522, the base station radio system serving the first wireless device receives the smart contract offer. Operation proceeds from step 2522 to step 2524. In step 2524, the first wireless device determines to accept the first smart contract offer and communicates a first smart contract offer acceptance message it generates to the first smart contract function. Operation proceeds from step 2524 to optional step 2526. In optional step 2526, the base station radio system serving the first wireless device determines to accept the first smart contract offer and communicates a first contract offer acceptance message it generates to the first smart contract function. Operation proceeds from step 2526 to step 2528.

In step 2528, the first smart contract function receives the first smart contract offer acceptance message from the first wireless device. Operation proceeds from step 2528 to optional step 2530. In optional step 2530, the first smart contract function receives the first smart contract offer acceptance message from the base station serving the first wireless device. Operation proceeds from step 2530 to step 2532.

In step 2532, in response to detecting, by the first smart contract function or the first smart contract based on information inputted or communicated to it by the first smart contract function, that the conditions specified in the terms of the first smart contract have been met or satisfied (e.g., acceptance of the first smart contract offer), initiating one or more actions identified in the first smart contract (e.g., by the first smart contract or the first smart contract function). In some embodiments, initiating actions includes: communicating instructions to entities (e.g., first blockchain enabled scheduler, first smart contract function, a ledger update function or entity, a storage component which handles storage and retrieval of data in the first base station, RLC function, base station radio systems) to perform the action or one or more operations for and/or in connection with implementing the action. In various embodiments, the actions include: (i) updating a smart contract blockchain ledger to include the first smart contract or information included in the first smart contract, (ii) generating a first token for the first smart contract, (iii) updating the radio resource allocation blockchain ledger to include the radio resource allocation included in the first token, (iv) distributed the updated smart contract blockchain ledger and the updated radio resource allocation blockchain ledger to other entities (e.g., the first blockchain enabled scheduler of the first base station, other schedulers of the first base station (e.g., scheduler for other base station radio systems of the first base station when separate entities are used for each base station radio system, a second base station, a second smart contract function, and other functions/components of the first base station which did not generate the ledgers), and (v) issuing the first token to the first wireless device. In various embodiments, the first token includes one or more of the following: (a) information identifying the radio resources allocated for the first wireless device to use for communicating data to the base station serving the first wireless device, (b) a start time indicating when the first wireless device can begin transferring data using the allocated radio resources identified in the first token, (c) information indicating when the first token will expire along with the allocation of radio resources, (d) the identity of the first wireless device which was included in the first smart contract, (e) the identity of the base station radio system serving the first wireless device which was included in the first smart contract.

In some embodiments, the smart contract blockchain ledger is for the first base station or for the base station radio system serving the first wireless device. In some embodiments, updating the smart contract blockchain ledger includes adding or chaining the first smart contract as the next block to a smart contract blockchain in the smart contract blockchain ledger. In some embodiments, updating the smart contract blockchain ledger includes adding the information in the first smart contract to a new block and adding or chaining the new block to the smart contract blockchain in the smart contract blockchain ledger.

In some embodiments, instead of the first smart contract initiating the generation and issuance of the first token, the first blockchain enabled scheduler in response to receiving information (e.g., a notification from the first smart contract function or the receipt of the distributed updated smart contract ledger including the first smart contract) that the first smart contract offer has been accepted by the first wireless device, communicates a request to the first smart contract function to issue a first token to the first wireless device for the first smart contract. In some such embodiments, in response to receiving the request to issue a first token, the first smart contract function generates the first smart contract and communicates the first smart contract to the first wireless device. In some embodiments, the first blockchain enabled scheduler generates the first token and includes it with the request to the first smart contract function to issue the first token.

Operation proceeds from step 2532 via connection node B 2536 to step 2538 shown on FIG. 21C. In step 2538, the first token is generated (e.g., by the first smart contract function or the first blockchain enabled scheduler (e.g., in response to an instruction from the first smart contract or notification that the first smart contract offer has been accepted by the first wireless device or the parties to the first smart contract). In some embodiments, step 2538 includes sub-step 2540. In sub-step 2540, the radio resources (e.g., PRBs or resource elements of PRBs) are identified that are available for allocation to the first wireless device based on information obtained from the radio resource allocation blockchain ledger. The radio resource blockchain ledger including information on the radio resources already allocated for the base station radio system serving the first wireless device. From the identified available radio resources, the specific radio resources to allocate/reserve for the first wireless device are identified and included in the first token. (e.g., in the form of a PRB index or resource element index that identifies the radio resources (e.g., PRBs or resource elements of PRBs that are allocated/reserved for use for the first wireless device to communicate data to the base station radio system serving the first wireless device). Operation proceeds from step 2538 to step 2542.

In step 2542, the radio resource allocation blockchain ledger is updated (e.g., by the first blockchain enabled scheduler, the first smart contract function, or a storage component of the first base station that handles storage and retrieval of data for the first base station) to include/reflect the radio resources allocated to the first wireless device in the first token (e.g., by adding the first token or information included in the first token as the next block in the radio resource allocation blockchain ledger). Operation proceeds from step 2542 to step 2544. In step 2544, the updated radio resource blockchain ledger is distributed to other entities (e.g., other entities in the first base station and/or other base stations of the wireless system to which the first base station belongs). For example, when the first base station is the distributed base station 101′ shown in FIG. 2 and is used in the system 300 of FIG. 3, the updated radio resource blockchain ledger is distributed to each of the smart contract functions, RLC functions, and blockchain enabled scheduler functions of the distributed base station 101′ smart contract functions, RLC functions, and blockchain enabled scheduler functions of the centralized computing systems 202 and 302). Operation proceeds from step 2544 to step 2546.

In step 2546, the first token is communicated (e.g., by the first smart contract function or the first blockchain enabled scheduler) to the base station radio system serving the first wireless device. Operation proceeds from step 2546 to step 2548. In step 2548, the first token is communicated to the first wireless device by the base station radio system serving the first wireless device. Operation proceeds from step 2548 to step 2550. In step 2550, the first wireless device receives and processes the first token identifying the radio resources allocated for use by the first base and when the first wireless device can begin using the radio resources identified in the first token as well as for how long. Operation proceeds step 2550 to step 2552. In step 2552, the first wireless device uses the radio resources (e.g., PRBs) identified in the first token for its use to communicate data (e.g., data in its uplink buffer) to the base station radio system serving the first wireless device. Operation proceeds from step 2552 to step 2554.

In step 2554, the first base station (e.g., the base station radio system serving the first wireless device or the first smart contract function) determines that the data transmission from the first wireless device has been completed or that the first token has expired. Operation proceeds from step 2554 via connection node C 2556 to step 2558. In step 2558, in response to determining by the first base station that the data transmission from the first wireless device has been completed or that the first token has expired, a notification is communicated, by the base station serving the first wireless device, to the first wireless device to cease utilizing the radio resources identified in the first token for the first wireless device. Operation proceeds from step 2558 to step 25560. In step 2560, in response to determining by the first base station that the data transmission from the first wireless device has been completed or that the first token has expired, the first base station (e.g., the first blockchain enabled scheduler or the first smart contract function) releases the radio resources allocated in the first token for use by the first wireless which makes them available to be allocated in other tokens for use for example by other wireless devices being served by the base station radio system serving the first wireless device. Operation proceeds from step 2560 to step 2558. Operation proceeds from step 2560 to step 2562.

In step 2562, the radio resource allocation blockchain ledger is updated (e.g., by the first blockchain enabled scheduler, the first smart contract function, or a storage component of the first base station) to indicate that the radio resources allocated to the first wireless device in the first token have been released and are available for re-allocation (e.g., to other devices). Operation proceeds from step 2562 to step 2564. In step 2564, the updated radio resource blockchain ledger is distributed to other entities as described above. Operation proceeds from step 2564 to step 2566. In step 2566, the smart contract blockchain ledger (e.g., by the first smart contract function or a storage component) to indicate that the first smart contract has been completed. Operation proceeds from step 2566 to step 2568. In step 2568, the smart contract blockchain ledger is distributed to other entities as previously described. Operation proceeds from step 2568 to step 2570. In step 2570, the method 2500 is repeated for additional radio resource requests from wireless devices being served by the first base station.

In some embodiments of method 2500, the first base station is a distributed base station including: (i) a central computing system, and (ii) a plurality of base station radio systems. In some embodiments, each of the plurality of base station radio systems includes a radio unit, each radio unit including a transmitter, a receiver and an antenna or antenna system (e.g., beam forming antenna array system). In some embodiments, the central computing system includes a first server, said first blockchain enabled scheduler being a function executing on the first server. In some embodiments, the first smart contract function is a function executing on the first server. In some embodiments, a first Radio Link Controller function of the first base station is a function executing on the first server. In some embodiments, the central computing system is a cloud computing system. In some embodiments, the central computing system includes a plurality of servers, said plurality of servers including at least one server for each of the plurality of base station radio systems of the first base station. In some embodiments, the plurality of base station radio systems includes a first radio base station system, said first radio base station system actively serving a first plurality of wireless devices and a second radio base station system actively serving a second plurality of wireless devices, said first plurality of wireless devices not including wireless devices in said second plurality of wireless devices, and at least some of said radio resources being utilized by the first base station radio system and the second base station radio system are the same, said first base station radio system and said second base station radio system having overlapping coverage areas.

In some embodiments as previously discussed the radio resource type is a physical resource block (PRB) type and the amount of radio resources to be allocated for use by the first wireless device to communicate with the base station radio system serving the first wireless device is an amount of physical resource blocks (PRBs) to be allocated for use by the first wireless device to communicate with the base station radio system serving the first wireless device. In some embodiments, the step of determining the amount of radio resources to be allocated for use by the first wireless device to communicate with the base station radio system serving the first wireless device is further based on information contained in a blockchain ledger, each block of the blockchain ledger including: (i) information on radio resources of the first base station that have been allocated for use by a wireless device being served by the first base station, (ii) information on the identity of the wireless device to which the radio resources have been allocated, and (iii) information on the identity of the base station radio system serving the wireless device to which the radio resources have been allocated. In some embodiments, the information contained in the radio resource allocation blockchain ledger includes information on the scheduled allocation of all radio resources available to the base station radio system serving the first wireless device (e.g., identification of total amount of radio resources scheduled for usage vs. total radio resources to determine availability of radio resources that can be allocated to the first wireless device and for what period of time).

In some embodiments, he plurality of base station radio systems of the first distributed base station includes: a first base station radio system being located at a first location and a second base station radio system being located at a second location, said first and second locations being different locations; said first base station radio system and said second base station radio system having overlapping coverage areas, said first base station radio system and said second base station radio system using the same spectrum (e.g., the same 5 MHz channel).

In some embodiments, each of the functions of the system 100 and 300 (e.g., RLC function, blockchain enabled scheduler function, and smart contract function are implemented by circuitry). In some embodiments, each of the functions of system 100 and 300 are implemented by processor executing instructions to perform the steps, functions, and operations discussed in the connection with or attributed to the function (e.g., the blockchain enabled scheduler function, the smart contract function, and the RLC function).

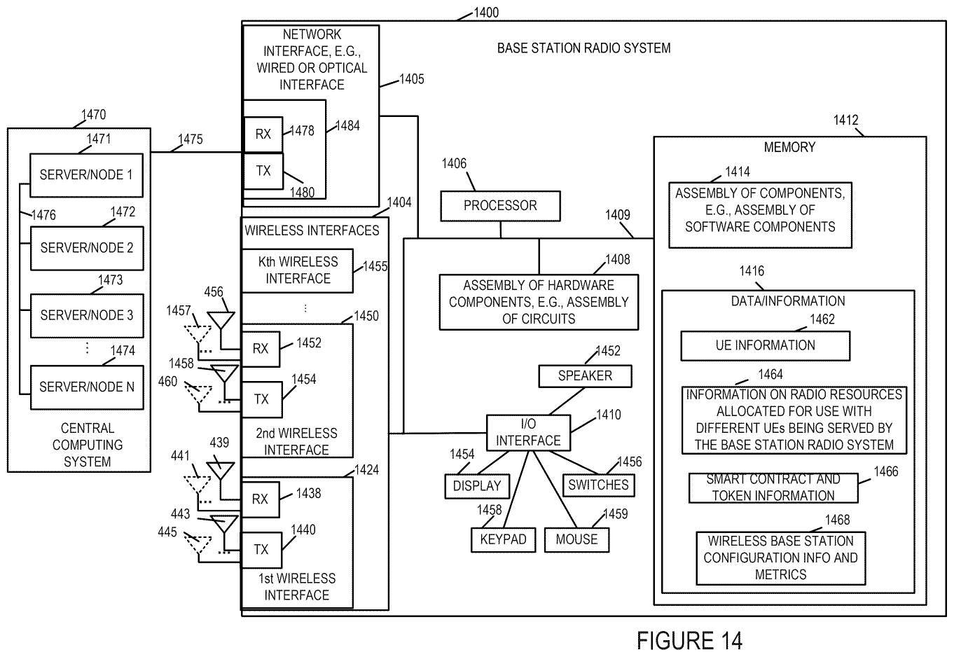

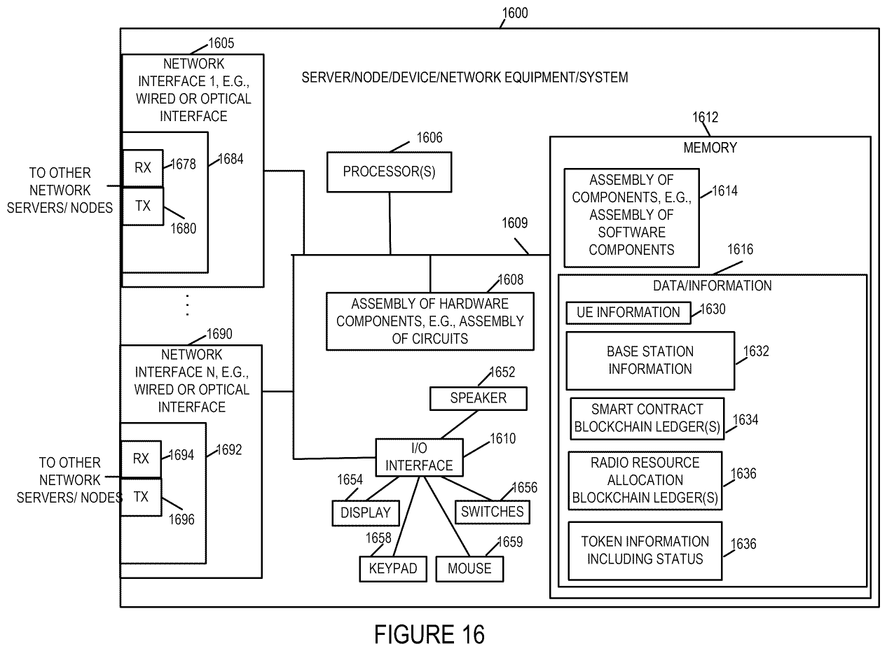

FIG. 14 is a drawing of an exemplary base station radio system 1400 coupled or connected to a central computing system 1470 via a communications link 1475 in accordance with an exemplary embodiment. The combination forming a distributed base station when the functions/entities shown in central computing system 102 are implemented on the central computing system 1470 as discussed below. The central computing system 1470 includes a plurality of servers and/or nodes (server/node 1 1471, server/node 2 1472, server/node 3 1473, . . . , server/node N 1474, where N is an integer greater than 3) coupled or connected via communications link 1476 which allows the exchange of data and information between the servers. In some embodiments, the central processing system 1470 is implemented in the cloud or is a clouding computing system. In some embodiments, one or more of the servers and/or nodes of the central computing system 1470 are implemented in accordance with exemplary server 1600 shown in FIG. 16. In some embodiments, one or more of the central computing systems discussed and/or shown in the Figures and/or in connection with the methods discussed herein are implemented in accordance with the central computing system 1470. For example, in some embodiments, the central computing system 102 of system 100 is implemented in accordance with central computing system 1470. In some such embodiments, one or more of the functions 104, 106, and 108 may be, and sometimes are, implemented on one or more of the plurality of servers/nodes of the central computing system 1470. In some embodiments, each of the functions 104, 106, and 108 are implemented on a different server or node of central computing system 1470. In some embodiments, the central computing system 102′ of FIG. 2 is implemented in accordance with central computing system 1470. In some embodiments, one or more of the central computing systems 102, 202 and 302 of system 300 shown in FIG. 3 are implemented in accordance with central computing system 1470.

Base station radio system 1400 may be, and in some embodiments is implemented as including the radio unit of an eNodeB, gNodeB, or Citizens Broadband Radio Service Device (CBSD), in accordance with an exemplary embodiment. Exemplary base station radio system 1400 includes wireless interfaces 1404, a network interface 1405, e.g., a wired or optical interface, a processor 1406, e.g., a CPU, an assembly of hardware components 1408, e.g., an assembly of circuits, and I/O interface 1410, and memory 1412 coupled together via a bus 1409 over which the various elements may interchange data and information. Base station radio system 1400 further includes a speaker 1452, a display 1454, switches 1456, keypad 1458 and mouse 1459 coupled to I/O interface 1410, via which the various I/O devices (1452, 1454, 1456, 1458, 1459) may communicate with other elements (1404, 1405, 1406, 1408, 1412) of the base station radio system 1400. Network interface 1405 includes a receiver 1478 and a transmitter 1480. In some embodiments, receiver 1478 and transmitter 1480 are part of a transceiver 1484. Wireless interfaces 1404 include a plurality of wireless interfaces including first wireless interface 1424, second wireless interface 1450, . . . , Kth wireless interface 1455, K being an integer greater than 2. The wireless interfaces are used to communicate with the wireless devices, e.g., user equipment devices. The first wireless interface 1424 is used for example to communicate with a first user equipment device using a first spectrum band. The second wireless interface can be used to communicate with a second user equipment device using a second spectrum band. The first wireless interface 1424 includes wireless receiver 1438 and a wireless transmitter 1440. In some embodiments, receiver 1438 and transmitter 1440 are part of a transceiver. In various embodiments, the first wireless interface 1424 includes a plurality of wireless receivers and a plurality of wireless transmitters. Wireless receiver 1438 is coupled to a plurality of receive antennas (receive antenna 1 1439, . . . , receive antenna M 1441), via which base station radio system 1400 can receive wireless signals from other wireless communications devices including a second wireless communications device, e.g., a user equipment device. Wireless transmitter 1440 is coupled to a plurality of wireless transmit antennas (transmit antenna 1 1443, . . . , transmit antenna N 1445) via which the base station radio system 1400 can transmit signals to other wireless communications devices including a second wireless communications device, e.g., a user equipment device.

The second wireless interface 1450 includes wireless receiver 1452 and a wireless transmitter 1454. In some embodiments, receiver 1452 and transmitter 1454 are part of a transceiver. In various embodiments, the second wireless interface 1450 includes a plurality of wireless receivers and a plurality of wireless transmitters. Wireless receiver 1452 is coupled to one or more receive antennas (receive antenna 1 1456, . . . , receive antenna M 1457), via which wireless base station 1400 can receive wireless signals from other wireless communications devices including a second wireless communications device, e.g., a UE device, using the same or a different wireless protocol than the first wireless interface. Wireless transmitter 1454 is coupled to one or more wireless transmit antennas (transmit antenna 1 1458, . . . , transmit antenna N 1460) via which the wireless base station 1400 can transmit signals to other wireless communications devices including a second wireless communications device, e.g., UE device. The base station radio system network interface 1405 is coupled and/or connected to central computing system 1470 via communications link 1475. In some embodiments, the base station radio system 1400 includes multiple network interfaces so that it can connect to multiple networks and/or other devices (e.g., a cable network, a core network, other base stations or other base station radio systems) via the different interfaces.

Memory 1412 includes an assembly of components 1414, e.g., an assembly of software components, and data/information 1416. Data/information 1416 includes UE information 1462 (e.g., wireless device identity information, wireless device information including location information and configuration parameters, reported channel condition information, signal strength information, signal interference information, reference signal received power UE measured from other base station radio system in overlapping coverage, signaling information, modulation index and scheme information for data transfer, reported performance metrics, radio resources allocated (e.g., PRBs), token allocated) for the UE devices to which it is providing services; information on the radio resources/spectrum allocated for use by the UEs/wireless devices the base station radio system is serving 1464; smart contract and token information 1466 for the smart contract to which the base station radio system is party to and token information for tokens issued to UEs the base station radio system is serving. The data/information 1468 includes wireless base station information and metrics (e.g., wireless base station configuration information on transmit power levels, metrics and information collected and reported to the OSS of the wireless system such as for example successful connections, failed connections, successful handovers, failed handovers, signaling information such as signaling interference information, signal strength of UEs not being served by the base station radio system but which might cause interference and which can be used in the allocation of radio resources to avoid interference by deconflicting the allocation of radio resources to UEs being served by different base station radio systems in an overlapping coverage area (i.e., not assigning the same radio resources (e.g., PRBs) to two UEs in an overlapping coverage area as determined based on and reported signal strength measurements from the UEs and the base station radio systems).

While the details of the first and second wireless interfaces are shown, the other wireless interfaces of the wireless base station, e.g., wireless interface K where K is an integer greater than 2 also include multiple receivers and transmitters so that the base station radio system 1400 can provide wireless services to for example a plurality of wireless devices such as user equipment devices. In some embodiments, one or more of the base station radio systems discussed and/or shown in the Figures and/or in connection with the methods discussed herein are implemented in accordance with the base station radio system 1400. For example, the base station radio systems A 112, B 114, C 116 of system 100 of FIG. 1 and the A 112, B 114, C 116, D 212, E 214, F 216, G 312, H 314, and I 316 of system 300 are implemented in accordance with the base station radio system 1400.

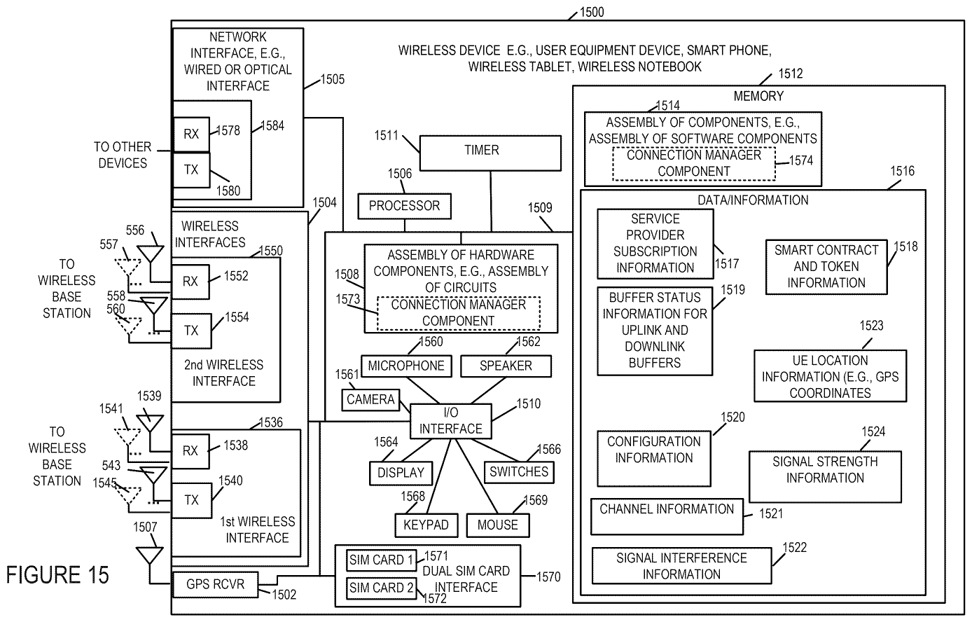

FIG. 15 is a drawing of an exemplary user equipment (UE) device 1500 in accordance with an exemplary embodiment. UE device 1500 is, e.g., a wireless device, e.g., a mobile device such as a cell phone, a smart phone, wireless tablet or wireless notebook. UE device 1500 is a dual SIM wireless device that is enabled to communicate using two different wireless networks and/or wireless protocols, e.g., 5G wireless protocol, CBRS wireless protocol or cellular wireless protocol. Exemplary UE device 1500 includes wireless interfaces 1504, a network interface 1505, a processor 1506, e.g., a CPU, an assembly of hardware components 1508, e.g., an assembly of circuits, and I/O interface 1510, a GPS receiver 1502 coupled to GPS receive antenna 1507, a timer 1511, e.g., a reference clock, a SIM card interface 1570 including a first SIM card, SIM card 1 1571, corresponding a first service provider, and a second SIM card, SIM card 2 1572 corresponding to a second service provider, and memory 1512 coupled together via a bus 1509 over which the various elements may interchange data and information. UE device 1500 further includes a microphone 1560, camera 1561, speaker 1562, a display 1564, e.g., a touch screen display, switches 1566, keypad 1568 and mouse 1569 coupled to I/O interface 1510, via which the various I/O devices (1560, 1561, 1562, 1564, 1566, 1568, 1569) may communicate with other elements (1502, 1504, 1505, 1506, 1508, 1512, 1570) of the UE device. Network interface 1505 includes a receiver 1578 and a transmitter 1580. The network interface 1505 can be coupled to routers within a home or a customer premises or to wired (e.g., cable) or optical (e.g., fiber-optic) networks. In some embodiments, receiver 1578 and transmitter 1580 are part of a transceiver 1584. In some embodiments, the assembly of hardware components 1508 includes a connection manager component 1573.

Wireless interfaces 1504 include a plurality of wireless interfaces including first wireless interface 1536 and a second wireless interface 1550. The first wireless interface 1536 is, e.g., used to communicate with a wireless base station of a first wireless network. The second wireless interface 1550 is, e.g., used to communicate with a wireless base station e.g., of a second wireless network. The first wireless interface 1536 includes wireless receiver 1538 and a wireless transmitter 1540. In some embodiments, receiver 1538 and transmitter 1540 are part of a transceiver. In various embodiments, the first wireless interface 1536 includes a plurality of wireless receivers and a plurality of wireless transmitters. Wireless receiver 1538 is coupled to a plurality of receive antennas (receive antenna 1 1539, . . . , receive antenna M 1541), via which user equipment device 1500 can receive wireless signals from other wireless communications devices including a wireless base station, e.g., a 5G NR wireless base station. Wireless transmitter 1540 is coupled to a plurality of wireless transmit antennas (transmit antenna 1 1543, . . . , transmit antenna N 1545) via which the user equipment device 1500 can transmit signals to other wireless communications devices including a 5G NR wireless base station. The antennas 1539, . . . , 1541 and 1543, . . . , 1545 are typically mounted inside the housing of the wireless device but in some embodiments are located outside the user equipment device housing. In some embodiments the various antennas form an antenna array with the antennas pointing in different directions. In some embodiments, one or more of the antennas are included inside the housing of the user equipment device and the user equipment device includes one or more connections to which exterior antennas may be connected.

The second wireless interface 1550 includes wireless receiver 1552 and a wireless transmitter 1554. In some embodiments, receiver 1552 and transmitter 1554 are part of a transceiver. In various embodiments, the second wireless interface 1550 includes a plurality of wireless receivers and a plurality of wireless transmitters. Wireless receiver 1552 is coupled to one or more receive antennas (receive antenna 1 1556, . . . , receive antenna M 1557), via which user device 1500 can receive wireless signals from other wireless communications devices including, e.g. a 5G NR base station or a base station radio system. Wireless transmitter 1554 is coupled to one or more wireless transmit antennas (transmit antenna 1 1558, . . . , transmit antenna N 1560) via which the user equipment device 1500 can transmit signals to other wireless communications devices including, e.g. a 5G NR wireless base station or a base station radio system. The user equipment device network interface 1505 may be coupled to LAN or WAN networks or routers so that the user equipment device can also obtain services via a hardwired connection in addition to through the wireless interfaces, e.g. when the UE device 1500 is at a location where such a connection is possible. In some embodiments, one or more of the wireless interfaces 1536 and 1550 are capable of communicating using different spectrum frequency ranges (e.g., frequency in FR 1 spectrum range and/or frequency in FR 2 spectrum range). While the wireless device 1500 is a dual SIM device only a single SIM device is necessary for implementing the invention and in some embodiments of wireless device 1500 only a single SIM is utilized.

Memory 1512 includes an assembly of components 1514, e.g., an assembly of software components, and data/information 1516. In some embodiments, the assembly of software components 1514 includes a connection manager component 1574 which determines to which base station radio system and/or which cell of a base station radio system the user equipment device 1500 is to connect. Data/information 1516 includes service provider subscription information 1517, e.g. credentials and NAI realm information corresponding to a first service provider. Data/information 1516 further includes Uplink/Downlink usage information 1518 (e.g., uplink and downlink data demand for sessions (e.g., within a time interval or period). Data/information 1516 further includes smart contract and token information 1519. Data/information 1516 further includes configuration information for communicating using allocated radio resources or spectrum 1520 (e.g., frame, sub-frame, time slot, symbols/timeslot Downlink or Uplink configuration information, modulation index to be used as instructed by the base station radio system serving the UE and the radio resources to be used (e.g., PRBs allocated for usage, and/or which symbols or resource elements of a PRB allocated for usage by a token received pursuant to a smart contract); handover parameters, connection decision parameters). Data/information 1516 further includes channel information 1521 (e.g., information on the radio channel conditions), signal interference information 1522 (e.g., SNIR measurements), UE location information (e.g., GPS coordinates) 1523, and signal strength information 1524 (e.g., Reference Signal Received Power (RSRP) measurements). The channel information, location information, and measurements are reported the base station radio system which is serving the wireless device so that it can be used in managing the radio resources/spectrum allocated to the wireless device (e.g., in estimating the amount of radio resources to allocate for an amount of data to be transferred and for determining which radio resources to allocate to avoid conflicts).

In some embodiments, the user equipment devices discussed in the Figures and/or in connection with the embodiments of the present invention are implemented in accordance with user equipment device 1500. For example, UE 1 140, UE 2 142, UE 3 144, UE 4 1146, UE 5 148, UE 6 150, UE 7 240, UE 8 242, UE 9 244, UE 10 246, UE 11 248, UE 12 250, UE 13 340, UE 14 342, UE 15 344, UE 16, 346, UE 17 348, UE 18 350, . . . , UE N 352 of system 100 shown in FIG. 1 and system 300 shown in FIG. 3 may be, and in some embodiments are, implemented in accordance with wireless device 1500.

FIG. 16 is a drawing of an exemplary server, node, device, network equipment, or system 1600 (e.g., a core network system, a scheduler server or node, a smart contract/miners network server or node, Radio Link Controller server or node) in accordance with an exemplary embodiment. The server, node, device, system, or network equipment 1600 will be referred to herein as a server. The server 1600 includes a plurality of network interfaces 1605, . . . , 1690, e.g., a wired or optical interface, a processor(s) 1606 (e.g., one or more processors), e.g., a CPU, an assembly of hardware components 1608, e.g., an assembly of circuits, and I/O interface 1610 and memory 1612 coupled together via a bus 1609 over which the various elements may interchange data and information. The server 1600 further includes a speaker 1652, a display 1654, switches 1656, keypad 1658 and mouse 1659 coupled to I/O interface 1610, via which the various I/O devices (1652, 1654, 1656, 1658, 1659) may communicate with other elements (1605,. 1690, 1606, 1608, 1612) of the server 1600. Network interface 1605 includes a receiver 1678 and a transmitter 1680. The network interface 1605 is typically used to communicate with other devices, e.g., other servers, core network equipment, base station radio system. In some embodiments, receiver 1678 and transmitter 1680 are part of a transceiver 1684. Network interface 1690 includes a receiver 1694 and a transmitter 1696. The network interface 1690 is typically used to communicate with other devices, e.g., base stations, base station radio systems, other network nodes, servers, systems or nodes, or equipment in the network core, etc. In some embodiments, receiver 1694 and transmitter 1696 are part of a transceiver 1692. Memory 1612 includes an assembly of component 1614, e.g., an assembly of software components, and data/information 1616. Data/information 1616 includes UE information 1630. Data/information 1616 also includes base station information 1632 including for example configuration information for a plurality of base station radio systems as well as other metrics and information (e.g., information on location of the base station radio base systems, data traffic uplink and downlink demand information for individual base station radio systems, signal interference level information for base station radio systems, signal strength coverage level information for the base station radio system, signal interference distribution for the base station radio systems, signal strength distribution for the base station radio systems, user equipment location information for the base station radio systems), base station radio system configuration of cell symbols/slot configuration and frame, slot, and modulation information. Data/information 1616 also includes one or more smart contract blockchain ledgers 1634; radio resource allocation blockchain ledger(s) 1636; and token information including token status 1638.

The specific information included in data/information 1616 depends on the specific server, node, device, system, or network equipment implemented. For example, if the server 1600 is implemented as a smart contract server the data/information 116 will include information on the status of smart contracts, token generation, information for updating the blockchain ledger regarding allocation and use of radio link resources, etc. while such information would not necessarily be included in data/information 1616 when the server 1600 is implemented a RLC server. However, when the server 1600 is implemented as a RLC server the data/information 1616 will include RLC instructions to be sent to UEs which would not be included in a smart contract server data/information 1616 memory.

In some embodiments, the servers, nodes, devices, network equipment, and/or systems discussed in the Figures and/or in connection with the embodiments of the present invention described are implemented in accordance with server 1600. For example, the servers/nodes of the central computing system 1470 of FIG. 1400, the servers illustrated in FIG. 2 and the functions of the central computing system, and the central computing systems 102, 102′, 202, 302 are implemented in accordance with the server, node, device, network equipment, system 1600. In some embodiments, the blockchain enabled scheduler function 104, 204, 304, smart contract function/miners network 106, 206, 306, and RLC functions 108, 208, 308 are implemented as components of central processing system implemented in accordance with server, node, device, network equipment, system 1600

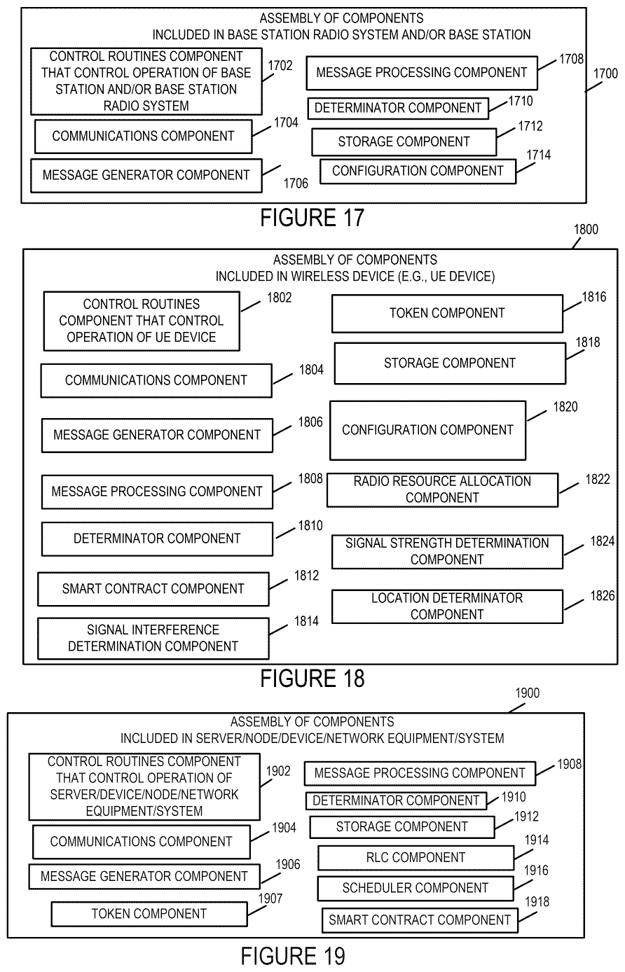

FIG. 17 is a drawing of an exemplary assembly of components 1700 which may be included in an exemplary base station or an exemplary base station radio system (e.g., exemplary base station radio system 1400 of FIG. 14), in accordance with an exemplary embodiment. The components in the assembly of components 1700 can, and in some embodiments are, implemented fully in hardware within a processor, e.g., processor 1406, e.g., as individual circuits. The components in the assembly of components 1700 can, and in some embodiments are, implemented fully in hardware within the assembly of hardware components 1408, e.g., as individual circuits corresponding to the different components. In other embodiments some of the components are implemented, e.g., as circuits, within processor 1406 with other components being implemented, e.g., as circuits within assembly of components 1408, external to and coupled to the processor 1406. As should be appreciated the level of integration of components on the processor and/or with some components being external to the processor may be one of design choice. Alternatively, rather than being implemented as circuits, all or some of the components may be implemented in software and stored in the memory 1412 of the base station radio system 1400, with the components controlling operation of base station radio system 1400 to implement the functions corresponding to the components when the components are executed by a processor e.g., processor 1406. In some such embodiments, the assembly of components 1700 is included in the memory 1412 as assembly of software components 1414. In still other embodiments, various components in assembly of components 1700 are implemented as a combination of hardware and software, e.g., with another circuit external to the processor providing input to the processor which then under software control operates to perform a portion of a component's function.

When implemented in software the components include code, which when executed by a processor, e.g., processor 1406, configure the processor to implement the function corresponding to the component. In embodiments where the assembly of components 1700 is stored in the memory 1412, the memory 1412 is a computer program product comprising a computer readable medium comprising code, e.g., individual code for each component, for causing at least one computer, e.g., processor 406, to implement the functions to which the components correspond.

Completely hardware based or completely software based components may be used. However, it should be appreciated that any combination of software and hardware, e.g., circuit implemented components may be used to implement the functions. As should be appreciated, the components illustrated in FIG. 17 control and/or configure the base station radio system 1400 or elements therein such as the processor 1406, to perform the functions of corresponding steps illustrated and/or described in the method of one or more of the flowcharts, signaling diagrams and/or described with respect to any of the Figures. Thus the assembly of components 1700 includes various components that perform functions of corresponding one or more described and/or illustrated steps of an exemplary method.

Assembly of components 1700 includes a control routines component 1702, a communications component 1704, a message generator component 1706, a message processing component 1708, a determinator component 1710, a storage component 1712, and a configuration component 1714.

The control routines component 1702 is configured to control operation of the base station radio system or a base station if used in a non-distributed base station.

The communication component 1704 is configured to handle communications, e.g., transmission and reception of messages, and protocol signaling for the base station radio system and/or base station (e.g., communications with user equipment devices and components, functions, devices, and servers in a central computing system and/or network core and/or other base stations).

The message generator component 1706 is configured to generate messages for transmission to other devices, e.g., request messages, response messages, notification messages, messages for sharing information (such as for example, UE identification, location and session information, signal strength coverage information, signaling interference coverage information, downlink/uplink traffic demand information, buffer status information, radio resource requests, smart contract offer messages, smart contract acceptance messages, messages including tokens), communications messages with central computing system, devices, and communications messages with user equipment devices (e.g., symbols/slot configuration information, smart contract messages, token messages). In some embodiments, the message generator component 1706 is a sub-component of the communications component 1704.

The message processing component 1708 is configured to process messages received from other devices and implement operations in response to instructions and/or information included in the processed message, e.g., processing and implementing operations in connection with messages from user equipment devices, messages from network equipment devices/servers/central computing system. The message processing component all is responsible for processing internal messaging between components and/or functions of the base station radio system or base station. In some embodiments, the message processing component 1708 is a sub-component of the communications component 1704.

The determinator component 1710 is configured to make determinations and decisions for the base station radio system including for example: signal strength information, signal interference information, determinations of whether or not to accept a smart contract offer, determinations of whether a data transmission has completed successfully, determinations of whether tokens have expired.

The storage component 1712 is configured to manage the storage, and retrieval of data and/or instructions to/and from memory, buffers in memory, hardware buffers and/or storage device coupled and/or connected to the base station or base station radio system. The storage component 1712 also manages the storage and retrieval of data from blockchain ledgers and the formation and updating of blockchain ledgers.

The configuration component 1714 is configured to manage the implementation of the base station radio system's configuration including implementing configuration instructions (e.g., configuration instructions for allocating radio resources (e.g., PRBs to UEs for usage) as well as frame, sub-frame, modulation, slot and symbols/slot downlink/uplink configuration instructions received at the base station radio system or the base station (e.g., from a base station radio system configuration manager server in the central computing system or the network core)).

FIG. 18 is a drawing of an exemplary assembly of components 1800 which may be included in an exemplary user equipment (UE) device, e.g., UE device 1500 of FIG. 15, in accordance with an exemplary embodiment. The components in the assembly of components 1800 can, and in some embodiments are, implemented fully in hardware within a processor, e.g., processor 1506, e.g., as individual circuits. The components in the assembly of components 1800 can, and in some embodiments are, implemented fully in hardware within the assembly of hardware components 1508, e.g., as individual circuits corresponding to the different components. In other embodiments some of the components are implemented, e.g., as circuits, within processor 1506 with other components being implemented, e.g., as circuits within assembly of components 1508, external to and coupled to the processor 1506. As should be appreciated the level of integration of components on the processor and/or with some components being external to the processor may be one of design choice. Alternatively, rather than being implemented as circuits, all or some of the components may be implemented in software and stored in the memory 1512 of the UE device 1500, with the components controlling operation of UE device 1500 to implement the functions corresponding to the components when the components are executed by a processor e.g., processor 1506. In some such embodiments, the assembly of components 1800 is included in the memory 1512 as assembly of software components 1514. In still other embodiments, various components in assembly of components 1800 are implemented as a combination of hardware and software, e.g., with another circuit external to the processor providing input to the processor which then under software control operates to perform a portion of a component's function. When implemented in software the components include code, which when executed by a processor, e.g., processor 1506, configure the processor to implement the function corresponding to the component. In embodiments where the assembly of components 800 is stored in the memory 1512, the memory 1512 is a computer program product comprising a computer readable medium comprising code, e.g., individual code for each component, for causing at least one computer, e.g., processor 1506, to implement the functions to which the components correspond.

Completely hardware based or completely software based components may be used. However, it should be appreciated that any combination of software and hardware, e.g., circuit implemented components may be used to implement the functions. As should be appreciated, the components illustrated in FIG. 18 control and/or configure the UE device 1500 or elements therein such as the processor 1506, to perform the functions of corresponding steps illustrated and/or described in the method of one or more of the flowcharts, signaling diagrams and/or described with respect to any of the Figures. Thus the assembly of components 1800 includes various components that perform functions of corresponding one or more described and/or illustrated steps of an exemplary method.

Assembly of components 1800 includes a control routines component 1802, a communications component 1804, a message generator component 1806, a message processing component 1808, a determinator component 1810, a data smart contract component 1812, a signal interference determination component 1814, a token component 1816, a storage component 1818, a configuration component 1820, a radio resource allocation component 1822, signal strength determination component 1824, and a location determinator component 1826.

The control routines component 1802 is configured to control operation of the wireless device (e.g., UE). The communications component 1804 is configured to handle communications, e.g., receipt and transmission of signals and provide protocol signal processing for one or protocols for the wireless device.

The message generator component 1806 is configured to generate messages for transmission to base stations or base station radio systems (e.g., 5G NR base stations, CBSD devices, gNodeBs, eNodeBs, distributed base stations) such as messages including request and response messages, smart contract offer acceptance messages, radio resource request messages, buffer status messages, etc. In some embodiments, the message generator component 1806 is a sub-component of the communications component 1804.

The message processing component 1808 processes received messages, e.g., requests for information. In some embodiments, the message processing component 1808 is a sub-component of the communications component 1804.

The determinator component 1810 makes determination for the user equipment devices such as for example, determining GPS coordinates for the UE, determining to make radio resource requests or data transfer requests, determining whether to accept smart contract offers, determining which radio resources have been allocated for use based on information included in a token (e.g., based on PRB index information); determining which PRBs identified as available for use to self-allocate and utilize, determining signaling interference levels, determining signaling strength levels, determining to report UE information (e.g., signaling strength, UE location, uplink and downlink traffic demand, signaling interference measurements) to the wireless base station to which it is connected so it can be used for spectrum allocation decisions by the base station.

The smart contract 1812 components manages all aspects of smart contracts for the wireless device including determining whether or not to accept smart contract offers and/or to request changes to the smart contract offer such as changes to the terms such as amount of resources to be allocated and/or timing of the allocation.

The signaling interference component 1812 measures and/or determines signaling interference levels (e.g., SINR measurements) at various locations.

The token component 1816 is configured to manage and all handle all tasks and/or operations related to tokens including the receipt and processing of tokens, determination of radio resources identified for use by the wireless device in the token as well as the start time of usage of the allocated radio resources, which PRBs are allocated for usage, which resource elements are allocated for usage, duration of the token, and determination of expiration of the token and allocation of the resources identified in the token.

The storage component 1818 is configured to perform all operations in storing and retrieving information (e.g., credential information, location information, signaling interference data, signaling strength data, uplink and downlink traffic demand data, UE location information, radio resource allocation information, token information including token expiration time, smart contract information, spectrum information, configuration information (e.g., for communicating using the radio resources allocated (e.g., the PRBs identified token information for frame), information for encrypting and decrypting messages, tokens, smart contracts) from memory and/or storage devices (e.g., SIMs) located in the wireless device.

The configuration component 1820 configures the wireless device based on instructions received from the base station including configuration instructions for communicating using the radio resources identified in tokens.

The radio resource allocation component 1822 is configured to use the radio resources allocated in a token to communicate (e.g., transfer data) to the wireless base station. In some embodiments, the radio resource allocation component 1822 is a sub-component of the token component 1816 or the communications component 1804.

The signal strength determination component 1824 determines the signal strength at various locations when connected to a base station for example by measuring Reference Signal Received Power signal received from a base station and reports the information to the base station.

The location determinator component 1826 determines the location (e.g., GPS coordinates) of the wireless device.

FIG. 19 is a drawing of an exemplary assembly of components 1900 which may be included in a server, node, device, network equipment or system 1600 of FIG. 16, in accordance with an exemplary embodiment. The components in the assembly of components 1900 can, and in some embodiments are, implemented fully in hardware within a processor or one or more processors, e.g., processor(s) 1606, e.g., as individual circuits. The components in the assembly of components 1900 can, and in some embodiments are, implemented fully in hardware within the assembly of hardware components 1608, e.g., as individual circuits corresponding to the different components. In other embodiments some of the components are implemented, e.g., as circuits, within processor(s) 1606 with other components being implemented, e.g., as circuits within assembly of components 1608, external to and coupled to the processor(s) 1606. As should be appreciated the level of integration of components on the processor and/or with some components being external to the processor may be one of design choice. Alternatively, rather than being implemented as circuits, all or some of the components may be implemented in software and stored in the memory 1612 of the server 1600, with the components controlling operation of the server 1600 to implement the functions corresponding to the components when the components are executed by a processor e.g., processor 1606. In some such embodiments, the assembly of components 1900 is included in the memory 1612 as assembly of software components 1614. In still other embodiments, various components in assembly of components 1900 are implemented as a combination of hardware and software, e.g., with another circuit external to the processor providing input to the processor which then under software control operates to perform a portion of a component's function.

When implemented in software the components include code, which when executed by a processor or one or more processors, e.g., processor(s) 1606, configure the processor(s) to implement the function corresponding to the component. In embodiments where the assembly of components 1900 is stored in the memory 1612, the memory 1612 is a computer program product comprising a computer readable medium comprising code, e.g., individual code for each component, for causing at least one computer, e.g., processor 1606, to implement the functions to which the components correspond.

Completely hardware based or completely software based components may be used. However, it should be appreciated that any combination of software and hardware, e.g., circuit implemented components may be used to implement the functions. As should be appreciated, the components illustrated in FIG. 19 control and/or configure the server 1600 or elements therein such as the processor(s) 1606, to perform the functions of corresponding steps illustrated and/or described in the method of one or more of the flowcharts, signaling diagrams and/or described with respect to any of the Figures. Thus the assembly of components 1900 includes various components that perform functions of corresponding one or more described and/or illustrated steps of an exemplary method.

Assembly of components 1900 includes a control routines component 1902, a communications component 1904, a message generator component 1906, a token component 1907, a message processing component 1908, a determinator component 1910, a storage component 1912, a Radio Link Control (RLC) component 1914, a scheduler component 1916, a smart contract component 1920. The control routines component 1902 is configured to control operation of the server, device, node, network equipment or system in which the assembly of components 1900 is used. The communication component 1904 is configured to handle communications, e.g., transmission and reception of messages, and protocol signaling.

The message generator component 1906 is configured to generate messages for transmission to other devices. The token component 1907 is configured to generate tokens, communicate tokens, monitor the status of token (e.g., token expiration). The message processing component 1908 is configured to process messages and implement procedures/operations in response to messages or based on the contents of messages. This includes messages received from other devices, e.g., messages from wireless base stations, core network, radio base station system, other base stations. In some embodiments the token component is a sub-component of the smart contract component 1916 or the scheduler component 1918. The determinator component 1910 is configured to make determinations and decisions for the server/device/node/network equipment/system including for example determining radio resource allocations, when tokens have expired, when smart contract conditions have been met, when UEs are in overlapping coverage area. The storage component 1912 is configured to manage the storage, and retrieval of data and/or instructions to/and from memory, and/or storage devices coupled and/or connected to the network equipment device including formation, updating, and distribution of blockchain ledgers. The Radio Link Control (RLC) component 1914 is configured to manage RLC control operations for a base station and it performs the operations and functions described in connection with RLC function described in connection with the figures and methods described herein. The scheduler component 1916 is configured perform the steps, operations and/or functions described in connection with and/or attributed to the blockchain enabled scheduler function and/or schedulers of the figures and methods described herein including determining an amount of resources to be allocated to a wireless device in response to a request for resources. The smart contract function is configured 1918 is configured to perform the steps, operations and/or functions described in connection with and/or attributed to the smart contract function(s) of the figures, methods, and embodiments described herein including generating smart contracts, generating and communicating smart contract offers, receiving smart contract offer acceptances, determining when conditions of smart contract are met, generating tokens, identifying radio resources and/or spectrum resources to allocate, determining when a token has expired, determining when to release the radio resources of a token, forming, updating and distributing smart contract blockchain ledgers and radio resource allocation ledgers.

The specific components of the assembly of components 1900 included in any particular server, node, device, system, network equipment may, and typically does vary depending on the specific server, node, device, system, network equipment and the functionality required for the server, node, device, system, network equipment and/or the operations the server, node, device, system, network equipment is responsible for performing. While the exemplary base stations have been distributed base stations, the invention is also applicable regular or non-distributed base stations. In such embodiments, the base station includes the components of assembly of components 1700 and assembly of components 1900.

Various exemplary numbered embodiments illustrating different features of the present invention will now be discussed. The various features discussed may be used in variety of different combinations. It should be appreciated that not necessarily all embodiments include the same features and some of the features described below are not necessary but can be desirable in some embodiments. The numbered embodiments are only exemplary and are not meant to be limiting to the scope of the invention. The various method embodiments may be, and in some embodiments are, implemented on system 100 of FIG. 1, system 300 of FIG. 1 or the distributed base station 100′ of FIG. 2.

### List of Exemplary Numbered Method Embodiments:

Method Embodiment 1. A method comprising: initiating generation of a first smart contract by a first blockchain enabled scheduler of a first base station in response to receiving a first request for radio resources from a first wireless device; generating a first smart contract, by a first smart contract function of the first base station, said first smart contract including: (i) information identifying the first wireless device as a first party to the first smart contract, (ii) information identifying a base station radio system of the first base station that is serving the first wireless device as a second party to the first smart contract, and (iii) terms of the first smart contract; and communicating, by the first smart contract function, a first smart contract offer message to the first wireless device, said first smart contract offer message including information on the parties to the first smart contract and information on the terms of the first smart contract.

Method Embodiment 2. The method of Method Embodiment 1, wherein the information on the terms of the first smart contract includes: (i) information on radio resources to be allocated to the first wireless device for use in communicating with the base station radio system serving the first wireless device, (ii) conditions on when the first smart contract is to be executed, and (iii) one or more actions to be initiated by the first smart contract when the conditions in the first smart contract have been met.

Method Embodiment 2A. The method of Method Embodiment 2, wherein the first smart contract is an executable software routine that performs the following operations: (i) monitoring to detect when the conditions identified in the first smart contract are met; and (ii) in response to detecting that the conditions in the first smart contract are met initiating said one or more actions identified in the first smart contract.

Method Embodiment 2A1. The method of Method Embodiment 2A, wherein the conditions in the first smart contract are receipt of information indicating acceptance of the first smart contract offer by the first wireless device.

Method Embodiment 2A2. The method of Method Embodiment 2A, further comprising: communicating, by the first smart contract function, the first smart contract offer message to the first wireless device; and wherein the conditions in the first smart contract are receipt of information indicating the acceptance of the first smart contract offer by the first wireless device and acceptance of the first smart offer by the base station radio system serving the first wireless device.

Method Embodiment 2A3. The method of Method Embodiment 2A, wherein initiating one or more actions identified in the first smart contract includes sending an instruction to one or more entities or functions to perform the action.

Method Embodiment 2A4. The method of Method Embodiment 2A3, wherein the one or more entities or functions include one or more of the following: the first smart contract function, the first blockchain enabled scheduler, a storage component of the first base station, and a ledger update function or entity of the first base station.

Method Embodiment 2B. The method of Method Embodiment 2A, wherein the one or more actions identified in the first smart contract include: (i) updating of one or more blockchain ledgers, and (ii) distributing the updated one or more blockchain ledgers to other entities, said other entities including one or more of the following: the first blockchain enabled scheduler of the first base station, a second base station, and a second smart contract function.

Method Embodiment 2C. The method of Method Embodiment 2B, wherein said updating of one or more blockchain ledgers includes updating a smart contract blockchain ledger for the first base station, said updating the smart contract blockchain ledger for the first base station including adding or chaining the first smart contract as the next block to a smart contract blockchain in the smart contract blockchain ledger.

Method Embodiment 2D. The method of Method Embodiment 2B, wherein in response to receiving information (e.g., a notification from the first smart contract function or the distributed updated ledger including the first smart contract) that the first smart contract offer has been accepted by the first wireless device, communicating a request to the first smart contract function to issue a first token to the first wireless device for the first smart contract.

Method Embodiment 3. The method of Method Embodiment 2, wherein said information on the radio resources to be allocated to the first wireless device for use in communicating with the base station radio system serving the first wireless device includes: a radio resource type indicating the type of radio resources to be allocated for use by the first wireless device to communicate with the base station radio system serving the first wireless device.

Method Embodiment 4. The method of Method Embodiment 3, wherein the radio resource type is one of the following: a physical resource block type or a resource element of a physical resource block type.

Method Embodiment 4A. The method of Method Embodiment 2, wherein said information on the radio resources to be allocated to the first wireless device for use in communicating with the base station radio system serving the first wireless device further includes: an amount of radio resources to be provided for the first wireless device to use in communicating with the base station radio system serving the first wireless device.

Method Embodiment 5. The method of Method Embodiment 4, wherein said information on the radio resources to be allocated to the first wireless device for use in communicating with the base station radio system serving the first wireless device further includes: a duration of the allocation of the radio resources to the first wireless device for use in communicating with the base station radio system serving the first wireless device.

Method Embodiment 5A. The method of Method Embodiment 2, wherein said information on the radio resources to be allocated to the first wireless device for use in communicating with the base station radio system serving the first wireless device includes: information identifying the radio resources to be allocated to the first wireless device for use in communicating with the base station radio system serving the first wireless device.

Method Embodiment 6. The method of Method Embodiment 2, wherein said one or more actions to be initiated by the first smart contract when the conditions in the first smart contract have been met includes: a first action, said first action including initiating issuance of a first token to the first wireless device, said first token including information indicating radio resources allocated for the first wireless device to use for communicating with the base station serving the first wireless device.

Method Embodiment 6A. The method of Method Embodiment 6, wherein the first token includes a start time indicating when the first wireless device can begin transferring data using the allocated radio resources identified in the first token.

Method Embodiment 6B. The method of Method Embodiment 6A, wherein the first token further includes information indicating when the first token will expire (e.g., a token expiration time or a duration of use or a specific set of PRBs that may be used from the start time), said first token expiration ending the allocation of radio resources to the first wireless device by the first token.

Method Embodiment 6C. The method of Method Embodiment 6A, wherein the information included in the first token identifying radio resources allocated for the first wireless device to use for communicating with the base station serving the first wireless device includes: a Physical Block Resource (PRB) Index that identifies the radio resources allocated for the first wireless device to use for communicating (e.g., transferring data) with the base station radio system serving the first wireless device.

Method Embodiment 6D. The method of Method Embodiment 6, further comprising: generating the first token, by the first smart contract function or the first blockchain enabled scheduler, said generating the first token including identifying radio resources (e.g., PRBs or resource elements of PRBs) that are available for allocation to the first wireless device based on information obtained from a radio resource allocation blockchain ledger, said radio resource allocation blockchain ledger including information on the radio resources allocated for the base station radio system which is identified in the first smart contract (e.g., the base station radio system serving the first wireless device); and updating, by the first smart contract, the first blockchain enabled scheduler, or a storage component of the first base station, the radio resource allocation blockchain ledger to include the radio resources allocated to the first wireless device in the first token (e.g., add the first token or information on the allocated radio resources included in the first token to the radio resource allocation blockchain as the next block in the radio resource blockchain ledger); distributing the updated radio resource allocation blockchain leger to other entities (e.g., other base stations of the wireless system to which the first base station belongs and/or to other functions or entities (e.g., first smart contract function, first blockchain enabled scheduler, and base station radio systems of the first base station)); communicating the first token to the base station radio system serving the first wireless device which is identified in the first smart contract; communicating the first token to the first wireless device.

Method Embodiment 6E. The method of Method Embodiment 6D, further comprising: receiving, by the first wireless device, the first token; and using, by the first wireless device, the radio resources identified in the first token to transmit data to the base station radio system serving the first wireless device.

Method Embodiment 6F. The method of Method Embodiment 6E, further comprising: determining by the first base station (e.g., by the base station radio system serving the first wireless device or the first smart contract function) that the data transmission from the first wireless device has been completed or that the first token has expired; and in response to determining by the first base station (e.g., by the base station radio system serving the first wireless device or the first smart contract function) that the data transmission from the first wireless device has been completed or that the first token has expired, communicating a notification to the first wireless device to cease utilizing the radio resources identified for use by the first wireless device in the first token (e.g., sending a notification that the data transmission has completed successfully or that the first token has expired).

Method Embodiment 6G. The method of Method Embodiment 6F, further comprising: in response to the completion of the data transmission or the expiration of the first token, releasing by the first base station (e.g., by the first blockchain enabled scheduler or the first smart contract function) the radio resources allocated in the first token; updating, by the first smart contract, the first blockchain enabled scheduler or the storage component of the first base station, the radio resource allocation blockchain ledger to indicate that the radio resources allocated in the first token have been released; and distributing the updated radio resource allocation blockchain ledger to other entities (e.g., other base stations in a wireless system to which the first wireless base station belongs, first smart contract function, the first blockchain enabled scheduler (other smart contract functions when the first base station utilizes multiple smart contract functions, other blockchain enabled schedulers when the first base station utilizes multiple blockchain enabled schedulers).

Method Embodiment 7. The method of Method Embodiment 1, further comprising: prior to initiating generation of the first smart contract by the first blockchain enabled scheduler, determining, by the first blockchain enabled scheduler, an amount of radio resources to be allocated for use by the first wireless device to communicate with the base station radio system serving the first wireless device.

Method Embodiment 8. The method of Method Embodiment 7, wherein said determining the amount of radio resources to be allocated for use by the first wireless device to communicate with the base station radio system serving the first wireless device is based on: (i) information contained in the first request for radio resources from the first wireless device or in a buffer status report received by the first base station from the first wireless device; and (ii) information contained in a blockchain ledger, each block of the blockchain ledger including: (a) information on radio resources of the first base station that have been allocated for use by a wireless device being served by the first base station, (b) information on the identity of the wireless device to which the radio resources have been allocated, and (c) information on the identity of the base station radio system serving the wireless device to which the radio resources have been allocated.

Method Embodiment 8A. The method of Method Embodiment 8, wherein said determining the amount of radio resources to be allocated for use by the first wireless device to communicate with the base station radio system serving the first wireless device is further based on one or more of the following: (i) coverage area of the base station radio system serving the first wireless device, (ii) number of wireless devices actively being served by the base station radio system serving the first wireless device, (iii) radio conditions at the first wireless device (e.g., channel conditions and/or signal interference conditions (SINR) determined based on reports from the first wireless device and/or determined based on reference signals received from the first wireless device at the first base station), (iv) modulation scheme to be utilized for data transmission (e.g., Quadrature Amplitude Modulation (QAM) scheme—16-QAM, 64-QAM, 256-QAM, etc. or modulation index from 5G standard set of modulation indices), (v) Quality of Service (QoS) to be provided to the first wireless device (e.g., via contract between subscriber of the first wireless device and operator of the wireless system including the first base station), and (vi) type of application on the first wireless device requesting the radio resources (e.g., voice call application, text messaging application, e-mail communications application, data transfer application, multi-media application, internet service application, emergency services application (e.g., 911 service application)).

Method Embodiment 9. The method of Method Embodiment 1, further comprising: after receiving by the smart contract function an acceptance of the first smart contract offer by the first wireless device, generating a first token by the first smart contract function of the first base station, said first token authorizing a first wireless device to utilize radio resources identified in the first token for communicating with a first base station radio system of the first base station, said first base station radio system being the base station radio system serving the first wireless device; storing, by the first smart contract function, information on the radio resources authorized for use by the first token in a radio resource allocation ledger; distributing the radio resource allocation ledger to the first blockchain enabled scheduler of the first base station; and communicating the first token to the first wireless device.

Method Embodiment 10. The method of Method Embodiment 9, wherein the information on the radio resources authorized for use by the first token is stored as a block of a radio resource allocation blockchain stored in the radio resource allocation ledger.

Method Embodiment 11. The method of Method Embodiment 3, wherein the first base station is a distributed base station including: (i) a central computing system, and (ii) a plurality of base station radio systems.

Method Embodiment 11A. The method of Method Embodiment 11, wherein each of the plurality of base station radio systems includes a radio unit, each radio unit including a transmitter, a receiver and an antenna or antenna system (e.g., beam forming antenna array system).

Method Embodiment 11B. The method of Method Embodiment 11, wherein the central computing system includes a first server, said first blockchain enabled scheduler being a function executing on the first server.

Method Embodiment 11C. The method of Method Embodiment 11B, wherein the first smart contract function is a function executing on the first server.

Method Embodiment 11D. The method of Method Embodiment 11C, wherein a first Radio Link Controller function of the first base station is a function executing on the first server.

Method Embodiment 11E. The method of Method Embodiment 11, wherein the central computing system is a cloud computing system.

Method Embodiment 11F. The method of Method Embodiment 11, wherein the central computing system includes a plurality of servers, said plurality of servers including at least one server for each of the plurality of base station radio systems of the first base station.

Method Embodiment 11G. The method of Method Embodiment 11, wherein the plurality of base station radio systems includes a first base station radio system, said first base station radio system actively serving a first plurality of wireless devices and a second base station radio system actively serving a second plurality of wireless devices, said first plurality of wireless devices not including wireless devices in said second plurality of wireless devices, and wherein at least some of said radio resources being utilized by the first base station radio system and the second base station radio system are the same, said first base station radio system and said second base station radio system having overlapping coverage areas; and wherein said first base station radio system is the base station radio system serving the first wireless device, said first wireless device being one of said wireless devices of the first plurality of wireless devices.

Method Embodiment 12. The method of Method Embodiment 11, wherein the radio resource type is a physical resource block (PRB) type; wherein the amount of radio resources to be allocated for use by the first wireless device to communicate with the base station radio system serving the first wireless device is an amount of physical resource blocks (PRBs) to be allocated for use by the first wireless device to communicate with the base station radio system serving the first wireless device; and wherein said determining the amount of radio resources to be allocated for use by the first wireless device to communicate with the base station radio system serving the first wireless device is further based on information contained in a blockchain ledger, each block of the blockchain ledger including: (i) information on radio resources of the first base station that have been allocated for use by a wireless device being served by the first base station, (ii) information on the identity of the wireless device to which the radio resources have been allocated, and (iii) information on the identity of the base station radio system serving the wireless device to which the radio resources have been allocated.

Method Embodiment 12A. The method of Method Embodiment 12, wherein the information contained in the blockchain ledger includes information on the scheduled allocation of all radio resources available to the base station radio system serving the first wireless device (e.g., identification of total amount of radio resources scheduled for usage vs. total radio resources to determine availability of radio resources that can be allocated to the first wireless device and for what period of time).

Method Embodiment 13. The method of Method Embodiment 11, wherein the plurality of base station radio systems of the first distributed base station includes: a first base station radio system being located at a first location and a second base station radio system being located at a second location, said first and second locations being different locations; said first base station radio system and said second base station radio system having overlapping coverage areas, said first base station radio system and said second base station radio system using the same spectrum (e.g., the same 5 MHz channel), saif first base station radio system being the base station radio system serving the first wireless device.

### List of Exemplary Numbered Apparatus Embodiments:

Apparatus Embodiment 1. A first base station comprising: memory; and a first processor, said first processor controlling the first base station to perform the following operations: initiating generation of a first smart contract in response to receiving a first request for radio resources from a first wireless device; generating a first smart contract, said first smart contract including: (i) information identifying the first wireless device as a first party to the first smart contract, (ii) information identifying a base station radio system of the first base station that is serving the first wireless device as a second party to the first smart contract, and (iii) terms of the first smart contract; and communicating, by the first base station, a first smart contract offer message to the first wireless device, said first smart contract offer message including information on the parties to the first smart contract and information on the terms of the first smart contract.

Apparatus Embodiment 2. The first base station of Apparatus Embodiment 1, wherein the information on the terms of the first smart contract includes: (i) information on radio resources to be allocated to the first wireless device for use in communicating with the base station radio system serving the first wireless device, (ii) conditions on when the first smart contract is to be executed, and (iii) one or more actions to be initiated by the first smart contract when the conditions in the first smart contract have been met.

Apparatus Embodiment 2A. The first base station of Apparatus Embodiment 2, wherein the first smart contract is an executable software routine that performs the following operations: (i) monitoring to detect when the conditions identified in the first smart contract are met; and (ii) in response to detecting that the conditions in the first smart contract are met initiating said one or more actions identified in the first smart contract.

Apparatus Embodiment 2A1. The first base station of Apparatus Embodiment 2A, wherein the conditions in the first smart contract are receipt of information indicating acceptance of the first smart contract offer by the first wireless device.

Apparatus Embodiment 2A2. The first base station of Apparatus Embodiment 2A, wherein the first processor further controls the first base station to perform the following additional operations: communicating the first smart contract offer message to the first wireless device; and wherein the conditions in the first smart contract are receipt of information indicating the acceptance of the first smart contract offer by the first wireless device and acceptance of the first smart offer by the base station radio system serving the first wireless device.

Apparatus Embodiment 3. The first base station of Apparatus Embodiment 2, wherein said information on the radio resources to be allocated to the first wireless device for use in communicating with the base station radio system serving the first wireless device includes: a radio resource type indicating the type of radio resources to be allocated for use by the first wireless device to communicate with the base station radio system serving the first wireless device.

Apparatus Embodiment 4. The first base station of Apparatus Embodiment 3, wherein the radio resource type is one of the following: a physical resource block type or a resource element of a physical resource block type.

Apparatus Embodiment 4A. The first base station of Apparatus Embodiment 2, wherein said information on the radio resources to be allocated to the first wireless device for use in communicating with the base station radio system serving the first wireless device further includes: an amount of radio resources to be provided for the first wireless device to use in communicating with the base station radio system serving the first wireless device.

Apparatus Embodiment 5. The first base station of Apparatus Embodiment 4, wherein said information on the radio resources to be allocated to the first wireless device for use in communicating with the base station radio system serving the first wireless device further includes: a duration of the allocation of the radio resources to the first wireless device for use in communicating with the base station radio system serving the first wireless device.

Apparatus Embodiment 5A. The first base station of Apparatus Embodiment 2, wherein said information on the radio resources to be allocated to the first wireless device for use in communicating with the base station radio system serving the first wireless device includes: information identifying the radio resources to be allocated to the first wireless device for use in communicating with the base station radio system serving the first wireless device.

Apparatus Embodiment 6. The first base station of Apparatus Embodiment 2, wherein said one or more actions to be initiated by the first smart contract when the conditions in the first smart contract have been met includes: a first action, said first action including initiating issuance of a first token to the first wireless device, said first token including information indicating radio resources allocated for the first wireless device to use for communicating with the base station serving the first wireless device.

Apparatus Embodiment 6A. The first base station of Apparatus Embodiment 6, wherein the first token includes a start time indicating when the first wireless device can begin transferring data using the allocated radio resources identified in the first token.

Apparatus Embodiment 6B. The first base station of Apparatus Embodiment 6A, wherein the first token further includes information indicating when the first token will expire (e.g., a token expiration time or a duration of use or a specific set of PRBs that may be used from the start time), said first token expiration ending the allocation of radio resources to the first wireless device by the first token.

Apparatus Embodiment 6C. The first base station of Apparatus Embodiment 6A, wherein the information included in the first token identifying radio resources allocated for the first wireless device to use for communicating with the base station serving the first wireless device includes: a Physical Block Resource (PRB) Index that identifies the radio resources allocated for the first wireless device to use for communicating (e.g., transferring data) with the base station radio system serving the first wireless device.

Apparatus Embodiment 6D. The first base station of Apparatus Embodiment 6, wherein the first processor further controls the first base station to perform the following additional operations: generating the first token, said generating the first token including identifying radio resources (e.g., PRBs or resource elements of PRBs) that are available for allocation to the first wireless device based on information obtained from a radio resource allocation blockchain ledger, said radio resource allocation blockchain ledger including information on the radio resources allocated for the base station radio system which is identified in the first smart contract (e.g., the base station radio system serving the first wireless device); and updating the radio resource allocation blockchain ledger to include the radio resources allocated to the first wireless device in the first token (e.g., add the first token or information on the allocated radio resources included in the first token to the radio resource allocation blockchain as the next block in the radio resource allocation blockchain ledger); distributing the updated radio resource allocation blockchain leger to other entities (e.g., other base stations of the wireless system to which the first base system belongs); communicating the first token to the first wireless device.

Apparatus Embodiment 6E. The first base station of Apparatus Embodiment 6D, wherein the first token is encrypted by the first base station prior to transmission to the first wireless device; and wherein the radio resource allocation blockchain ledger is encrypted or signed by the first base station prior to distribution to other base stations in the wireless system to which the first base station belongs.

Apparatus Embodiment 6F. The first base station of Apparatus Embodiment 6D, wherein the first processor further controls the first base station to perform the following additional operations: determining by the first base station that the data transmission from the first wireless device has been completed or that the first token has expired; and in response to determining by the first base station that the data transmission from the first wireless device has been completed or that the first token has expired, communicating a notification to the first wireless device to cease utilizing the radio resources identified for use by the first wireless device in the first token (e.g., sending a notification that the data transmission has completed successfully or that the first token has expired).

Apparatus Embodiment 6G. The first base station of Apparatus Embodiment 6F, wherein the first processor further controls the first base station to perform the following additional operations: in response to the completion of the data transmission or the expiration of the first token, releasing by the first base station the radio resources allocated in the first token; updating the radio resource allocation blockchain ledger to indicate that the radio resources allocated in the first token have been released; and distributing the updated radio resource allocation blockchain ledger to other entities (e.g., other base stations in a wireless system to which the first wireless base station belongs).

Apparatus Embodiment 7. The first base station of Apparatus Embodiment 1, wherein the first processor further controls the first base station to perform the following additional operations: prior to initiating generation of the first smart contract, determining an amount of radio resources to be allocated for use by the first wireless device to communicate with the base station radio system serving the first wireless device.

Apparatus Embodiment 8. The first base station of Apparatus Embodiment 7, wherein said determining the amount of radio resources to be allocated for use by the first wireless device to communicate with the base station radio system serving the first wireless device is based on: (i) information contained in the first request for radio resources from the first wireless device or in a buffer status report received by the first base station from the first wireless device; and (ii) information contained in a blockchain ledger, each block of the blockchain ledger including: (a) information on radio resources of the first base station that have been allocated for use by a wireless device being served by the first base station, (b) information on the identity of the wireless device to which the radio resources have been allocated, and (c) information on the identity of the base station radio system serving the wireless device to which the radio resources have been allocated.

Apparatus Embodiment 8A. The first base station of Apparatus Embodiment 8, wherein said determining the amount of radio resources to be allocated for use by the first wireless device to communicate with the base station radio system serving the first wireless device is further based on one or more of the following: (i) coverage area of the base station radio system serving the first wireless device, (ii) number of wireless devices actively being served by the base station radio system serving the first wireless device, (iii) radio conditions at the first wireless device (e.g., channel conditions and/or signal interference conditions (SINR) determined based on reports from the first wireless device and/or determined based on reference signals received from the first wireless device at the first base station), (iv) modulation scheme to be utilized for data transmission (e.g., Quadrature Amplitude Modulation (QAM) scheme—16-QAM, 64-QAM, 256-QAM, etc. or modulation index from 5G standard set of modulation indices), (v) Quality of Service (QoS) to be provided to the first wireless device (e.g., via contract between subscriber of the first wireless device and operator of the wireless system to which the first base station belongs), and (vi) type of application on the first wireless device requesting the radio resources (e.g., voice call application, text messaging application, e-mail communications application, data transfer application, multi-media application, internet service application, emergency services application (e.g., 911 service application)).

Apparatus Embodiment 9. The first base station of Apparatus Embodiment 1, wherein the first processor further controls the first base station to perform the following additional operations: after receiving an acceptance of the first smart contract offer by the first wireless device, generating a first token, said first token authorizing a first wireless device to utilize radio resources identified in the first token for communicating with a base station radio system of the first base station, said base station radio system being the base station radio system serving the first wireless device; storing information on the radio resources authorized for use by the first token in a radio resource allocation ledger; distributing the radio resource allocation ledger to a second base station which is part of a wireless system to which the first base station belongs; and communicating the first token to the first wireless device.

Apparatus Embodiment 10. The first base station of Apparatus Embodiment 9, wherein the information on the radio resources authorized for use by the first token is stored as a block of a radio resource allocation blockchain stored in the radio resource allocation ledger.

Apparatus Embodiment 11. The first base station of Apparatus Embodiment 3, wherein the first base station is a distributed base station including: (i) a central computing system, and (ii) a plurality of base station radio systems.

Apparatus Embodiment 11A. The first base station of Apparatus Embodiment 11, wherein each of the plurality of base station radio systems includes a radio unit, each radio unit including a transmitter, a receiver and an antenna or antenna system (e.g., beam forming antenna array system).

Apparatus Embodiment 11E. The first base station of Apparatus Embodiment 11, wherein the central computing system is a cloud computing system.

Apparatus Embodiment 11F. The first base station of Apparatus Embodiment 11, wherein the central computing system includes a plurality of servers, said plurality of servers including at least one server for each of the plurality of base station radio systems of the first base station.

Apparatus Embodiment 11G. The first base station of Apparatus Embodiment 11, wherein the plurality of base station radio systems includes a first base station radio system, said first base station radio system actively serving a first plurality of wireless devices and a second radio base station system actively serving a second plurality of wireless devices, said first plurality of wireless devices not including wireless devices in said second plurality of wireless devices, said first wireless device being one of the wireless devices of the first plurality of wireless devices; and wherein at least some of said radio resources being utilized by the first base station radio system and the second base station radio system are the same, said first base station radio system and said second base station radio system having overlapping coverage areas.

Apparatus Embodiment 12. The first base station of Apparatus Embodiment 11, wherein the radio resource type is a physical resource block (PRB) type; wherein the amount of radio resources to be allocated for use by the first wireless device to communicate with the base station radio system serving the first wireless device is an amount of physical resource blocks (PRBs) to be allocated for use by the first wireless device to communicate with the base station radio system serving the first wireless device; and wherein said determining the amount of radio resources to be allocated for use by the first wireless device to communicate with the base station radio system serving the first wireless device is further based on information contained in a blockchain ledger, each block of the blockchain ledger including: (i) information on radio resources of the first base station that have been allocated for use by a wireless device being served by the first base station, (ii) information on the identity of the wireless device to which the radio resources have been allocated, and (iii) information on the identity of the base station radio system serving the wireless device to which the radio resources have been allocated.

Apparatus Embodiment 12A. The first base station of Apparatus Embodiment 12, wherein the information contained in the blockchain ledger includes information on the scheduled allocation of all radio resources available to the base station radio system serving the first wireless device (e.g., identification of total amount of radio resources scheduled for usage vs. total radio resources to determine availability of radio resources that can be allocated to the first wireless device and for what period of time).

Apparatus Embodiment 13. The first base station of Apparatus Embodiment 11, wherein the plurality of base station radio systems of the first distributed base station includes: a first base station radio system being located at a first location and a second base station radio system being located at a second location, said first and second locations being different locations; said first base station radio system and said second base station radio system having overlapping coverage areas, said first base station radio system and said second base station radio system using the same spectrum (e.g., the same 5 MHz channel), said first base station radio system being the base station radio system serving the first wireless device.

### List of Exemplary Numbered Non-transitory Computer Readable Medium Embodiments

Non-transitory Computer Readable Medium Embodiment 1. A non-transitory computer readable medium including a first set of computer executable instructions which when executed by a processor of a base station cause the base station to perform the steps of: initiating generation of a first smart contract in response to receiving a first request for radio resources from a first wireless device; generating a first smart contract, said first smart contract including: (i) information identifying the first wireless device as a first party to the first smart contract, (ii) information identifying a base station radio system of the first base station that is serving the first wireless device as a second party to the first smart contract, and (iii) terms of the first smart contract; and communicating a first smart contract offer message to the first wireless device, said first smart contract offer message including information on the parties to the first smart contract and information on the terms of the first smart contract.

The techniques of various embodiments may be implemented using software, hardware and/or a combination of software and hardware. Various embodiments are directed to apparatus, e.g., base stations, distributed base stations, wireless devices, mobile terminals, network equipment, servers, devices, eNBs, gNBs, CBSDs, CBRS tower base stations, 5G New Radio-wireless base stations, smart devices, user equipment devices, user devices, computers, smartphones, subscriber devices, servers, nodes, systems and/or elements. Various embodiments are also directed to methods, e.g., method of controlling and/or operating base stations, distributed base stations, wireless devices, mobile terminals, network equipment, servers, devices, eNBs, gNBs, CBSDs, CBRS tower base stations, 5G New Radio-wireless base stations, smart devices, user equipment devices, user devices, computers, smartphones, subscriber devices, servers, nodes, systems and/or elements. Various embodiments are also directed to machine, e.g., computer, readable medium, e.g., ROM, RAM, CDs, hard discs, etc., which include machine readable instructions for controlling a machine to implement one or more steps of a method. The computer readable medium is, e.g., non-transitory computer readable medium.

It is understood that the specific order or hierarchy of steps in the processes and methods disclosed is an example of exemplary approaches. Based upon design preferences, it is understood that the specific order or hierarchy of steps in the processes and methods may be rearranged while remaining within the scope of the present disclosure. The accompanying method claims present elements of the various steps in a sample order, and are not meant to be limited to the specific order or hierarchy presented. In some embodiments, one or more processors are used to carry out one or more steps of the each of the described methods.

In various embodiments each of the steps or elements of a method are implemented using one or more processors. In some embodiments, each of elements or steps are implemented using hardware circuitry.

In various embodiments devices, e.g., base stations, distributed base stations, wireless devices, mobile terminals, network equipment, servers, devices, eNBs, gNBs, CBSDs, CBRS tower base stations, 5G New Radio-wireless base stations, smart devices, user equipment devices, user devices, computers, smartphones, subscriber devices, servers, nodes, systems and/or elements described herein are implemented using one or more components to perform the steps corresponding to one or more methods, for example, generating or creating base station configurations, messages, connections, message reception, message transmission, switching modes, signal processing, sending, comparing, determining and/or transmission steps. Thus, in some embodiments various features are implemented using components or in some embodiments logic such as for example logic circuits. Such components may be implemented using software, hardware or a combination of software and hardware. Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods, e.g., in one or more devices, servers, nodes and/or elements. Accordingly, among other things, various embodiments are directed to a machine-readable medium, e.g., a non-transitory computer readable medium, including machine executable instructions for causing a machine, e.g., processor and associated hardware, to perform one or more of the steps of the above-described method(s). Some embodiments are directed to a device, e.g., a controller, including a processor configured to implement one, multiple or all of the steps of one or more methods of the invention.

In some embodiments, the processor or processors, e.g., CPUs, of one or more devices, e.g., base stations, distributed base stations, wireless devices, mobile terminals, network equipment, servers, devices, eNBs, gNBs, CBSDs, CBRS tower base stations, 5G New Radio-wireless base stations, smart devices, user equipment devices, user devices, computers, smartphones, subscriber devices, servers, nodes, systems and/or elements. The configuration of the processor may be achieved by using one or more components, e.g., software components, to control processor configuration and/or by including hardware in the processor, e.g., hardware components, to perform the recited steps and/or control processor configuration. Accordingly, some but not all embodiments are directed to a device, e. g base stations, distributed base stations, wireless devices, mobile terminals, network equipment, servers, devices, eNBs, gNBs, CBSDs, CBRS tower base stations, 5G New Radio-wireless base stations, smart devices, user equipment devices, user devices, computers, smartphones, subscriber devices, servers, nodes, systems and/or elements, with a processor which includes a component corresponding to each of the steps of the various described methods performed by the device in which the processor is included. In some but not all embodiments a device, e.g., base stations, distributed base stations, wireless devices, mobile terminals, network equipment, servers, devices, eNBs, gNBs, CBSDs, CBRS tower base stations, 5G New Radio-wireless base stations, smart devices, user equipment devices, user devices, computers, smartphones, subscriber devices, servers, nodes, systems and/or elements, includes a controller corresponding to each of the steps of the various described methods performed by the device in which the processor is included. The components may be implemented using software and/or hardware.

Some embodiments are directed to a computer program product comprising a computer-readable medium, e.g., a non-transitory computer-readable medium, comprising code for causing a computer, or multiple computers, to implement various functions, steps, acts and/or operations, e.g., one or more steps described above. Depending on the embodiment, the computer program product can, and sometimes does, include different code for each step to be performed. Thus, the computer program product may, and sometimes does, include code for each individual step of a method, e.g., a method of controlling a device, e.g., base stations, distributed base stations, wireless devices, mobile terminals, network equipment, servers, devices, eNBs, gNBs, CBSDs, CBRS tower base stations, 5G New Radio-wireless base stations, smart devices, user equipment devices, user devices, computers, smartphones, subscriber devices, servers, nodes, systems and/or elements. The code may be in the form of machine, e.g., computer, executable instructions stored on a computer-readable medium, e.g., a non-transitory computer-readable medium, such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the methods described herein. The processor may be for use in, e.g., a communications device such as a base stations, distributed base stations, wireless devices, mobile terminals, network equipment, servers, devices, eNBs, gNBs, CBSDs, CBRS tower base stations, 5G New Radio-wireless base stations, smart devices, user equipment devices, user devices, computers, smartphones, subscriber devices, servers, nodes, systems and/or elements or other device described in the present application.

Numerous additional variations on the methods and apparatus of the various embodiments described above will be apparent to those skilled in the art in view of the above description. Such variations are to be considered within the scope. Numerous additional embodiments, within the scope of the present invention, will be apparent to those of ordinary skill in the art in view of the above description and the claims which follow. Such variations are to be considered within the scope of the invention.

What is claimed is:

1. A method comprising:
initiating generation of a first smart contract by a first blockchain enabled scheduler of a first base station in response to receiving a first request for radio resources from a first wireless device;
generating a first smart contract, by a first smart contract function of the first base station, said first smart contract including: (i) information identifying the first wireless device as a first party to the first smart contract, (ii) information identifying a base station radio system of the first base station that is serving the first wireless device as a second party to the first smart contract, and (iii) terms of the first smart contract; and
communicating, by the first smart contract function, a first smart contract offer message to the first wireless device, said first smart contract offer message including information on the parties to the first smart contract and information on the terms of the first smart contract.

2. The method of claim 1, wherein the information on the terms of the first smart contract includes: (i) information on radio resources to be allocated to the first wireless device for use in communicating with the base station radio system serving the first wireless device, (ii) conditions on when the first smart contract is to be executed, and (iii) one or more actions to be initiated by the first smart contract when the conditions in the first smart contract have been met.

3. The method of claim 2, wherein the first smart contract is an executable software routine that performs the following operations:
(i) monitoring to detect when the conditions identified in the first smart contract are met; and
(ii) in response to detecting that the conditions in the first smart contract are met initiating said one or more actions identified in the first smart contract.

4. The method of claim 2,
wherein said information on the radio resources to be allocated to the first wireless device for use in communicating with the base station radio system serving the first wireless device includes: a radio resource type indicating the type of radio resources to be allocated for use by the first wireless device to communicate with the base station radio system serving the first wireless device.

5. The method of claim 4, wherein the radio resource type is one of the following: a physical resource block type or a resource element of a physical resource block type.

6. The method of claim 5, wherein said information on the radio resources to be allocated to the first wireless device for use in communicating with the base station radio system serving the first wireless device further includes: a duration of the allocation of the radio resources to the first wireless device for use in communicating with the base station radio system serving the first wireless device.

7. The method of claim 2, wherein said one or more actions to be initiated by the first smart contract when the conditions in the first smart contract have been met includes: a first action, said first action including initiating issuance of a first token to the first wireless device, said first token including information indicating radio resources allocated for the first wireless device to use for communicating with the base station serving the first wireless device.

8. The method of claim 1, further comprising:
prior to initiating generation of the first smart contract by the first blockchain enabled scheduler, determining, by the first blockchain enabled scheduler an amount of radio resources to be allocated for use by the first wireless device to communicate with the base station radio system serving the first wireless device.

9. The method of claim 8,
wherein said determining the amount of radio resources to be allocated for use by the first wireless device to communicate with the base station radio system serving the first wireless device is based on: (i) information contained in the first request for radio resources from the first wireless device or in a buffer status report received by the first base station from the first wireless device; and (ii) information contained in a blockchain ledger, each block of the blockchain ledger including: (a) information on radio resources of the first base station that have been allocated for use by a wireless device being served by the first base station, (b) information on the identity of the wireless device to which the radio resources have been allocated, and (c) information on the identity of the base station radio system serving the wireless device to which the radio resources have been allocated.

10. The method of claim 1, further comprising:
after receiving by the smart contract function an acceptance of the first smart contract offer by the first wireless device, generating a first token by the first smart contract function of the first base station, said first token authorizing a first wireless device to utilize radio resources identified in the first token for communicating with a first base station radio system of the first base station, said first base station radio system being the base station radio system serving the first wireless device;
storing, by the first smart contract function, information on the radio resources authorized for use by the first token in a radio resource allocation ledger;
distributing the radio resource allocation ledger to the first blockchain enabled scheduler of the first base station; and
communicating the first token to the first wireless device.

11. The method of claim 10, wherein the information on the radio resources authorized for use by the first token is stored as a block of a radio resource allocation blockchain stored in the radio resource allocation ledger.

12. The method of claim 4,
wherein the first base station is a distributed base station including: (i) a central computing system, and (ii) a plurality of base station radio systems.

13. The method of claim 12,
wherein the radio resource type is a physical resource block (PRB) type;
wherein the amount of radio resources to be allocated for use by the first wireless device to communicate with the base station radio system serving the first wireless device is an amount of physical resource blocks (PRBs) to be allocated for use by the first wireless device to communicate with the base station radio system serving the first wireless device; and
wherein said determining the amount of radio resources to be allocated for use by the first wireless device to communicate with the base station radio system serving the first wireless device is further based on information contained in a blockchain ledger, each block of the blockchain ledger including: (i) information on radio resources of the first base station that have been allocated for use by a wireless device being served by the first base station, (ii) information on the identity of the wireless device to which the radio resources have been allocated, and (iii) information on the identity of the base station radio system serving the wireless device to which the radio resources have been allocated.

14. A first base station comprising:
memory; and
a first processor, said first processor controlling the first base station to perform the following operations:
initiating generation of a first smart contract in response to receiving a first request for radio resources from a first wireless device;
generating a first smart contract, said first smart contract including: (i) information identifying the first wireless device as a first party to the first smart contract, (ii) information identifying a base station radio system of the first base station that is serving the first wireless device as a second party to the first smart contract, and (iii) terms of the first smart contract; and
communicating a first smart contract offer message to the first wireless device, said first smart contract offer message including information on the parties to the first smart contract and information on the terms of the first smart contract.

15. The first base station of claim 14, wherein the information on the terms of the first smart contract includes: (i) information on radio resources to be allocated to the first wireless device for use in communicating with the base station radio system serving the first wireless device, (ii) conditions on when the first smart contract is to be executed, and (iii) one or more actions to be initiated by the first smart contract when the conditions in the first smart contract have been met.

16. The first base station of claim 15,
wherein said information on the radio resources to be allocated to the first wireless device for use in communicating with the base station radio system serving the first wireless device includes: a radio resource type indicating the type of radio resources to be allocated for use by the first wireless device to communicate with the base station radio system serving the first wireless device.

17. The first base station of claim 15, wherein said one or more actions to be initiated by the first smart contract when the conditions in the first smart contract have been met includes: a first action, said first action including initiating issuance of a first token to the first wireless device, said first token including information indicating radio resources allocated for the first wireless device to use for communicating with the base station serving the first wireless device.

18. The first base station of claim 14, wherein the first processor further controls the first base station to perform the following additional operations:
prior to initiating generation of the first smart contract, determining an amount of radio resources to be allocated for use by the first wireless device to communicate with the base station radio system serving the first wireless device.

19. The first base station of claim 14, wherein the first processor further controls the first base station to perform the following additional operations:
after receiving an acceptance of the first smart contract offer by the first wireless device, generating a first token, said first token authorizing a first wireless device to utilize radio resources identified in the first token for communicating with a base station radio system of the first base station, said base station radio system being the base station radio system serving the first wireless device;
storing information on the radio resources authorized for use by the first token in a radio resource allocation ledger;
distributing the radio resource allocation ledger to a second base station which is part of a wireless system to which the first base station belongs; and
communicating the first token to the first wireless device.

20. A non-transitory computer readable medium including a first set of computer executable instructions which when executed by a processor of a base station cause the base station to perform the steps of:
initiating generation of a first smart contract in response to receiving a first request for radio resources from a first wireless device;
generating a first smart contract, said first smart contract including: (i) information identifying the first wireless device as a first party to the first smart contract, (ii) information identifying a base station radio system of the first base station that is serving the first wireless device as a second party to the first smart contract, and (iii) terms of the first smart contract; and
communicating a first smart contract offer message to the first wireless device, said first smart contract offer message including information on the parties to the first smart contract and information on the terms of the first smart contract.
